(19) United States
(12) Patent Application Publication
(10) Pub. No.: US 2017/0132357 A1
(43) Pub. Date: May 11, 2017

(54) PLATFORM FOR VISUAL SYNTHESIS OF GENOMIC, MICROBIOME, AND METABOLOME DATA

(71) Applicant: HUMAN LONGEVITY, INC., San Diego, CA (US)

(72) Inventors: Suzanne Brewerton, Singapore (SG); Bryan Coon, San Diego, CA (US); Chao Xie, Singapore (SG); Rafael Zuniga, San Diego, CA (US); Jhalley de Castro, Singapore (SG); Shibu Yooseph, San Diego, CA (US); Weizhong Li, San Diego, CA (US); Ryan Ulaszek, San Diego, CA (US); Niels Klitgord, Poway, CA (US); Zhenxuan Yeo, Singapore (SG); Fabi Mulawadi, Singapore (SG); Aaron Friedman, San Diego, CA (US); Stephen Terrell, San Diego, CA (US); Adrianto Wirawan, Singapore (SG); Korkut Gule, Singapore (SG); Erhan Saygi, Singapore (SG); Andreas Hadimulyono, Singapore (SG); Yong Heng Tan, Singapore (SG); Thomas Sisk, Singapore (SG); Alexey Volochenko, Brooklyn, NY (US); Sean Blair, Singapore (SG); Aik Meng Ang, Singapore (SG); Kian Yong Lim, Singapore (SG); Daniel Zhang, Singapore (SG); Dmitry Bezyazychnyy, Singapore (SG); Qiang Wang, Singapore (SG); Xiaohui Liu, Singapore (SG); Ream Lim, Singapore (SG); Nikita Veshkurtsev, Singapore (SG); Marie Wong, Singapore (SG); Jason Piper, Singapore (SG); Miao Sun, Singapore (SG); Matthew Cloney, San Diego, CA (US); Bao Pham, Singapore (SG); Yaron Turpaz, San Diego, CA (US)

(21) Appl. No.: 15/348,917

(22) Filed: Nov. 10, 2016

Related U.S. Application Data
(60) Provisional application No. 62/253,629, filed on Nov. 10, 2015.
(60) Provisional application No. 62/296,986, filed on Feb. 18, 2016.
(60) Provisional application No. 62/362,892, filed on Jul. 15, 2016.

(51) Int. Cl. G06F 19/12; G06F 19/28; G06F 19/00; G06F 19/18; G06F 19/26

(52) U.S. Cl. CPC G06F 19/12; G06F 19/18; G06F 19/26; G06F 19/3437; G06F 19/28

(57) ABSTRACT

Described are platforms, systems, media, and methods for providing a biologic information visual synthesis application, the biologic information including one or more of: genome data, microbiome data, and metabolome data.

### CROSS-REFERENCE TO RELATED APPLICATIONS

This application claims the benefit of U.S. provisional application Ser. No. 62/253,629 filed Nov. 10, 2015, U.S. provisional application Ser. No. 62/296,986 filed Feb. 18, 2016, and U.S. provisional application Ser. No. 62/362,892 filed Jul. 15, 2016, the entire contents of each of which is hereby incorporated by reference.

### BACKGROUND OF THE INVENTION

The current medical care model is largely focused on “sick care,” or waiting until symptoms of disease develop, followed by diagnosis and treatment. This approach was developed over the last century when infectious diseases and other acute conditions were more common than they are today. The “sick care” model is badly out of step with early detection and prevention in response to today's age-related chronic diseases epidemic including cardiovascular disease, cancer, diabetes, and dementia in the U.S. and other wealthy countries. As a result, many people suffer needlessly and die prematurely. The reasons for this mismatch are varied and numerous but largely revolve around the size, inertia, and misaligned payment incentives of and within the medical industry including health care providers, health insurers, and pharmaceutical companies.

### SUMMARY OF THE INVENTION

Recent progress in genomics and other technologies along with the rising importance of age-related diseases have opened an opportunity to revolutionize health and the practice of medicine. Most dramatically, the costs of genomic sequencing have decreased by more than four orders of magnitude over the last fifteen years, going from $100,000,000 for the first human whole-genome sequence to less than $10,000. The same shotgun sequencing techniques Venter, et al. developed to revolutionize human whole-genome sequencing are now also being used to define and explore the microbiome. Sometimes called our “second genome,” the microbiome is composed of the trillions of bacteria and other microorganisms that live in and on our body, all with their own genetic material interacting with our own human cells to support health and cause or be associated with disease. Combining human whole-genome sequencing and microbiome characterization with recent progress in measuring metabolomics, the small molecules and chemicals that result from protein synthesis and other basic physiologic functions will provide new opportunities in medical diagnosis, early detection, and prevention.

To make use of all these data there needs to be an affordable place to securely store, access, and analyze. Fortunately, the availability and decreased costs of cloud computing has now made it possible to securely store and analyze genomics and phenotype metadata as integrated health records at scale previously unattainable.

As a result of these new capabilities in data generation and storage, medical science is poised for a potentially disruptive transition in discovery. Machine learning is a computer science focused on “extracting rules and patterns from sets of data,” “without having to be explicitly instructed every step of the way by human programmers” (Economist. How Machine Learning Works. May 13, 2015). Machine learning has been particularly impactful when used with huge amounts of data. Most large-scale applications of machine learning have occurred outside of medical science or health care. As machine learning is applied to medical science it will likely challenge traditional, more linear, hypothesis-driven, biomedical research as the gold standard for new discoveries. Described herein is the use of machine learning with a database of integrated health records to translate the “language” of biology in the form of DNA sequence data—the “software of life,” into the language of health and disease as phenotypes. The expectation is that this will result in a dramatic acceleration of novel therapeutics and diagnostics, and new models for medical care.

A fundamentally new information environment, a knowledgebase, is described herein based on our work in genomics, microbiomics, and metabolomics, as they relate to information technologies. The medical model focuses on integrating genomics and phenotype data to identify actionable individual health risks as a basis for early detection and prevention of age-related disease in adults. Based on these efforts, we will design and evaluate the feasibility of individualized care plans based on study designs that focus on single individuals—known as N-of-1 trials. Health outcomes related to effectiveness of individualized health risks and care plans will be evaluated for effectiveness in prevention and early detection and response to age-related disease.

In one aspect, disclosed herein are computer-implemented systems comprising: at least one memory storing computer-executable instructions; and at least one processor configured to access the at least one memory and execute the computer-executable instructions to perform: receiving a query, wherein the query defines a cohort of one or more individuals; querying a database; wherein the database comprises a plurality of genomic data and a plurality of phenotype data; generating, using at least the genomic data, a genome summary, a microbiome summary, and a metabolome summary for the cohort, the genome summary comprising genes and gene variants of the cohort, the microbiome summary comprising one or more of: a relative abundance of types of microflora found in the cohort and genes and gene variants of the microflora, and the metabolome summary comprising measurements of metabolites found in the cohort; determining a graphical representation of the genome summary, the microbiome summary, and the metabolome summary for the cohort; and sending the graphical representation to a display device. In some cases, the database further comprises a plurality of microbiomic data and a plurality of metabolomic data. The plurality of genomic data is optionally obtained by analysis of one or more biologic samples from one or more individuals. The query may further comprise one or more of: demographic information, clinical information, disease history, family history, disease treatments, physical traits, test results, diagnostic images, dietary information, lifestyle information, and cognitive assessments. In various cases, the query optionally includes a phenotype, a sample ID, an individual ID, and/or a gene name or gene variant name. In some cases, the genome summary further comprises functional effect, clinical significance, variant type, and allele frequency for the gene variants. The at least one processor may be further configured to access the at least one memory and execute the computer-executable instructions to perform presenting a graphical user interface (GUI) for receiving the query. The GUI may allow construction of the query by adding or removing one or more of: a demographic filter, a primary diagnosis filter, a medical history filter, a lifestyle filter, a clinical measurement filter, and a laboratory measurement filter. The GUI optionally shows a number of individuals remaining in the cohort in response to each adding or removing a filter. The GUI may allow the user to configure display of the microbiome summary to show abundance by species or genus of microflora found in the individuals. The GUI may allow the user to configure display of the metabolome summary to show measurements of metabolites found in the individuals by metabolic superpathway or sub-pathway. In some cases, the genome summary, microbiome summary, and metabolome summary comprise data for individuals. The GUI may display one of the genome information, microbiome information, and metabolome information at a time and allows the user to switch among displays of the genome information, the microbiome information, and the metabolome information. In some cases, the genomic data comprises data in variant call format (VCF). In some cases, the genomic data is annotated with one or more non-genomic data upon or before import into the database. In further cases, the one or more non-genomic data comprises one or more of: demographic information, clinical information, disease history, family history, disease treatments, physical traits, test results, microbiome information, metabolome information, dietary information, lifestyle information, cognitive assessments, sample ID, and patient ID. In some cases, at least one processor is allocated to the query independently of other queries. In some cases, at least one dedicated processor is allocated to the query and the database is shared for all queries.

In another aspect, disclosed herein are computer-implemented systems comprising: at least one memory storing computer-executable instructions; and at least one processor configured to access the at least one memory and execute the computer-executable instructions to generate a graphical user interface (GUI) that accepts a query from a user defining a cohort of one or more individuals and presents to the user genome information, microbiome information, and metabolome information related to the cohort.

In another aspect, disclosed herein are computer-implemented methods comprising: receiving a query, wherein the query defines a cohort of one or more individuals; querying a database; wherein the database comprises a plurality of genomic data and a plurality of phenotype data; generating, using at least the genomic data, a genome summary, a microbiome summary, and a metabolome summary for the cohort, the genome summary comprising genes and gene variants of the cohort, the microbiome summary comprising one or more of: a relative abundance of types of microflora found in the cohort and genes and gene variants of the microflora, and the metabolome summary comprising measurements of metabolites found in the cohort; determining a graphical representation of the genome summary, the microbiome summary, and the metabolome summary for the cohort; and sending the graphical representation to a display device. In some cases, the database further comprises a plurality of microbiomic data and a plurality of metabolomic data. The plurality of genomic data is optionally obtained by analysis of one or more biologic samples from one or more individuals. The query may further comprise one or more of: demographic information, clinical information, disease history, family history, disease treatments, physical traits, test results, diagnostic images, dietary information, lifestyle information, and cognitive assessments. In various cases, the query optionally includes a phenotype, a sample ID, an individual ID, and/or a gene name or gene variant name. In some cases, the genome summary further comprises functional effect, clinical significance, variant type, and allele frequency for the gene variants. The method may further comprise presenting a graphical user interface (GUI) for receiving the query. The GUI may allow construction of the query by adding or removing one or more of: a demographic filter, a primary diagnosis filter, a medical history filter, a lifestyle filter, a clinical measurement filter, and a laboratory measurement filter. The GUI optionally shows a number of individuals remaining in the cohort in response to each adding or removing a filter. The GUI may allow the user to configure display of the microbiome summary to show abundance by species or genus of microflora found in the individuals. The GUI may allow the user to configure display of the metabolome summary to show measurements of metabolites found in the individuals by metabolic superpathway or sub-pathway. In some cases, the genome summary, microbiome summary, and metabolome summary comprise data for individuals. The GUI may display one of the genome information, microbiome information, and metabolome information at a time and allows the user to switch among displays of the genome information, the microbiome information, and the metabolome information. In some cases, the genomic data comprises data in variant call format (VCF). In some cases, the genomic data is annotated with one or more non-genomic data upon or before import into the database. In further cases, the one or more non-genomic data comprises one or more of: demographic information, clinical information, disease history, family history, disease treatments, physical traits, test results, microbiome information, metabolome information, dietary information, lifestyle information, cognitive assessments, sample ID, and patient ID. The method may further comprise allocating at least one computing resource to the query independently of other queries. The method may further comprise allocating at least one dedicated computing resource to the query, wherein the database is shared for all queries.

In another aspect, disclosed herein are computer-implemented methods comprising generating a graphical user interface (GUI) that accepts a query from a user defining a cohort of one or more individuals and presents to the user genome information, microbiome information, and metabolome information related to the cohort.

In another aspect, disclosed herein are non-transitory computer-readable storage media encoded with a computer program including instructions executable by at least one processor to perform: receiving a query, wherein the query defines a cohort of one or more individuals; querying a database; wherein the database comprises a plurality of genomic data and a plurality of phenotype data; generating, using at least the genomic data, a genome summary, a microbiome summary, and a metabolome summary for the cohort, the genome summary comprising genes and gene variants of the cohort, the microbiome summary comprising one or more of: a relative abundance of types of microflora found in the cohort and genes and gene variants of the microflora, and the metabolome summary comprising measurements of metabolites found in the cohort; determining a graphical representation of the genome summary, the microbiome summary, and the metabolome summary for the cohort; and sending the graphical representation to a display device. In some cases, the database further comprises a plurality of microbiomic data and a plurality of metabolomic data. The plurality of genomic data is optionally obtained by analysis of one or more biologic samples from one or more individuals. The query may further comprise one or more of: demographic information, clinical information, disease history, family history, disease treatments, physical traits, test results, diagnostic images, dietary information, lifestyle information, and cognitive assessments. In various cases, the query optionally includes a phenotype, a sample ID, an individual ID, and/or a gene name or gene variant name. In some cases, the genome summary further comprises functional effect, clinical significance, variant type, and allele frequency for the gene variants. The instructions may be executable by the at least one processor to further perform presenting a graphical user interface (GUI) for receiving the query. The GUI may allow construction of the query by adding or removing one or more of: a demographic filter, a primary diagnosis filter, a medical history filter, a lifestyle filter, a clinical measurement filter, and a laboratory measurement filter. The GUI optionally shows a number of individuals remaining in the cohort in response to each adding or removing a filter. The GUI may allow the user to configure display of the microbiome summary to show abundance by species or genus of microflora found in the individuals. The GUI may allow the user to configure display of the metabolome summary to show measurements of metabolites found in the individuals by metabolic superpathway or sub-pathway. In some cases, the genome summary, microbiome summary, and metabolome summary comprise data for individuals. The GUI may display one of the genome information, microbiome information, and metabolome information at a time and allows the user to switch among displays of the genome information, the microbiome information, and the metabolome information. In some cases, the genomic data comprises data in variant call format (VCF). In some cases, the genomic data is annotated with one or more non-genomic data upon or before import into the database. In further cases, the one or more non-genomic data comprises one or more of: demographic information, clinical information, disease history, family history, disease treatments, physical traits, test results, microbiome information, metabolome information, dietary information, lifestyle information, cognitive assessments, sample ID, and patient ID. In some cases, at least one processor is allocated to the query independently of other queries. In some cases, at least one dedicated processor is allocated to the query and the database is shared for all queries.

In another aspect, disclosed herein are non-transitory computer-readable storage media encoded with a computer program including instructions executable by at least one processor to generate a graphical user interface (GUI) that accepts a query from a user defining a cohort of one or more individuals and presents to the user genome information, microbiome information, and metabolome information related to the cohort.

In another aspect, disclosed herein are platforms comprising: a database, in a computer memory, comprising biologic information for members of a population of individuals, the biologic information comprising one or more of: genome data, microbiome data, and metabolome data, the biologic information obtained by analysis of one or more biologic samples from each individual; and a processor configured to provide a biologic information visual synthesis application comprising: a software module presenting an interface allowing a user to query the database by inputting a search term; and a software module generating a visual synthesis display comprising one or more of: a genome summary, a microbiome summary, and a metabolome summary for a cohort, a demographically matched subpopulation, and the population, the genome summary comprising genes and gene variants, the microbiome summary comprising one or more of: relative abundance of types of microflora and genes and gene variants of the microflora, and the metabolome summary comprising measurements of metabolites. In some embodiments, the database further comprises phenotype data for members of the population of individuals. In further embodiments, the phenotype data comprises one or more of demographic information, clinical information, disease history, family history, disease treatments, physical traits, test results, diagnostic images, dietary information, lifestyle information, cognitive assessments, and the like. In some embodiments, the microbiome data comprises metagenomic sequences of the microbiomes. In some embodiments, the software module presenting an interface allowing a user to query the database allows the user to build a cohort of individuals from the population by applying filters to the population. In some embodiments, the software module presenting an interface allowing a user to query the database further allows the user to query the database by inputting a sample ID, a phenotypic trait, or a metabolite. In some embodiments, the software module presenting an interface allowing a user to query the database further allows the user to query the database by inputting an individual ID. In some embodiments, the software module presenting an interface allowing a user to query the database further allows the user to query the database by inputting a gene name, a gene variant, or a nucleic acid sequence. In some embodiments, the filters are one or more selected from the group consisting of: a demographic filter, a primary diagnosis filter, a medical history filter, a lifestyle filter, a clinical measurement filter, and a laboratory measurement filter. In further embodiments, the software module presenting an interface allowing the user to build a cohort of individuals displays and dynamically updates the number of individuals in the cohort as filters are applied or removed. In some embodiments, the genome summary comprises a visual display of one or more of the functional effect, the clinical significance, the variant type, and the allele frequency for the gene variants. In some embodiments, the microbiome summary comprises an interface element allowing the user to configure the microbiome summary to display abundance by species or genus of microflora. In some embodiments, the microbiome summary comprises an interface element allowing the user to configure the microbiome summary to display information obtained from a metagenomic sequence of the microbiome. In further embodiments, the information obtained from a metagenomic sequence of the microbiome comprises genes names or gene variants. In some embodiments, the metabolome summary comprises an interface element allowing the user to configure the metabolome summary to display measurements of metabolites by metabolic superpathway or sub-pathway. In some embodiments, the genome summary, microbiome summary, and metabolome summary comprise data for individuals. In some embodiments, the user optionally switches between the genome summary, the microbiome summary, and the metabolome summary to view the microbiome and the metabolome data in the context of the genome data.

In another aspect, disclosed herein are computer-implemented systems comprising: a digital processing device comprising at least one processor, an operating system configured to perform executable instructions, and a memory; and a computer program including instructions executable by the digital processing device to create a biologic information visual synthesis application comprising: a database, in a computer memory, comprising biologic information for members of a population of individuals, the biologic information comprising one or more of: genome data, microbiome data, and metabolome data, the biologic information obtained by analysis of one or more biologic samples from each individual; a software module presenting an interface allowing a user to query the database by inputting a phenotype or a software module presenting an interface allowing the user to build a cohort of individuals from the population by applying filters to the population; and a software module generating a visual synthesis display comprising one or more of: a genome summary, a microbiome summary, and a metabolome summary for the cohort, a demographically matched subpopulation, and the population, the genome summary comprising genes and gene variants, the microbiome summary comprising one or more of: relative abundance of types of microflora and genes and gene variants of the microflora, and the metabolome summary comprising measurements of metabolites. In some embodiments, the database further comprises phenotype data for members of the population of individuals. In further embodiments, the phenotype data comprises one or more of demographic information, clinical information, disease history, family history, disease treatments, physical traits, test results, diagnostic images, dietary information, lifestyle information, cognitive assessments, and the like. In some embodiments, the software module presenting an interface allowing a user to query the database further allows the user to query the database by inputting a sample ID. In some embodiments, the software module presenting an interface allowing a user to query the database further allows the user to query the database by inputting an individual ID. In some embodiments, the software module presenting an interface allowing a user to query the database further allows the user to query the database by inputting a gene name. In some embodiments, the filters are one or more selected from the group consisting of: a demographic filter, a primary diagnosis filter, a medical history filter, a lifestyle filter, a clinical measurement filter, and a laboratory measurement filter. In further embodiments, the software module presenting an interface allowing the user to build a cohort of individuals displays and dynamically updates the number of individuals in the cohort as filters are applied or removed. In some embodiments, the genome summary comprises a visual display of the functional effect, the clinical significance, the variant type, and the allele frequency for the gene variants. In some embodiments, the microbiome summary comprises an interface element allowing the user to configure the microbiome summary to display abundance by species or genus of microflora. In some embodiments, the metabolome summary comprises an interface element allowing the user to configure the metabolome summary to display measurements of metabolites by metabolic superpathway or sub-pathway. In some embodiments, the genome summary, microbiome summary, and metabolome summary comprise data for individuals. In some embodiments, the user optionally switches between the genome summary, the microbiome summary, and the metabolome summary to view the microbiome and the metabolome data in the context of the genome data.

In another aspect, disclosed herein are non-transitory computer-readable storage media encoded with a computer program including instructions executable by a processor to create a biologic information visual synthesis application comprising: a database, in a computer memory, comprising biologic information for members of a population of individuals, the biologic information comprising one or more of: genome data, microbiome data, and metabolome data, the biologic information obtained by analysis of one or more biologic samples from each individual; a software module presenting an interface allowing a user to query the database by inputting a phenotype or a software module presenting an interface allowing the user to build a cohort of individuals from the population by applying filters to the population; and a software module generating a visual synthesis display comprising one or more of: a genome summary, a microbiome summary, and a metabolome summary for the cohort, a demographically matched subpopulation, and the population, the genome summary comprising genes and gene variants, the microbiome summary comprising one or more of: relative abundance of types of microflora and genes and gene variants of the microflora, and the metabolome summary comprising measurements of metabolites. In some embodiments, the database further comprises phenotype data for members of the population of individuals. In further embodiments, the phenotype data comprises one or more of demographic information, clinical information, disease history, family history, disease treatments, physical traits, test results, diagnostic images, dietary information, lifestyle information, cognitive assessments, and the like. In some embodiments, the software module presenting an interface allowing a user to query the database further allows the user to query the database by inputting a sample ID. In some embodiments, the software module presenting an interface allowing a user to query the database further allows the user to query the database by inputting an individual ID. In some embodiments, the software module presenting an interface allowing a user to query the database further allows the user to query the database by inputting a gene name. In some embodiments, the filters are one or more selected from the group consisting of: a demographic filter, a primary diagnosis filter, a medical history filter, a lifestyle filter, a clinical measurement filter, and a laboratory measurement filter. In further embodiments, the software module presenting an interface allowing the user to build a cohort of individuals displays and dynamically updates the number of individuals in the cohort as filters are applied or removed. In some embodiments, the genome summary comprises a visual display of the functional effect, the clinical significance, the variant type, and the allele frequency for the gene variants. In some embodiments, the microbiome summary comprises an interface element allowing the user to configure the microbiome summary to display abundance by species or genus of microflora. In some embodiments, the metabolome summary comprises an interface element allowing the user to configure the metabolome summary to display measurements of metabolites by metabolic superpathway or sub-pathway. In some embodiments, the genome summary, microbiome summary, and metabolome summary comprise data for individuals. In some embodiments, the user optionally switches between the genome summary, the microbiome summary, and the metabolome summary to view the microbiome and the metabolome data in the context of the genome data.

In another aspect, disclosed herein are platforms comprising: a database, in a computer memory, comprising biologic information for a population of individuals, the biologic information comprising genome data, microbiome data, and metabolome data for each individual, the biologic information obtained by analysis of a plurality of biologic samples from each individual; and a processor configured to provide a biologic information visual synthesis application comprising: a software module presenting an interface allowing a user to query the database by inputting a phenotype; a software module presenting an interface allowing the user to build a cohort of individuals from the population by applying filters to the population; and a software module generating a visual synthesis display comprising a genome summary, a microbiome summary, and a metabolome summary for the cohort, a demographically matched subpopulation, and the population, the genome summary comprising genes and gene variants, the microbiome summary comprising relative abundance of types of microflora, and the metabolome summary comprising measurements of metabolites. In some embodiments, the software module presenting an interface allowing a user to query the database further allows the user to query the database by inputting a sample ID. In some embodiments, the software module presenting an interface allowing a user to query the database further allows the user to query the database by inputting an individual ID. In some embodiments, the software module presenting an interface allowing a user to query the database further allows the user to query the database by inputting a gene name. In some embodiments, the filters are one or more selected from the group consisting of: a demographic filter, a primary diagnosis filter, a medical history filter, a lifestyle filter, a clinical measurement filter, and a laboratory measurement filter. In further embodiments, the software module presenting an interface allowing the user to build a cohort of individuals displays and dynamically updates the number of individuals in the cohort as filters are applied or removed. In some embodiments, the genome summary comprises a visual display of the functional effect, the clinical significance, the variant type, and the allele frequency for the gene variants. In some embodiments, the microbiome summary comprises an interface element allowing the user to configure the microbiome summary to display abundance by species or genus of microflora. In some embodiments, the metabolome summary comprises an interface element allowing the user to configure the metabolome summary to display measurements of metabolites by metabolic superpathway or sub-pathway. In some embodiments, the genome summary, microbiome summary, and metabolome summary comprise data for individuals. In some embodiments, the user optionally switches between the genome summary, the microbiome summary, and the metabolome summary to view the microbiome and the metabolome data in the context of the genome data.

In another aspect, disclosed herein are computer-implemented systems comprising: a digital processing device comprising at least one processor, an operating system configured to perform executable instructions, and a memory; and a computer program including instructions executable by the digital processing device to create a biologic information visual synthesis application comprising: a database, in a computer memory, comprising biologic information for a population of individuals, the biologic information comprising genome data, microbiome data, and metabolome data for each individual, the biologic information obtained by analysis of a plurality of biologic samples from each individual; a software module presenting an interface allowing a user to query the database by inputting a phenotype; a software module presenting an interface allowing the user to build a cohort of individuals from the population by applying filters to the population; and a software module generating a visual synthesis display comprising a genome summary, a microbiome summary, and a metabolome summary for the cohort, a demographically matched subpopulation, and the population, the genome summary comprising genes and gene variants, the microbiome summary comprising relative abundance of types of microflora, and the metabolome summary comprising measurements of metabolites. In some embodiments, the software module presenting an interface allowing a user to query the database further allows the user to query the database by inputting a sample ID. In some embodiments, the software module presenting an interface allowing a user to query the database further allows the user to query the database by inputting an individual ID. In some embodiments, the software module presenting an interface allowing a user to query the database further allows the user to query the database by inputting a gene name. In some embodiments, the filters are one or more selected from the group consisting of: a demographic filter, a primary diagnosis filter, a medical history filter, a lifestyle filter, a clinical measurement filter, and a laboratory measurement filter. In further embodiments, the software module presenting an interface allowing the user to build a cohort of individuals displays and dynamically updates the number of individuals in the cohort as filters are applied or removed. In some embodiments, the genome summary comprises a visual display of the functional effect, the clinical significance, the variant type, and the allele frequency for the gene variants. In some embodiments, the microbiome summary comprises an interface element allowing the user to configure the microbiome summary to display abundance by species or genus of microflora. In some embodiments, the metabolome summary comprises an interface element allowing the user to configure the metabolome summary to display measurements of metabolites by metabolic superpathway or sub-pathway. In some embodiments, the genome summary, microbiome summary, and metabolome summary comprise data for individuals. In some embodiments, the user optionally switches between the genome summary, the microbiome summary, and the metabolome summary to view the microbiome and the metabolome data in the context of the genome data.

In another aspect, disclosed herein are non-transitory computer-readable storage media encoded with a computer program including instructions executable by a processor to create a biologic information visual synthesis application comprising: a database, in a computer memory, comprising biologic information for a population of individuals, the biologic information comprising genome data, microbiome data, and metabolome data for each individual, the biologic information obtained by analysis of a plurality of biologic samples from each individual; a software module presenting an interface allowing a user to query the database by inputting a phenotype; a software module presenting an interface allowing the user to build a cohort of individuals from the population by applying filters to the population; and a software module generating a visual synthesis display comprising a genome summary, a microbiome summary, and a metabolome summary for the cohort, a demographically matched subpopulation, and the population, the genome summary comprising genes and gene variants, the microbiome summary comprising relative abundance of types of microflora, and the metabolome summary comprising measurements of metabolites. In some embodiments, the software module presenting an interface allowing a user to query the database further allows the user to query the database by inputting a sample ID. In some embodiments, the software module presenting an interface allowing a user to query the database further allows the user to query the database by inputting an individual ID. In some embodiments, the software module presenting an interface allowing a user to query the database further allows the user to query the database by inputting a gene name. In some embodiments, the filters are one or more selected from the group consisting of: a demographic filter, a primary diagnosis filter, a medical history filter, a lifestyle filter, a clinical measurement filter, and a laboratory measurement filter. In further embodiments, the software module presenting an interface allowing the user to build a cohort of individuals displays and dynamically updates the number of individuals in the cohort as filters are applied or removed. In some embodiments, the genome summary comprises a visual display of the functional effect, the clinical significance, the variant type, and the allele frequency for the gene variants. In some embodiments, the microbiome summary comprises an interface element allowing the user to configure the microbiome summary to display abundance by species or genus of microflora. In some embodiments, the metabolome summary comprises an interface element allowing the user to configure the metabolome summary to display measurements of metabolites by metabolic superpathway or sub-pathway. In some embodiments, the genome summary, microbiome summary, and metabolome summary comprise data for individuals. In some embodiments, the user optionally switches between the genome summary, the microbiome summary, and the metabolome summary to view the microbiome and the metabolome data in the context of the genome data.

In another aspect, disclosed herein are platforms comprising: a database, in a computer memory, comprising biologic information for members of a population of individuals, the biologic information comprising genome data, the biologic information obtained by analysis of one or more biologic samples from each individual, each individual and sample having an ID; and a processor configured to provide a biologic information visual synthesis application comprising: a software module presenting an interface allowing a user to query the database by one or more of: inputting a phenotype, inputting a gene name, inputting an individual ID, and inputting a sample ID; a software module generating a genome browser, the genome browser comprising: a whole genome display comprising an icon representing each chromosome, each icon indicating a density of gene variants; and a chromosome display comprising an iconic representation of each chromosome, the representation indicating a density of gene variants located at the relevant portion of the chromosome, wherein selection of a chromosome by a user generates a linear display of the chromosome demonstrating the spatial relationship on the chromosome of the genes and the variants; and a software module generating a lineage viewer, the lineage viewer comprising: a geographic display of autosomal ancestry, a geographic display of maternal line ancestry, and a geographic display of paternal line ancestry. In some embodiments, the database further comprises phenotype data for members of the population of individuals. In further embodiments, the phenotype data comprises one or more of demographic information, clinical information, disease history, family history, disease treatments, physical traits, test results, diagnostic images, dietary information, lifestyle information, cognitive assessments, and the like. In some embodiments, the geographic displays are in map form. In some embodiments, the whole genome display is circular. In some embodiments, the variants are visually distinguished by type. In some embodiments, the genome browser further comprises an interface for allowing the user to apply filters to the variants, the filters comprising one more selected from the group consisting of: clinical significance, functional effects, variant type, and zygosity.

In another aspect, disclosed herein are computer-implemented systems comprising: a digital processing device comprising at least one processor, an operating system configured to perform executable instructions, and a memory; and a computer program including instructions executable by the digital processing device to create a biologic information visual synthesis application comprising: a software module presenting an interface allowing a user to query the database one or more of: inputting a phenotype, inputting a gene name, inputting an individual ID, and inputting a sample ID; a software module generating a genome browser, the genome browser comprising: a whole genome display comprising an icon representing each chromosome, each icon indicating a density of gene variants; and a chromosome display comprising an iconic representation of each chromosome, the representation indicating a density of gene variants located at the relevant portion of the chromosome, wherein selection of a chromosome by a user generates a linear display of the chromosome demonstrating the spatial relationship on the chromosome of the genes and the variants; and a software module generating a lineage viewer, the lineage viewer comprising: a geographic display of autosomal ancestry, a geographic display of maternal line ancestry, and a geographic display of paternal line ancestry. In some embodiments, the database further comprises phenotype data for members of the population of individuals. In further embodiments, the phenotype data comprises one or more of demographic information, clinical information, disease history, family history, disease treatments, physical traits, test results, diagnostic images, dietary information, lifestyle information, cognitive assessments, and the like. In some embodiments, the geographic displays are in map form. In some embodiments, the whole genome display is circular. In some embodiments, the variants are visually distinguished by type. In some embodiments, the genome browser further comprises an interface for allowing the user to apply filters to the variants, the filters comprising one more selected from the group consisting of: clinical significance, functional effects, variant type, and zygosity.

In another aspect, disclosed herein are non-transitory computer-readable storage media encoded with a computer program including instructions executable by a processor to create a biologic information visual synthesis application comprising: a software module presenting an interface allowing a user to query the database one or more of: inputting a phenotype, inputting a gene name, inputting an individual ID, and inputting a sample ID; a software module generating a genome browser, the genome browser comprising: a whole genome display comprising an icon representing each chromosome, each icon indicating a density of gene variants; and a chromosome display comprising an iconic representation of each chromosome, the representation indicating a density of gene variants located at the relevant portion of the chromosome, wherein selection of a chromosome by a user generates a linear display of the chromosome demonstrating the spatial relationship on the chromosome of the genes and the variants; and a software module generating a lineage viewer, the lineage viewer comprising: a geographic display autosomal ancestry, a geographic display of maternal line ancestry, and a geographic display of paternal line ancestry. In some embodiments, the database further comprises phenotype data for members of the population of individuals. In further embodiments, the phenotype data comprises one or more of demographic information, clinical information, disease history, family history, disease treatments, physical traits, test results, diagnostic images, dietary information, lifestyle information, cognitive assessments, and the like. In some embodiments, the geographic displays are in map form. In some embodiments, the whole genome display is circular. In some embodiments, the variants are visually distinguished by type. In some embodiments, the genome browser further comprises an interface for allowing the user to apply filters to the variants, the filters comprising one more selected from the group consisting of: clinical significance, functional effects, variant type, and zygosity.

### BRIEF DESCRIPTION OF THE DRAWINGS

FIG. 1 illustrates that a user is presented with a home page.

FIG. 2 illustrates that a user can log in with the user's credentials.

FIG. 3 illustrates that the user can be further authenticated.

FIG. 4 illustrates a dashboard.

FIG. 5 illustrates a dashboard.

FIG. 6 illustrates a demographics summary.

FIG. 7 illustrates a demographics summary.

FIG. 8 illustrates a user interface.

FIG. 9 illustrates another user interface.

FIG. 10 illustrates HLA type information.

FIG. 11 illustrates a dashboard summary.

FIG. 12 illustrates a dashboard summary.

FIG. 13 shows a non-limiting example of a user interface for a biologic information visual synthesis application; in this case, an interface allowing a user to review and access saved queries.

FIG. 14 shows a non-limiting example of a user interface for a biologic information visual synthesis application; in this case, a query type interface allowing a user to initiate a query of the biologic information for an individual, a user-configured cohort, or the entire database of biologic information.

FIG. 15 shows a non-limiting example of a user interface for a biologic information visual synthesis application; in this case, a query type interface indicating query by phenotype.

FIG. 16 shows a non-limiting example of a user interface for a biologic information visual synthesis application; in this case, a query type interface indicating query by individual.

FIG. 17 shows a non-limiting example of a user interface for a biologic information visual synthesis application; in this case, an interface for entering one or more individual ID numbers.

FIG. 18 shows a non-limiting example of a user interface for a biologic information visual synthesis application; in this case, a query type interface indicating query by gene name.

FIG. 19 shows a non-limiting example of a user interface for a biologic information visual synthesis application; in this case, an interface for entering one or more gene names.

FIG. 20 shows a non-limiting example of a user interface for a biologic information visual synthesis application; in this case, an interface for summarizing individuals with regard to an identified gene.

FIG. 21 shows a non-limiting example of a user interface for a biologic information visual synthesis application; in this case, an interface for summarizing the genomic variants of an identified gene.

FIG. 22 shows a non-limiting example of a user interface for a biologic information visual synthesis application; in this case, an interface for reviewing the genomic variants of an identified gene.

FIG. 23 shows a non-limiting example of flowchart for a process of a biologic information visual synthesis application; in this case, a diagram depicting a gene data query.

FIG. 24 shows a non-limiting example of a user interface for a biologic information visual synthesis application; in this case, a query type interface indicating query by biological sample.

FIG. 25 shows a non-limiting example of a user interface for a biologic information visual synthesis application; in this case, an interface for entering a sample ID number.

FIG. 26 shows a non-limiting example of flowchart for a process of a biologic information visual synthesis application; in this case, a diagram depicting a sample data query.

FIG. 27 shows a non-limiting example of a user interface for a biologic information visual synthesis application; in this case, a query type interface indicating query to analyze a cohort by phenotype.

FIG. 28 illustrates a summary dashboard page.

FIG. 29 illustrates a user interface that allows a user to select the user's own control population.

FIG. 30 shows a non-limiting example of a user interface for a biologic information visual synthesis application; in this case, an interface for reviewing the genomic characteristics, e.g., genomic variants, of a cohort.

FIG. 31 shows a non-limiting example of a user interface for a biologic information visual synthesis application; in this case, an interface for reviewing the microbiome characteristics, e.g., microbial phylum abundance of a cohort compared to an overall population.

FIG. 32 shows a non-limiting example of a user interface for a biologic information visual synthesis application; in this case, an interface for reviewing the metabolome characteristics of a cohort compared to an overall population.

FIGS. 33-38 show non-limiting examples of a user interface for a biologic information visual synthesis application; in this case, interfaces for reviewing the genomic characteristics of a cohort identified by phenotype, e.g., primary diagnosis of Crohn's disease or ulcerative colitis.

FIGS. 39-42 show non-limiting examples of a user interface for a biologic information visual synthesis application; in this case, user-configurable interfaces for reviewing the metadata for individuals of a cohort identified by medical history and lifestyle history, e.g., history of type 2 diabetes.

FIG. 43 shows a non-limiting example of a user interface for a biologic information visual synthesis application; in this case, an interface for summarizing the genomic variants of a cohort identified by medical history and lifestyle history, e.g., history of type 2 diabetes, with regard to functional effect, clinical significance, variant type, and allele frequency and for summarizing the individuals of a cohort with regard to age, gender, ethnicity, and primary diagnosis.

FIGS. 44-46 show non-limiting examples of a user interface for a biologic information visual synthesis application; in this case, interfaces for reviewing the microbiome characteristics, e.g., microbial phylum abundance, etc., of a cohort identified by medical history and lifestyle history, e.g., history of type 2 diabetes.

FIG. 47 illustrates a phylogenetic tree.

FIGS. 48 and 49 show non-limiting examples of a user interface for a biologic information visual synthesis application; in this case, interfaces for reviewing the metabolome characteristics, e.g., biochemical pathways, etc., of a cohort identified by medical history and lifestyle history, e.g., history of type 2 diabetes.

FIG. 50 illustrates a page of metabolome information.

FIG. 51 shows a non-limiting example of a user interface for a biologic information visual synthesis application; in this case, a user-configurable interface for analyzing, e.g., generating a custom graph of, the characteristics of a cohort identified by medical history and lifestyle history, e.g., history of type 2 diabetes.

FIG. 52 illustrates a table of the genes that contain variants in the selected cohorts.

FIG. 53 illustrates a panel of extra annotation information about the gene selected in the table.

FIGS. 54-56 illustrate the pathway analysis capability.

FIGS. 57-60 illustrate the cohort comparison capability.

FIGS. 61-63 illustrate the account management capability.

FIG. 64 shows a non-limiting example of a user interface for a biologic information visual synthesis application; in this case, a query type interface indicating query of the entire population by genomic variant, wherein names of variants of interest are listed.

FIG. 65 shows a non-limiting example of a user interface for a biologic information visual synthesis application; in this case, a genomic variant filter interface.

FIG. 66 shows a non-limiting example of a user interface for a biologic information visual synthesis application; in this case, a query type interface indicating query of the entire population by genomic variant, wherein names of variants of interest are listed.

FIG. 67 shows a non-limiting example of a user interface for a biologic information visual synthesis application; in this case, an interface for reviewing the genomic variants of an identified sample.

FIGS. 68 and 69 show non-limiting examples of a user interface for a biologic information visual synthesis application; in this case, interfaces for an individual genome browser tool.

FIGS. 70 and 71 show non-limiting examples of a user interface for a biologic information visual synthesis application; in this case, interfaces for an individual lineage viewer tool.

FIG. 72 shows a non-limiting example of a user interface for a biologic information visual synthesis application; in this case, an interface for managing user accounts including individual and group accounts.

FIG. 73 shows a non-limiting example of a user interface for a biologic information visual synthesis application; in this case, an interface for building a cohort wherein demographic filters are available.

FIG. 74 shows a non-limiting example of a user interface for a biologic information visual synthesis application; in this case, an interface for building a cohort wherein demographic filters are applied.

FIG. 75 shows a non-limiting example of a user interface for a biologic information visual synthesis application; in this case, an interface for building a cohort wherein primary diagnosis filters are available.

FIG. 76 shows a non-limiting example of a user interface for a biologic information visual synthesis application; in this case, an interface for building a cohort wherein primary diagnosis filters are applied.

FIG. 77 shows a non-limiting example of a user interface for a biologic information visual synthesis application; in this case, an interface for building a cohort wherein medical history and lifestyle filters are available.

FIG. 78 shows a non-limiting example of a user interface for a biologic information visual synthesis application; in this case, an interface for building a cohort wherein medical history and lifestyle filters are applied.

FIG. 79 shows a non-limiting example of a user interface for a biologic information visual synthesis application; in this case, an interface for building a cohort wherein clinical measurement and laboratory measurement filters are available.

FIG. 80 shows a non-limiting example of a user interface for a biologic information visual synthesis application; in this case, an interface for building a cohort wherein clinical measurement and laboratory measurement filters are applied and a histogram of a selected test substance is displayed.

FIG. 81 shows a non-limiting example of a user interface for a biologic information visual synthesis application; in this case, an interface for summarizing the individuals of a cohort with regard to age, gender, ethnicity, and primary diagnosis.

FIG. 82 shows a non-limiting example of a user interface for a biologic information visual synthesis application; in this case, an interface for summarizing the genomic variants of a cohort with regard to functional effect, clinical significance, variant type, and allele frequency.

FIG. 83 shows a non-limiting example of flowchart for a process of a biologic information visual synthesis application; in this case, a diagram depicting ingress of hg38 data.

FIG. 84 shows a non-limiting example of flowchart for a process of a biologic information visual synthesis application; in this case, a diagram depicting ingress of a gVCF.

FIG. 85 shows a non-limiting example of flowchart for a process of a biologic information visual synthesis application; in this case, a diagram depicting annotation preparation.

FIG. 86 shows a non-limiting example of flowchart for a process of a biologic information visual synthesis application; in this case, a diagram depicting gVCF preparation.

FIG. 87 shows a non-limiting example of architecture diagram for a biologic information visual synthesis application; in this case, a diagram depicting an overall structure for the biologic information platform.

FIG. 88 shows a non-limiting example of architecture diagram for a biologic information visual synthesis application; in this case, a diagram depicting a managed cluster of clusters.

FIG. 89 shows a non-limiting example of architecture diagram for a biologic information visual synthesis application; in this case, a diagram depicting parallel production and research services drawing from a common data lake.

FIG. 90 shows a non-limiting example of architecture diagram for a biologic information visual synthesis application; in this case, a diagram depicting ingress of raw data into a data lake to provide a plurality of services, including querying, annotation, and reporting services, to clients.

FIGS. 91 and 92 show non-limiting examples of architecture diagrams for a biologic information visual synthesis application; in this case, diagrams depicting exemplary architectures for the biologic information platform.

FIG. 93 shows a non-limiting example of architecture diagram for a biologic information visual synthesis application; in this case, a diagram depicting an architecture preserving computing resources and significantly enhancing scalability and efficiency of the application.

FIGS. 94 and 95 illustrate an exemplary architecture for the query engine.

FIG. 96 illustrates an exemplary architecture for the system.

FIG. 97 illustrates an exemplary cohort creation process.

FIG. 98 illustrates an exemplary subcohort creation process.

### DETAILED DESCRIPTION OF THE INVENTION

Described herein are computer-implemented systems comprising: at least one memory storing computer-executable instructions; and at least one processor configured to access the at least one memory and execute the computer-executable instructions to perform: receiving a query, wherein the query defines a cohort of one or more individuals; querying a database; wherein the database comprises a plurality of genomic data and a plurality of phenotype data; generating, using at least the genomic data, a genome summary, a microbiome summary, and a metabolome summary for the cohort, the genome summary comprising genes and gene variants of the cohort, the microbiome summary comprising one or more of: a relative abundance of types of microflora found in the cohort and genes and gene variants of the microflora, and the metabolome summary comprising measurements of metabolites found in the cohort; determining a graphical representation of the genome summary, the microbiome summary, and the metabolome summary for the cohort; and sending the graphical representation to a display device.

Also described herein are computer-implemented systems comprising: at least one memory storing computer-executable instructions; and at least one processor configured to access the at least one memory and execute the computer-executable instructions to generate a graphical user interface (GUI) that accepts a query from a user defining a cohort of one or more individuals and presents to the user genome information, microbiome information, and metabolome information related to the cohort.

Also described herein are computer-implemented methods comprising: receiving a query, wherein the query defines a cohort of one or more individuals; querying a database; wherein the database comprises a plurality of genomic data and a plurality of phenotype data; generating, using at least the genomic data, a genome summary, a microbiome summary, and a metabolome summary for the cohort, the genome summary comprising genes and gene variants of the cohort, the microbiome summary comprising one or more of: a relative abundance of types of microflora found in the cohort and genes and gene variants of the microflora, and the metabolome summary comprising measurements of metabolites found in the cohort; determining a graphical representation of the genome summary, the microbiome summary, and the metabolome summary for the cohort; and sending the graphical representation to a display device.

Also described herein are computer-implemented methods comprising generating a graphical user interface (GUI) that accepts a query from a user defining a cohort of one or more individuals and presents to the user genome information, microbiome information, and metabolome information related to the cohort.

Also described herein are non-transitory computer-readable storage media encoded with a computer program including instructions executable by at least one processor to perform: receiving a query, wherein the query defines a cohort of one or more individuals; querying a database; wherein the database comprises a plurality of genomic data and a plurality of phenotype data; generating, using at least the genomic data, a genome summary, a microbiome summary, and a metabolome summary for the cohort, the genome summary comprising genes and gene variants of the cohort, the microbiome summary comprising one or more of: a relative abundance of types of microflora found in the cohort and genes and gene variants of the microflora, and the metabolome summary comprising measurements of metabolites found in the cohort; determining a graphical representation of the genome summary, the microbiome summary, and the metabolome summary for the cohort; and sending the graphical representation to a display device.

Also described herein are non-transitory computer-readable storage media encoded with a computer program including instructions executable by at least one processor to generate a graphical user interface (GUI) that accepts a query from a user defining a cohort of one or more individuals and presents to the user genome information, microbiome information, and metabolome information related to the cohort.

Also described herein are platforms comprising: a database, in a computer memory, comprising biologic information for members of a population of individuals, the biologic information comprising one or more of: genome data, microbiome data, and metabolome data, the biologic information obtained by analysis of one or more biologic samples from each individual; and a processor configured to provide a biologic information visual synthesis application comprising: a software module presenting an interface allowing a user to query the database by inputting a search term; and a software module generating a visual synthesis display comprising one or more of: a genome summary, a microbiome summary, and a metabolome summary for a cohort, a demographically matched subpopulation, and the population, the genome summary comprising genes and gene variants, the microbiome summary comprising one or more of: relative abundance of types of microflora and genes and gene variants of the microflora, and the metabolome summary comprising measurements of metabolites.

Also described herein are computer-implemented systems comprising: a digital processing device comprising at least one processor, an operating system configured to perform executable instructions, and a memory; and a computer program including instructions executable by the digital processing device to create a biologic information visual synthesis application comprising: a database, in a computer memory, comprising biologic information for members of a population of individuals, the biologic information comprising one or more of: genome data, microbiome data, and metabolome data, the biologic information obtained by analysis of one or more biologic samples from each individual; a software module presenting an interface allowing a user to query the database by inputting a phenotype or a software module presenting an interface allowing the user to build a cohort of individuals from the population by applying filters to the population; and a software module generating a visual synthesis display comprising one or more of: a genome summary, a microbiome summary, and a metabolome summary for the cohort, a demographically matched subpopulation, and the population, the genome summary comprising genes and gene variants, the microbiome summary comprising one or more of: relative abundance of types of microflora and genes and gene variants of the microflora, and the metabolome summary comprising measurements of metabolites.

Also described herein are non-transitory computer-readable storage media encoded with a computer program including instructions executable by a processor to create a biologic information visual synthesis application comprising: a database, in a computer memory, comprising biologic information for members of a population of individuals, the biologic information comprising one or more of: genome data, microbiome data, and metabolome data, the biologic information obtained by analysis of one or more biologic samples from each individual; a software module presenting an interface allowing a user to query the database by inputting a phenotype or a software module presenting an interface allowing the user to build a cohort of individuals from the population by applying filters to the population; and a software module generating a visual synthesis display comprising one or more of: a genome summary, a microbiome summary, and a metabolome summary for the cohort, a demographically matched subpopulation, and the population, the genome summary comprising genes and gene variants, the microbiome summary comprising one or more of: relative abundance of types of microflora and genes and gene variants of the microflora, and the metabolome summary comprising measurements of metabolites.

Also described herein are platforms comprising: a database, in a computer memory, comprising biologic information for a population of individuals, the biologic information comprising genome data, microbiome data, and metabolome data for each individual, the biologic information obtained by analysis of a plurality of biologic samples from each individual; and a processor configured to provide a biologic information visual synthesis application comprising: a software module presenting an interface allowing a user to query the database by inputting a phenotype; a software module presenting an interface allowing the user to build a cohort of individuals from the population by applying filters to the population; and a software module generating a visual synthesis display comprising a genome summary, a microbiome summary, and a metabolome summary for the cohort, a demographically matched subpopulation, and the population, the genome summary comprising genes and gene variants, the microbiome summary comprising relative abundance of types of microflora, and the metabolome summary comprising measurements of metabolites.

Also described herein are computer-implemented systems comprising: a digital processing device comprising at least one processor, an operating system configured to perform executable instructions, and a memory; and a computer program including instructions executable by the digital processing device to create a biologic information visual synthesis application comprising: a database, in a computer memory, comprising biologic information for a population of individuals, the biologic information comprising genome data, microbiome data, and metabolome data for each individual, the biologic information obtained by analysis of a plurality of biologic samples from each individual; a software module presenting an interface allowing a user to query the database by inputting a phenotype; a software module presenting an interface allowing the user to build a cohort of individuals from the population by applying filters to the population; and a software module generating a visual synthesis display comprising a genome summary, a microbiome summary, and a metabolome summary for the cohort, a demographically matched subpopulation, and the population, the genome summary comprising genes and gene variants, the microbiome summary comprising relative abundance of types of microflora, and the metabolome summary comprising measurements of metabolites.

Also described herein are non-transitory computer-readable storage media encoded with a computer program including instructions executable by a processor to create a biologic information visual synthesis application comprising: a database, in a computer memory, comprising biologic information for a population of individuals, the biologic information comprising genome data, microbiome data, and metabolome data for each individual, the biologic information obtained by analysis of a plurality of biologic samples from each individual; a software module presenting an interface allowing a user to query the database by inputting a phenotype; a software module presenting an interface allowing the user to build a cohort of individuals from the population by applying filters to the population; and a software module generating a visual synthesis display comprising a genome summary, a microbiome summary, and a metabolome summary for the cohort, a demographically matched subpopulation, and the population, the genome summary comprising genes and gene variants, the microbiome summary comprising relative abundance of types of microflora, and the metabolome summary comprising measurements of metabolites.

Also described herein are platforms comprising: a database, in a computer memory, comprising biologic information for member of a population of individuals, the biologic information comprising genome data, the biologic information obtained by analysis of one or more biologic samples from each individual, each individual and sample having an ID; and a processor configured to provide a biologic information visual synthesis application comprising: a software module presenting an interface allowing a user to query the database one or more of: inputting a phenotype, inputting a gene name, inputting an individual ID, and inputting a sample ID; a software module generating a genome browser, the genome browser comprising: a whole genome display comprising an icon representing each chromosome, each icon indicating a density of gene variants; and a chromosome display comprising an iconic representation of each chromosome, the representation indicating a density of gene variants located at the relevant portion of the chromosome, wherein selection of a chromosome by a user generates a linear display of the chromosome demonstrating the spatial relationship on the chromosome of the genes and the variants; and a software module generating a lineage viewer, the lineage viewer comprising: a geographic display of autosomal ancestry, a geographic display of maternal line ancestry, and a geographic display of paternal line ancestry.

Also described herein are computer-implemented systems comprising: a digital processing device comprising at least one processor, an operating system configured to perform executable instructions, and a memory; and a computer program including instructions executable by the digital processing device to create a biologic information visual synthesis application comprising: a software module presenting an interface allowing a user to query the database one or more of: inputting a phenotype, inputting a gene name, inputting an individual ID, and inputting a sample ID; a software module generating a genome browser, the genome browser comprising: a whole genome display comprising an icon representing each chromosome, each icon indicating a density of gene variants; and a chromosome display comprising an iconic representation of each chromosome, the representation indicating a density of gene variants located at the relevant portion of the chromosome, wherein selection of a chromosome by a user generates a linear display of the chromosome demonstrating the spatial relationship on the chromosome of the genes and the variants; and a software module generating a lineage viewer, the lineage viewer comprising: a geographic display of autosomal ancestry, a geographic display of maternal line ancestry, and a geographic display of paternal line ancestry.

Also described herein are non-transitory computer-readable storage media encoded with a computer program including instructions executable by a processor to create a biologic information visual synthesis application comprising: a software module presenting an interface allowing a user to query the database one or more of: inputting a phenotype, inputting a gene name, inputting an individual ID, and inputting a sample ID; a software module generating a genome browser, the genome browser comprising: a whole genome display comprising an icon representing each chromosome, each icon indicating a density of gene variants; and a chromosome display comprising an iconic representation of each chromosome, the representation indicating a density of gene variants located at the relevant portion of the chromosome, wherein selection of a chromosome by a user generates a linear display of the chromosome demonstrating the spatial relationship on the chromosome of the genes and the variants; and a software module generating a lineage viewer, the lineage viewer comprising: a geographic display of autosomal ancestry, a geographic display of maternal line ancestry, and a geographic display of paternal line ancestry.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, “cohort” means a group of one or more individuals banded together or treated as a group.

### Overview

Described herein is a cloud-based solution for the storage, query, and analysis of longitudinal data comprising a multiplicity of whole genomes, a large number of public and proprietary annotation sources as well as associated high quality phenotypic data, including microbiome metagenomes and metabolomics profiles. In various embodiments, the data analyzed by the platforms, systems, media, and methods described herein comprises more than 1,000, more than 5,000, more than 10,000, more than 20,000, more than 50,000, more than 100,000, more than 500,000, or more than 1,000,000 whole genomes.

The data analyzed by the platforms, systems, media, and methods described herein comprises genomic data. The genomic data is produced, by way of example, at a next generation sequencing (NGS) lab. In some cases, an AWS analysis pipeline based on Illumina's HiSeq X and the ISIS Analysis Software are utilized to produce the genomic data. Sequencing reads are mapped to the hg38 human reference sequence and the Isaac Variant Caller is used to call single nucleotide variants (SNVs) and insertions and deletions (indels). The genomic data comprises a multiplicity of unique SNVs. By way of examples, the genomic data comprises over 1 million, over 10 million, over 50 million, over 100 million, over 500 million, or over 1 billion unique SNVs.

The data analyzed by the platforms, systems, media, and methods described herein comprises metadata. The whole genomes are associated with high quality phenotypic information. A proprietary phenotype ingestion process enables the cleaning and standardization of phenotype data across disparate data sources. In some embodiments, the ingestion process includes: data integrity checks; standardization of units; standardization of terms; ontology/vocabulary mapping; and maintenance of the proprietary data dictionary.

In various embodiments, the phenotype data comprises more than 1000, more than 5000, more than 10,000, more than 100,000, more than 1,000,000, or more than 10,000,000 phenotype data fields with, more than 1 million, more than 5 million, more than 10 million, more than 50 million, more than 100 million, more than 500 million, or more than 1 billion data points.

The data analyzed by the platforms, systems, media, and methods described herein comprises annotation data. Annotation data is also cleaned and standardized through an automated end-to-end solution, which allows: idempotence, immutability, persistence; high quality data; consistency between data sources; and scalability and flexibility.

### Population of Individuals

The platforms, systems, media, and methods described herein include biologic data pertaining to a population of individuals, or use of the same. In various embodiments, the population of individuals comprises more than 1,000, more than 5,000, more than 10,000, more than 20,000, more than 50,000, or more than 100,000, more than 500,000, more than 1,000,000 more than 10,000,000, more than 50,000,000, or more than 100,000,000 individuals. In some cases, the individuals in the population participated in academic medical research studies using consents allowing for genetic testing of specimens. In such cases, biologic specimens and phenotype data are collected for individuals from pharmaceutical clinical trials, academic research, and health care settings. In some cases, biologic data pertaining to a population of individuals is collected from integrated health records for individuals representing a spectrum of diseases with unmet medical needs.

### Biologic Information

The platforms, systems, media, and methods described herein include biologic information, or use of the same. In some embodiments, the biologic information comprises whole human genome sequencing information.

The biologic information comprises microbiome information. As used herein, “microbiome” refers to the bacteria and other microorganisms that live in and on the human body. In some embodiments, the microbiome information comprises metagenomic microbiome characterization. In various embodiments, the microbiome information comprises one or more of: microflora genus and/or species information, microflora relative abundance information, and microflora gene and/or gene variant information.

The biologic information comprises metabolome information. As used herein, “metabolome” refers to the small-molecule chemicals found within a biological sample. In some embodiments, metabolome information comprises the presence of one or more small-molecule chemicals. In further embodiments, the metabolome information comprises a qualitative measurement of one or more small-molecule chemicals. In still further embodiments, the metabolome information comprises a quantitative measurement of one or more small-molecule chemicals. In various embodiments, the microbiome information comprises measurements of at least 100, at least 200, at least 300, at least 400, at least 500, at least 600, at least 700, at least 800, at least 900, at least 1000, at least 1100, at least 1200, at least 1300, at least 1400, or at least 1500 substances (e.g., molecules).

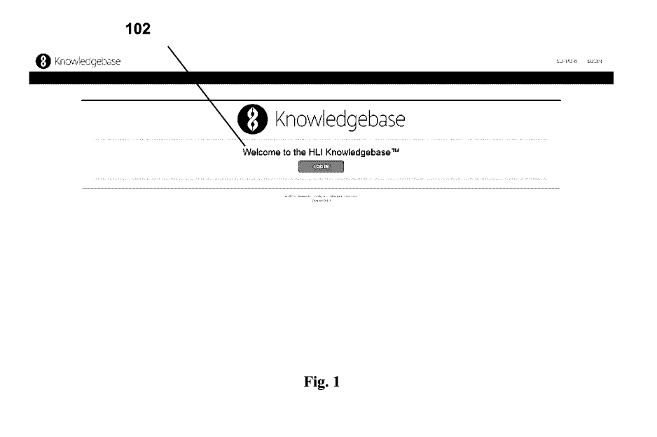

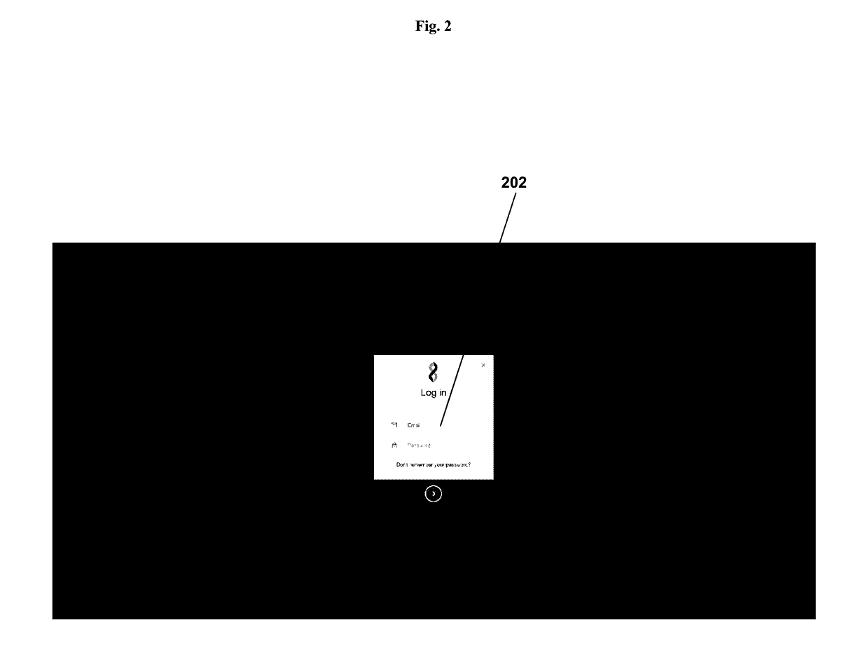

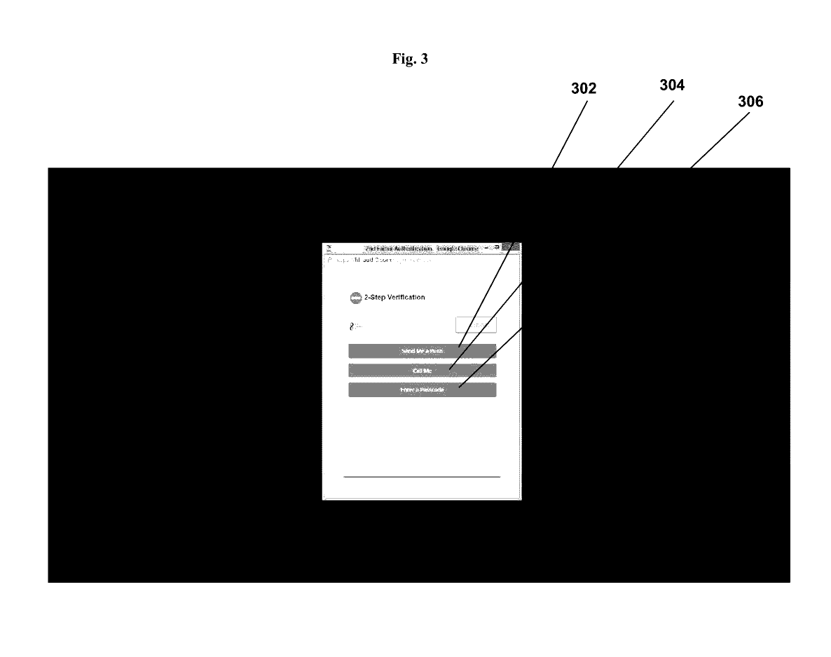

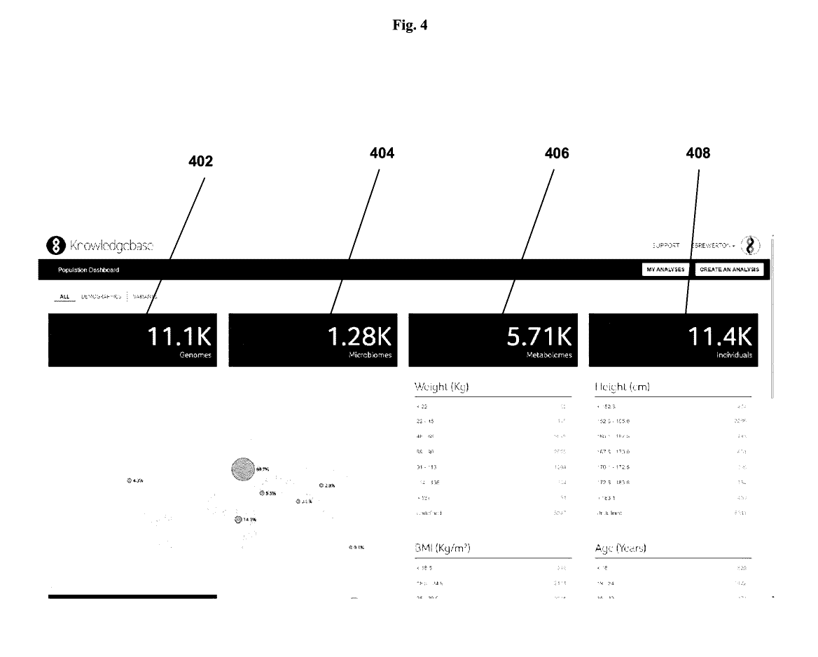

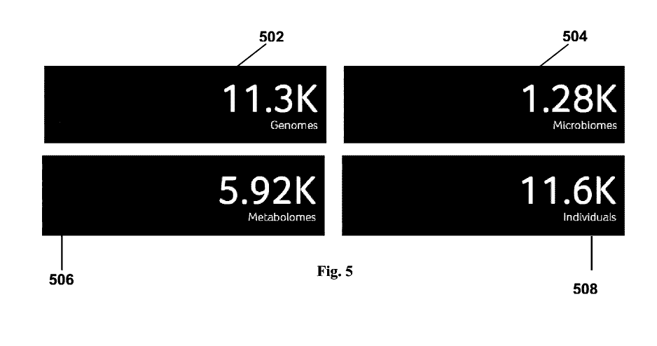

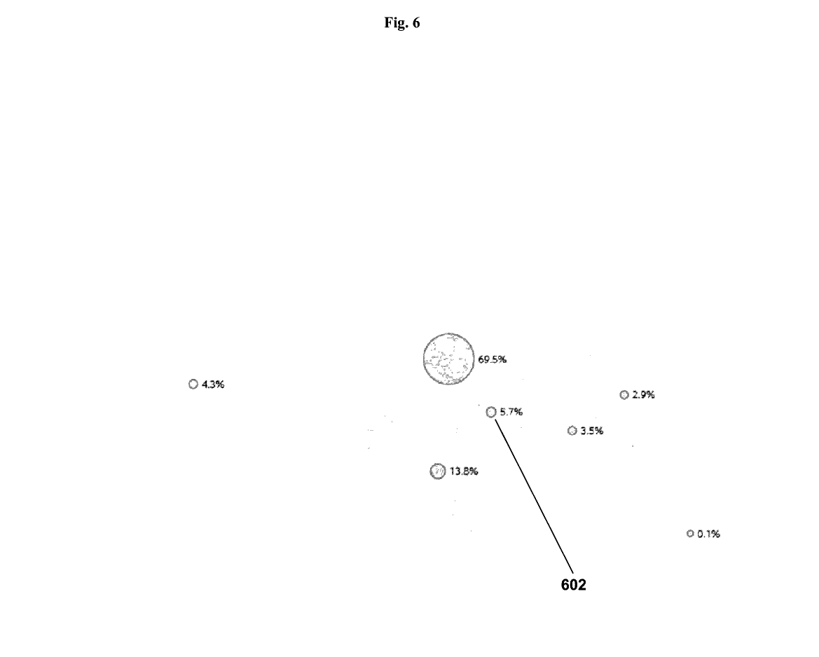

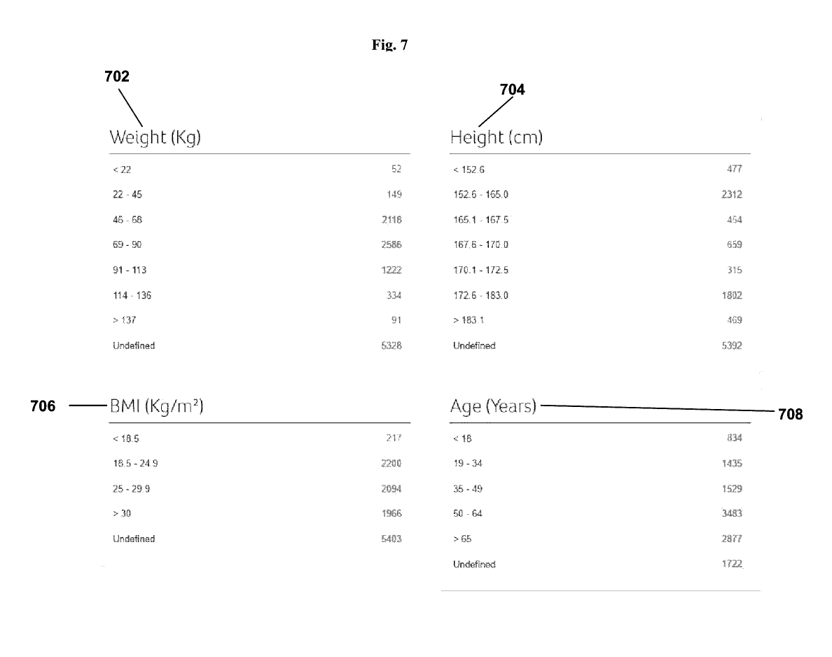

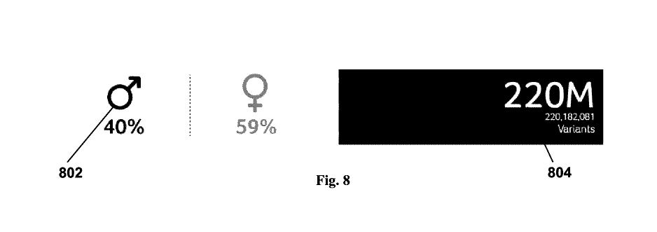

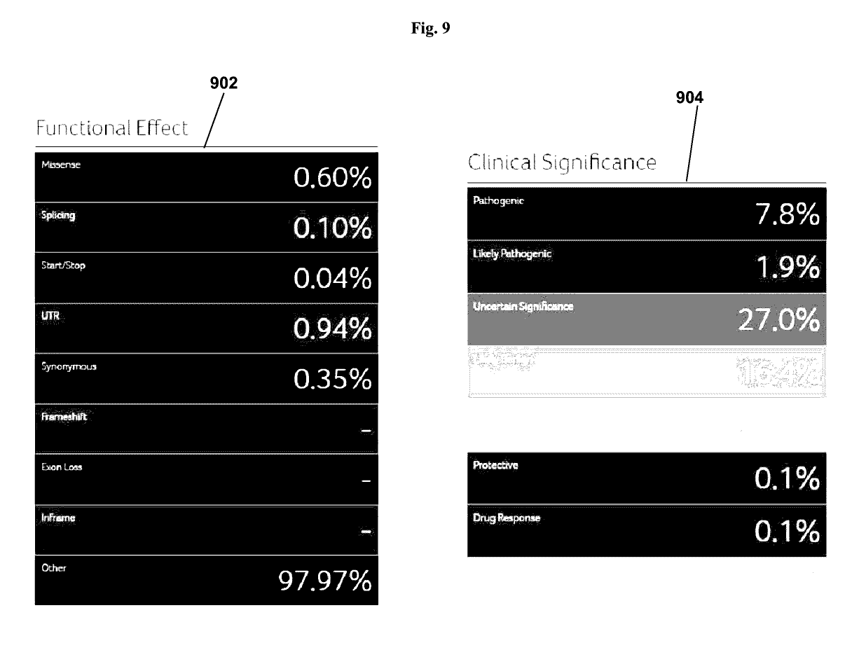

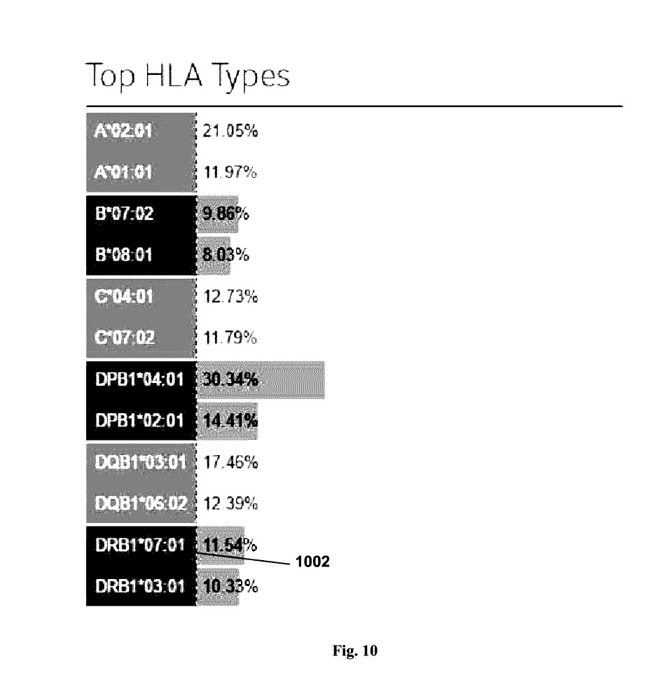

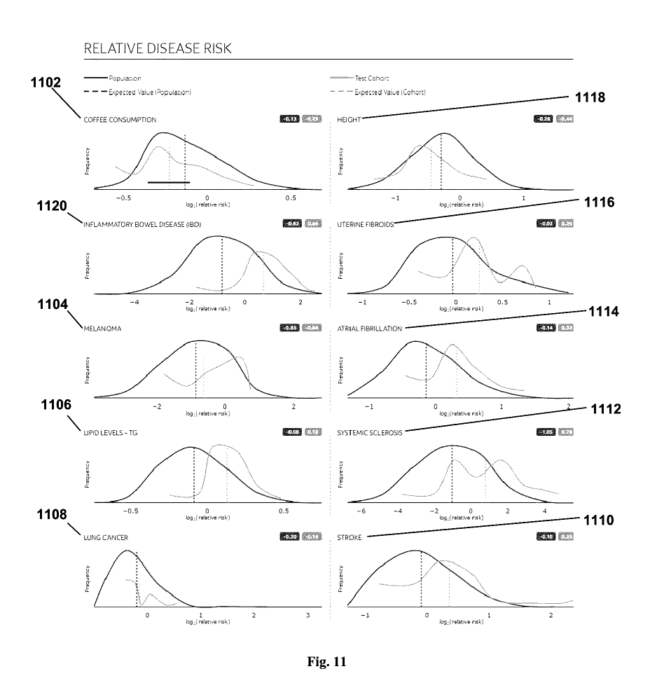

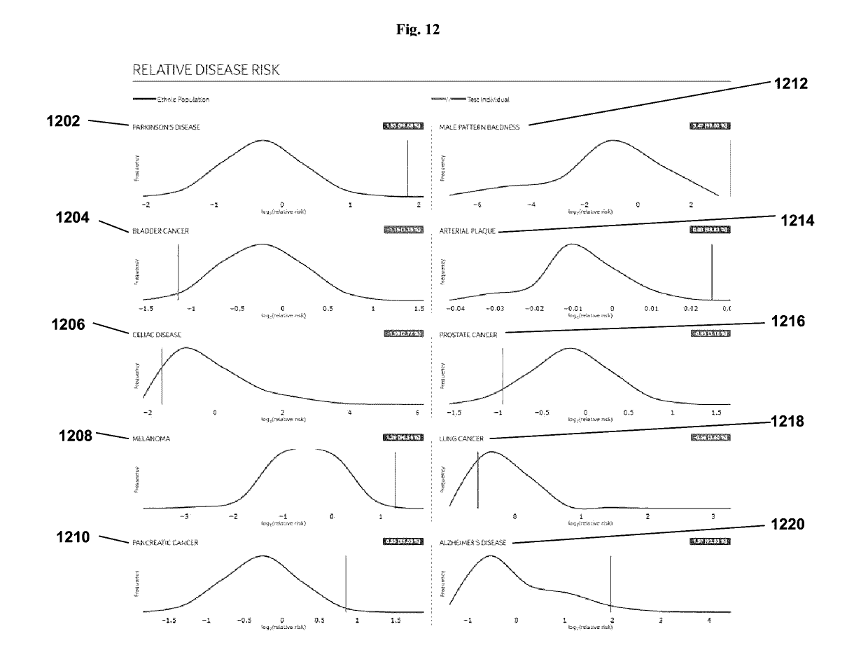

In some embodiments, the system presents a user interface. FIG. 1 illustrates that a user is presented with a home page. FIG. 2 illustrates that a user can log in with the user's credentials through the login screen 202. FIG. 3 illustrates that the user can be further authenticated by choosing to receive a push through 302, receive a call through 304, or offer a passcode through 306. FIGS. 4 and 5 illustrate a dashboard. The dashboard shows summary pages gives an overview of the population in the database, including a count of genomes 402 and 502, count of microbiomes 404 and 504, count of metabolomics samples 406 and 506, and count of individuals 408 and 508. FIGS. 6 and 7 illustrate a demographics summary. The demographics summary includes an ancestry map 602, histograms describing the height 704, weight 702, BMI 706, and age 708 distribution of the population. FIG. 8 illustrates a user interface. The user interface presents a gender distribution 802 of the individuals in the population, the count of variants 804 in the population. FIG. 9 illustrates another user interface. The interface presents the annotated functional effect 902 of the variants and the annotated clinical significance 904 of the variants. FIG. 10 illustrates HLA type information. The top HLA types widget 1002 describes the most abundant HLA types in the population, the top two of each of the six classic HLA genes. HLA type is calculated using a proprietary HLA typing from whole genome sequencing from each of the sequence in the database. FIGS. 11 and 12 illustrate a dashboard summary. The summary shows a summary of the genomic disease risk in the individual or population of interest. The genomic disease risk is calculated based on a number of disease ‘models’ derived from published Genome Wide Association Studies (GWAS). The top 10 most significant disease risks 1102-1120 are identified using a t-test to detect whether there is a significant difference between the cohort and the population. The top 10 most significant disease risks 1202-1220 are identified using a t-test to detect whether there is a significant difference between the cohort and the population.

Importantly, in some embodiments, some or all of the biologic information is linked to phenotype metadata as integrated health records on a cloud computer platform.

### Queries

The platforms, systems, media, and methods described herein include tools to query the biologic information, or use of the same. In some embodiments, the platforms, systems, media, and methods described herein allow a user to name, save, access, and edit queries performed.

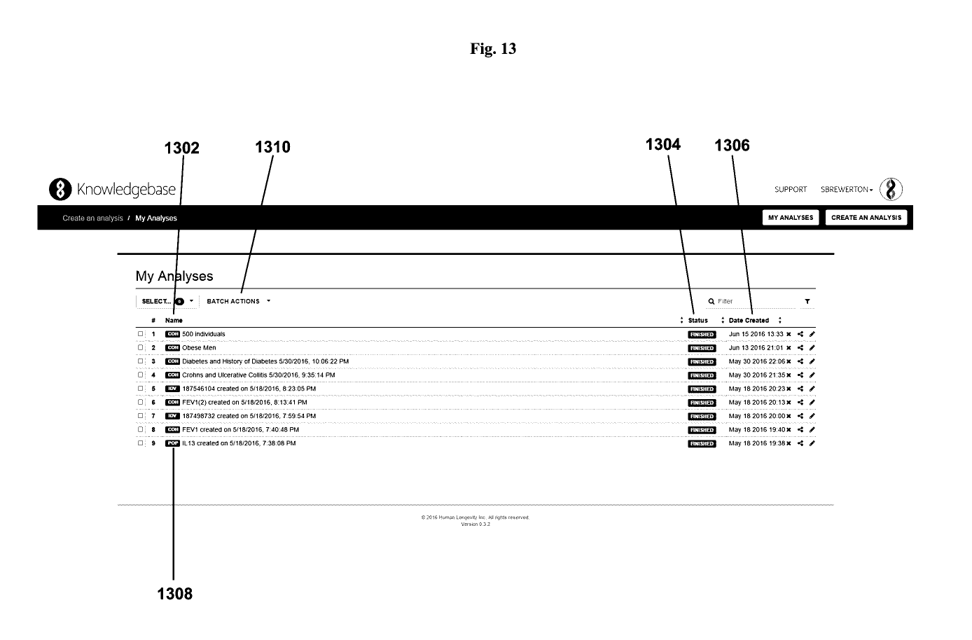

Referring to FIG. 13, in a particular embodiment, the application described herein includes a graphic user interface (GUI) presenting a list of saved analyses (queries). For each saved analysis, the interface presents a name 1302 previously entered by a user upon saving the analysis, a status 1304, and a creation date 1306. In this embodiment, the name of each analysis includes an icon indicating the type 1308 of analysis, for example, whether the analysis is for an individual, a cohort, or the entire population. Further, in this embodiment, the interface offers access to tools 1310 for filtering the list of saved analyses as well as tools for editing, deleting, and saving each saved analysis.

A user optionally queries the biologic information based on one or more of a wide variety of parameters. In some cases, to initiate a query, a user indicates a query scope by selecting whether they wish to analyze an individual, analyze a cohort, or analyze the entire population of biologic information.

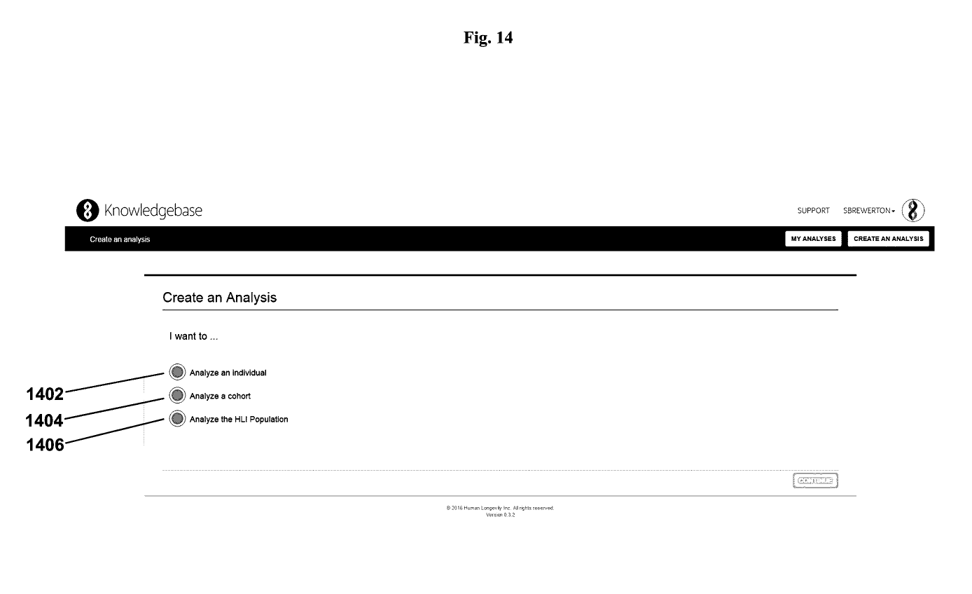

Referring to FIG. 14, in a particular embodiment, the application described herein includes an interface presenting options for creating a new analysis. In this embodiment, the interface allows the user to select the scope of the information that will be included in the analysis. The options include analyze biologic information associated with an individual 1402, analyze biologic information associated with a cohort of individuals 1404, and analyze biologic information associated with the entire population of individuals 1406.

In addition to selecting a scope for a new query, a user optionally indicates a type of query, e.g., on what basis the biologic information will be analyzed. By way of example, a user optionally queries the biologic information based on one or more phenotypes.

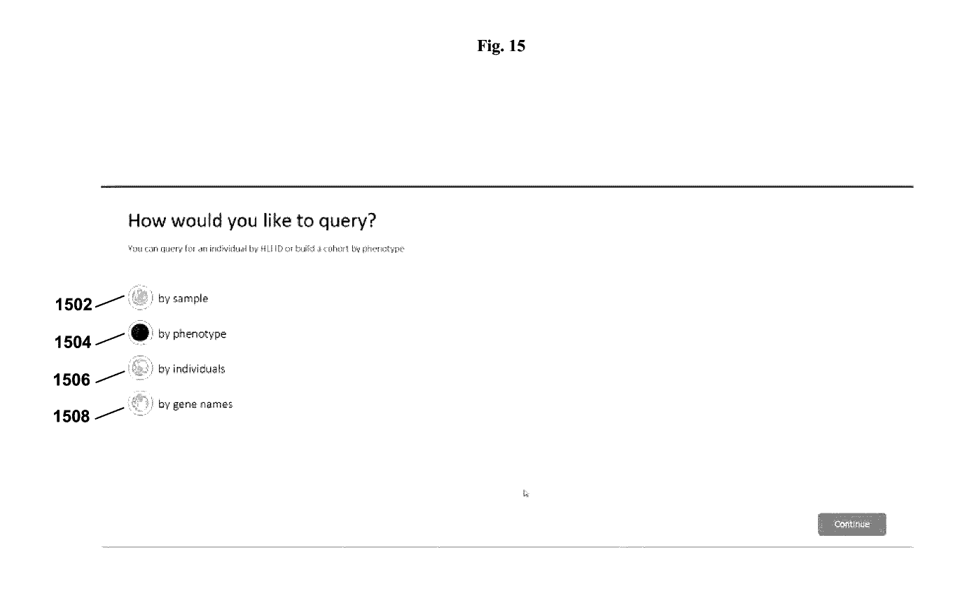

Referring to FIG. 15, in a particular embodiment, the application described herein includes an interface presenting options for creating a new analysis (query). In this embodiment, the interface allows the user to select the type of query. The options include query by sample 1502, query by phenotype 1504, query by individual(s) 1506, and query by gene names 1508.

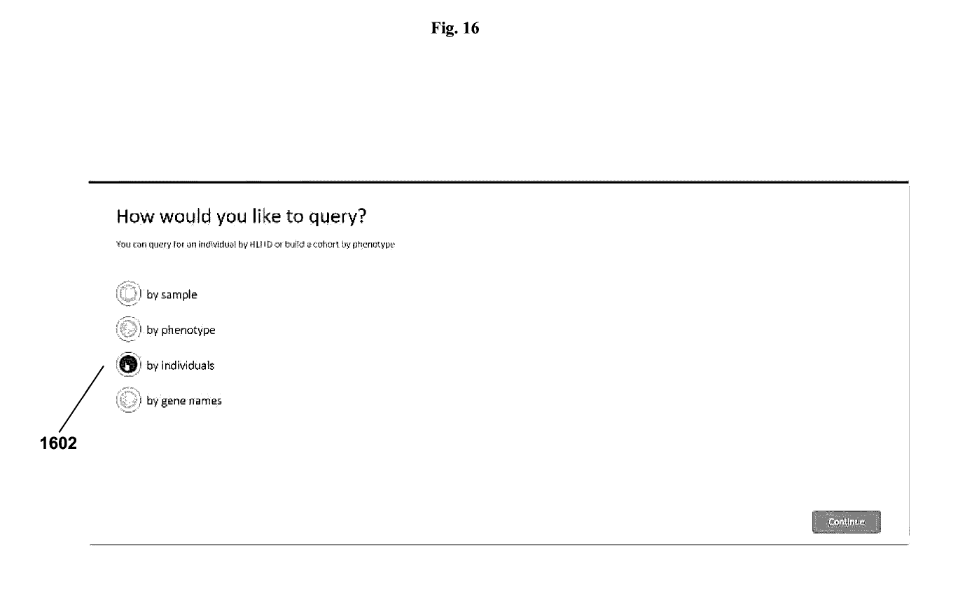

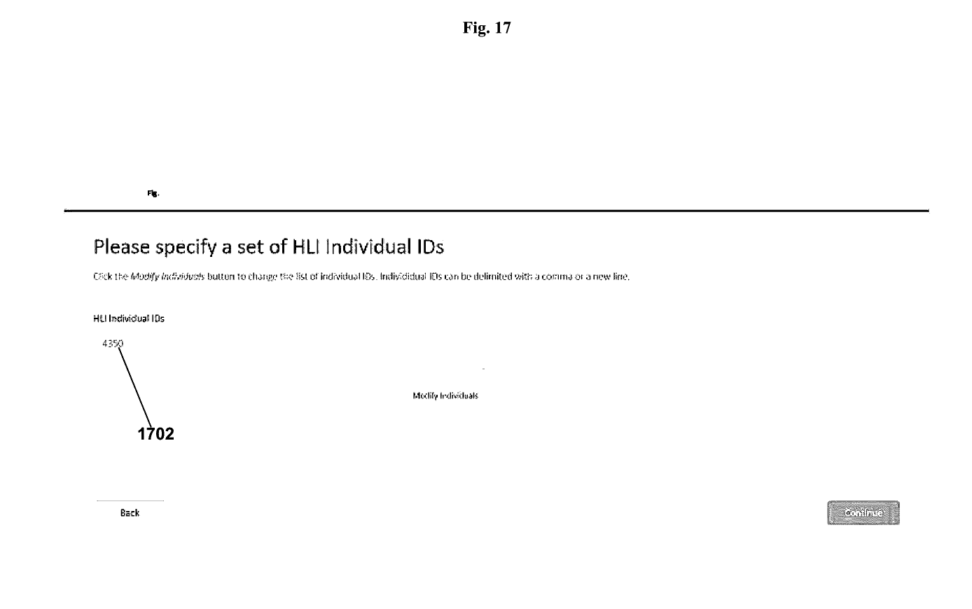

By way of example, a user optionally queries the biologic information based on one or more individuals. In such cases, the user specifies one or more individual IDs. Referring to FIG. 16, in a particular embodiment, a user opts to query by identifying one or more individuals 1602. FIG. 17 shows an exemplary interface for identifying individuals by entering individual ID numbers or other unique identifiers 1702.

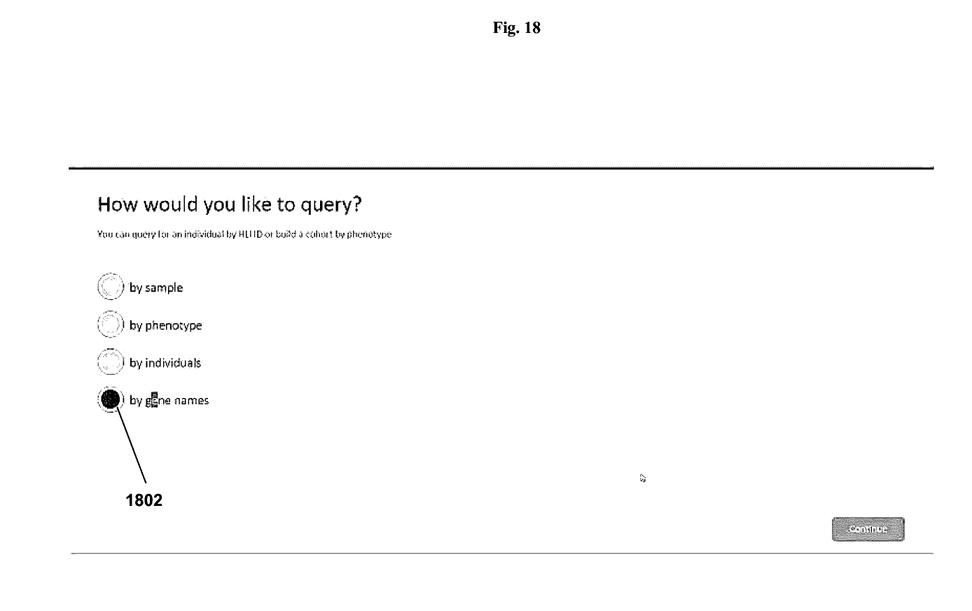

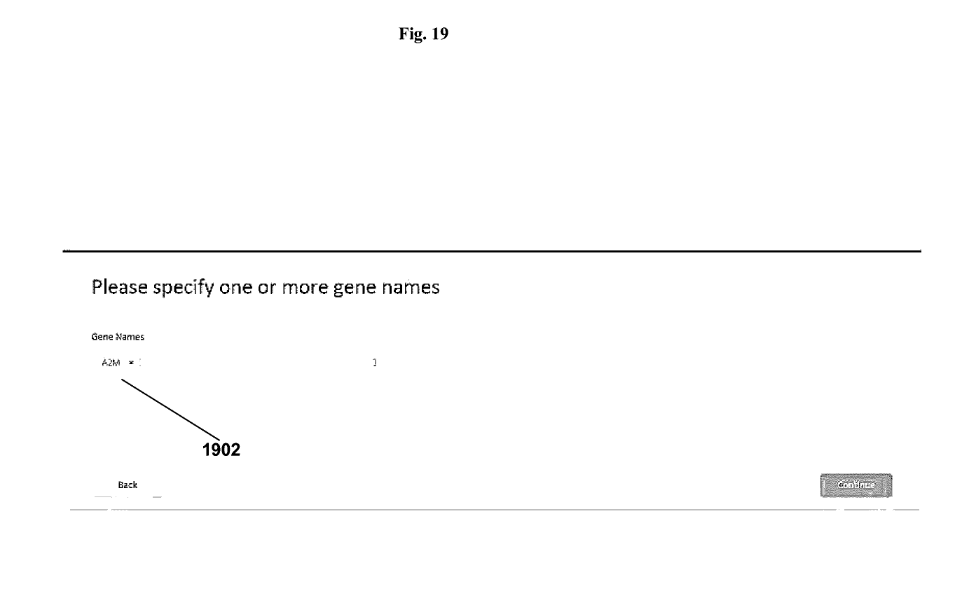

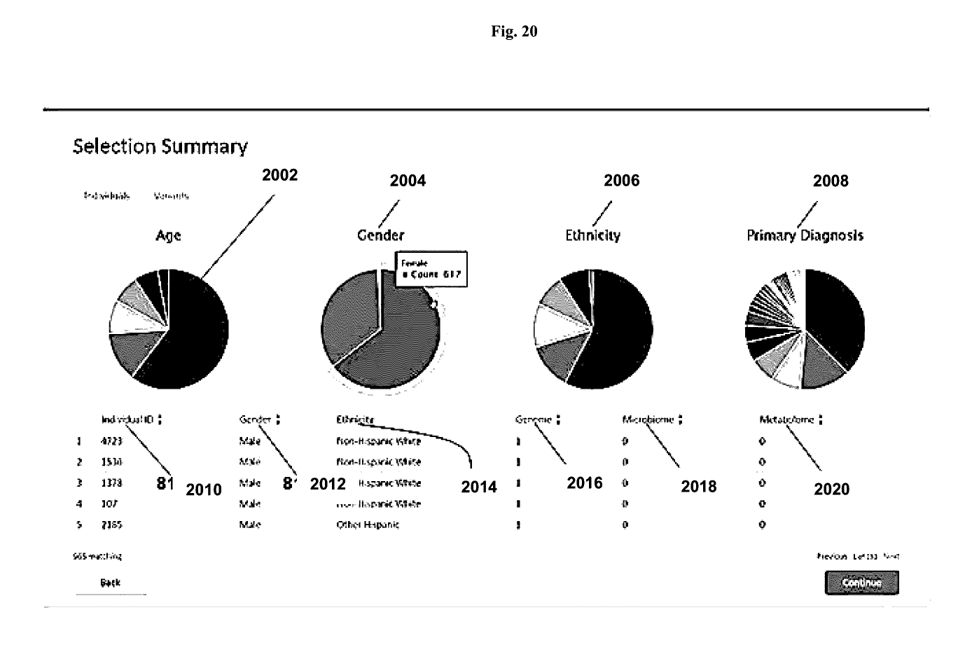

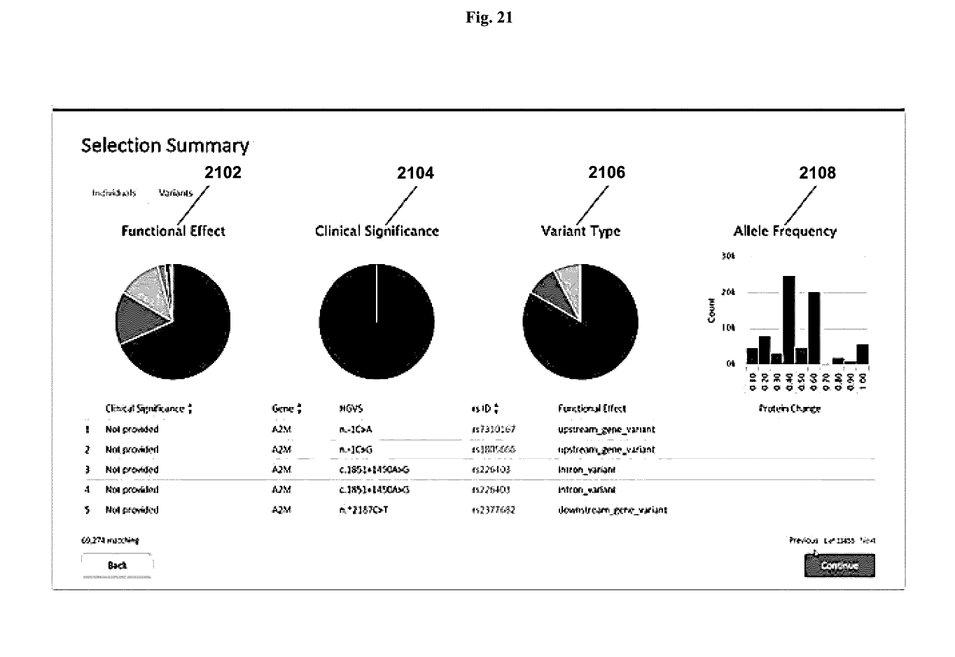

By way of still further example, a user optionally queries the biologic information based on one or more gene names. In such cases, the user specifies one or more gene names. Referring to FIG. 18, in a particular embodiment, a user opts to query by identifying one or more genes 1802. FIG. 19 shows an exemplary interface for identifying genes by entering individual gene names or other unique identifiers 1902. FIGS. 20 and 21 depict a summary of demographic characteristics (e.g., age 2002, gender 2004, ethnicity 2006, primary diagnosis 2008, etc.) and gene variant characteristics (e.g., functional effect 2102, clinical significance 2104, variant type 2106, and allele frequency 2108, etc.) for individuals returned by a query based on gene name (e.g., individual ID 2010, gender 2012, ethnicity 2014, number of genomes 2016, number of microbiomes 2018, and number of metabotome 2020).

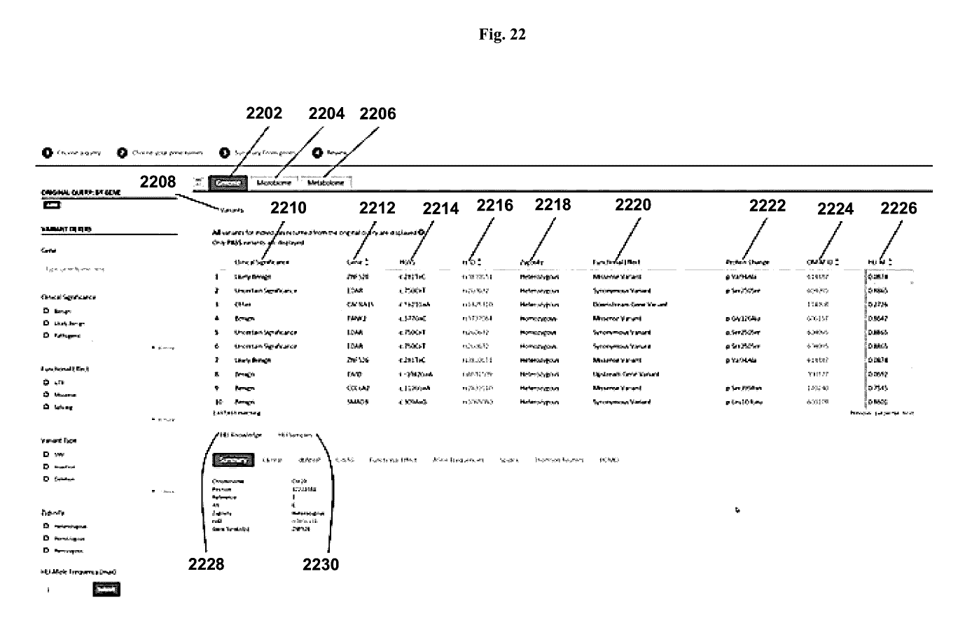

FIG. 22 depicts a visual synthesis application including interactive tabs providing access to summaries of genome 2202, microbiome 2204, and metabolome information 2206 resulting from a query by gene name. The genomic data comprises a list of variants 2208 and, for each variant includes, clinical significance 2210, gene 2212, HGVS nomenclature 2214, rs ID 2216, zygosity 2218, functional effect 2220, protein change 2222, CMIM ID 2224, and allele frequency 2226 as well as annotation information 2228 and originating sample information 2230.

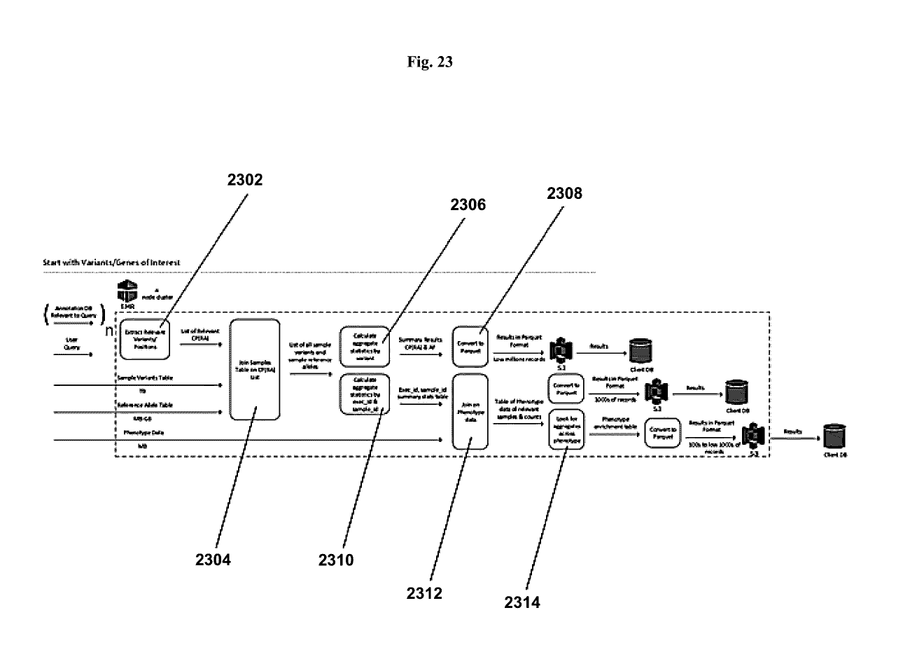

FIG. 23 is a flowchart depicting an exemplary process for conducting a data query based on an identified gene or gene variant of interest. A platform comprising a user interface and a backend engine accepts a user query regarding a gene of interest. The platform in step 2302 extracts relevant variations or positions for the gene to generate a list of relevant CP(RA). The platform in step 2304 joins the list of relevant CP(RA) together with data from a sample variants table, data from a reference allele table, and phenotype data to generate a list of all sample variants and sample reference alleles. The platform in step 2306 calculates aggregate statistics by variant for the list of all sample variants and sample reference alleles to generate summary results CP(RA) & AF. The platform in step 2308 converts the summary results CP(RA) & AF to the Parquet format and stores the results in a client database. In addition, the platform in step 2310 calculates aggregate statistics by exe_id & sample_id to generate a exec_id and sample_id summary stats table. The platform in step 2312 joins the exec_id and sample_id summary stats table with phenotype data to create a table of phenotype data of relevant samples and counts. The platform in step 2314 looks in a table of phenotype data of relevant samples and counts for aggregates across phonotypes to generate a phenotype enrichment table. The platform can also convert the table of phenotype data of relevant samples and counts as well as the phenotype enrichment table into the Parquet format for storage in a client database.

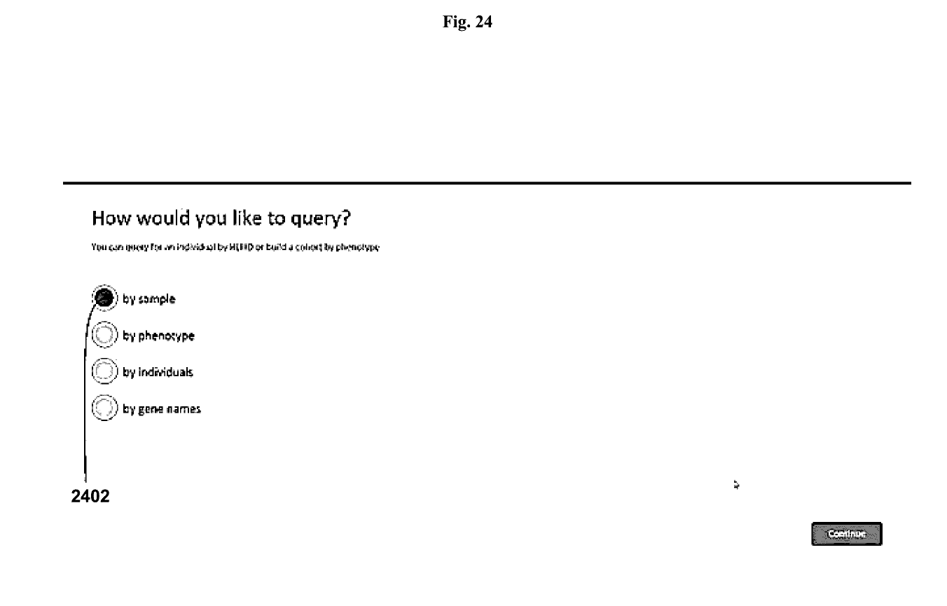

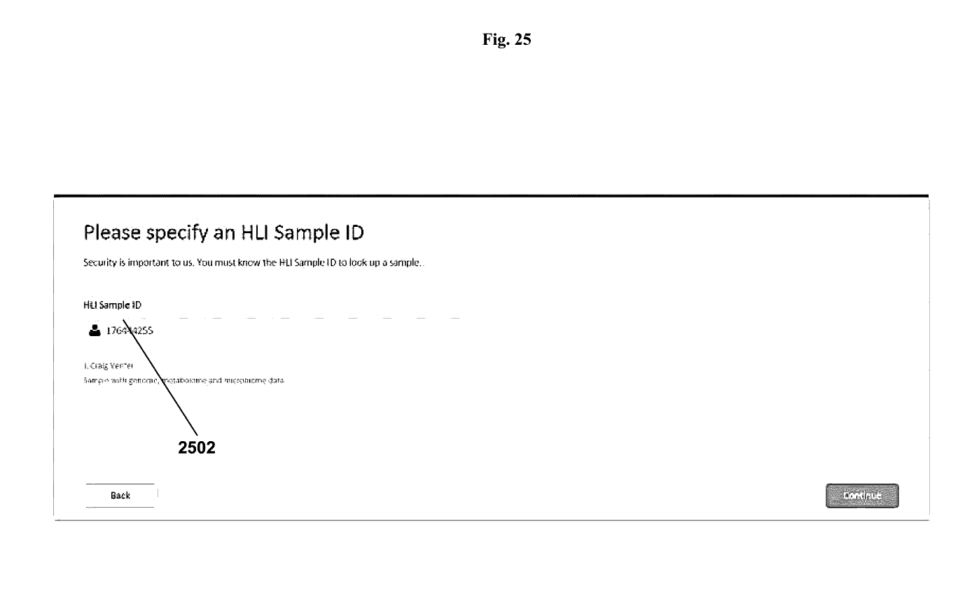

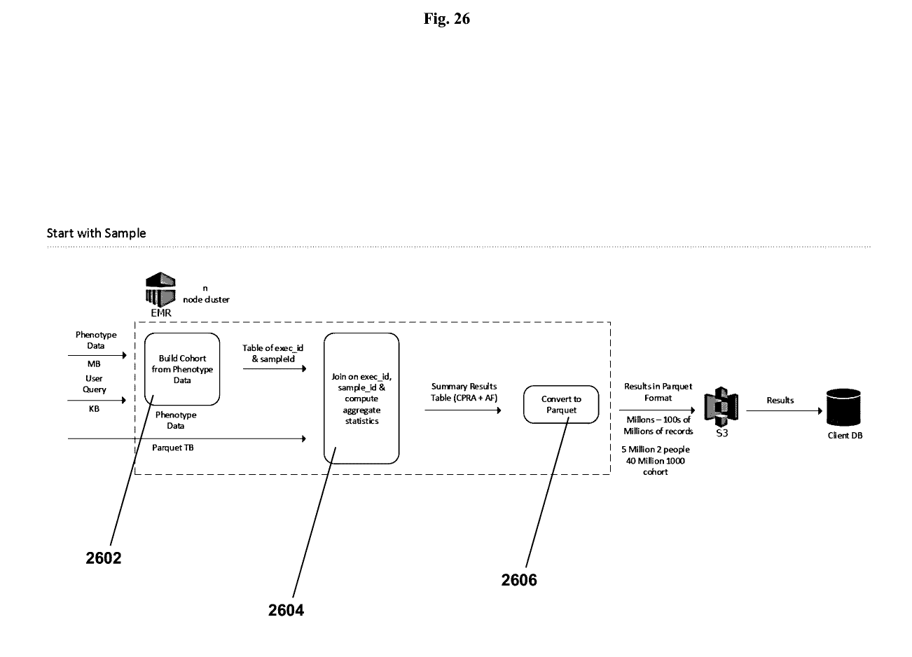

By way of yet further example, a user optionally queries the biologic information based on one or more biological samples. In such cases, the user specifies one or more sample IDs. Referring to FIG. 24, in a particular embodiment, a user opts to query by identifying one or more biologic samples 2402. FIG. 25 shows an exemplary interface for identifying samples by entering sample ID numbers or other unique identifiers 2502. FIG. 26 is a flowchart depicting an exemplary process for conducting a data query based on an identified sample. A platform comprising a user interface and a backend engine accepts a user query regarding biological samples of interest and corresponding phenotype data. The platform in step 2602 build a cohort from the phenotype data and generates a table of exec_id & sampled. The platform in step 2604 joins the exec_id and samjple_id and compute aggregate statistics to generate a summary results table (CPRA+AF). The platform in step 2606 converts the summary results table (CPRA+AF) into the Parquet format and stores them into a client database.

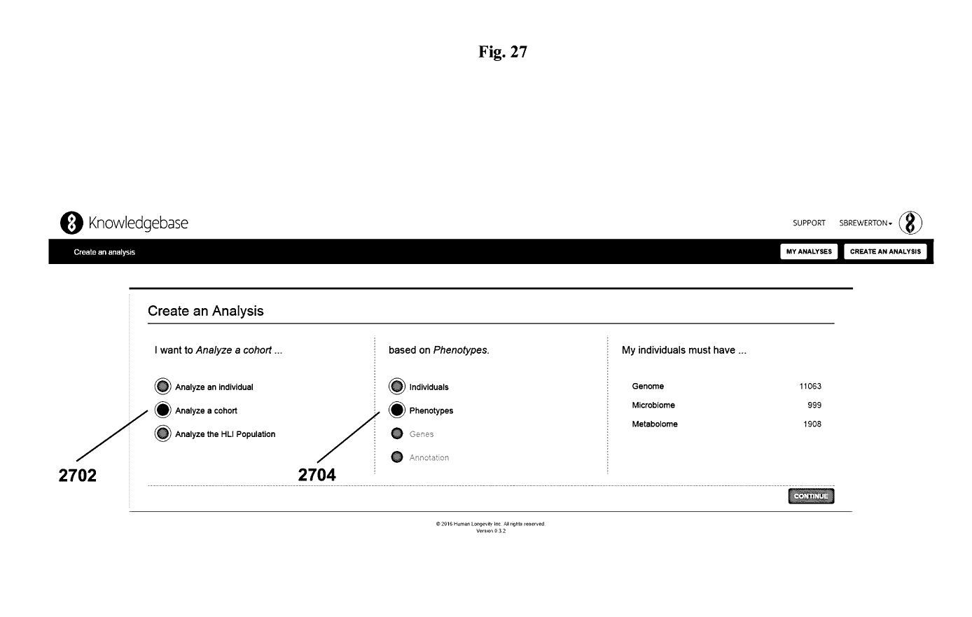

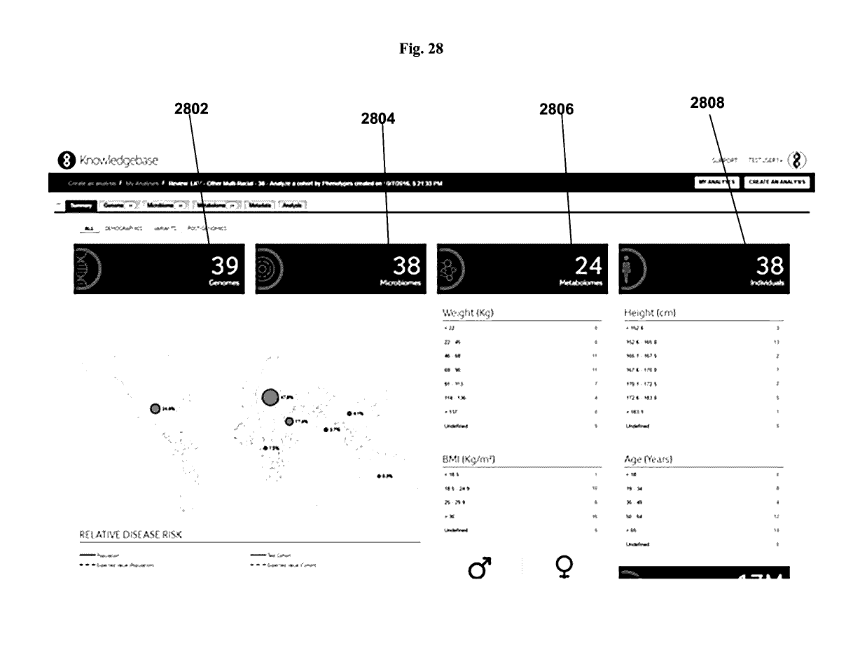

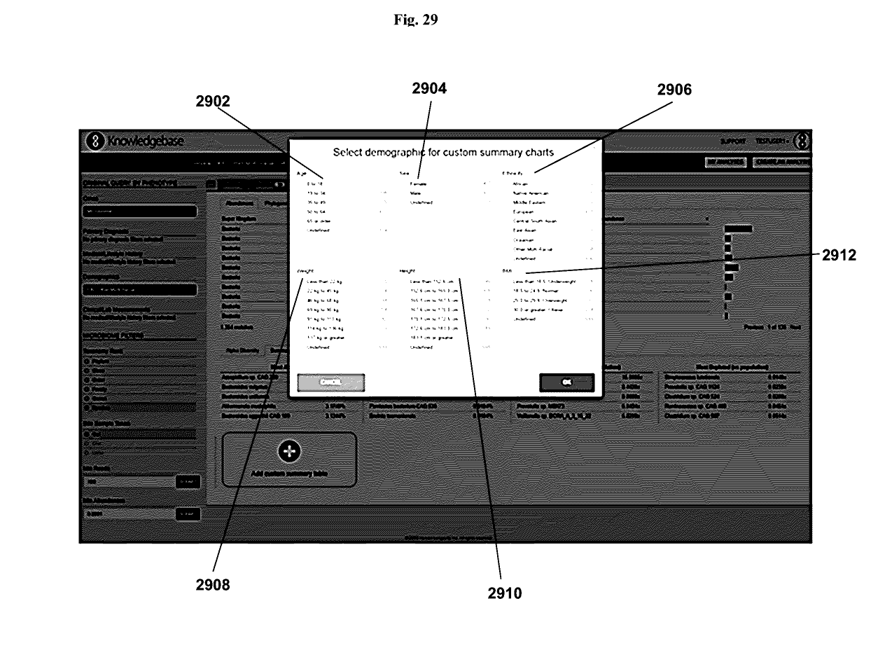

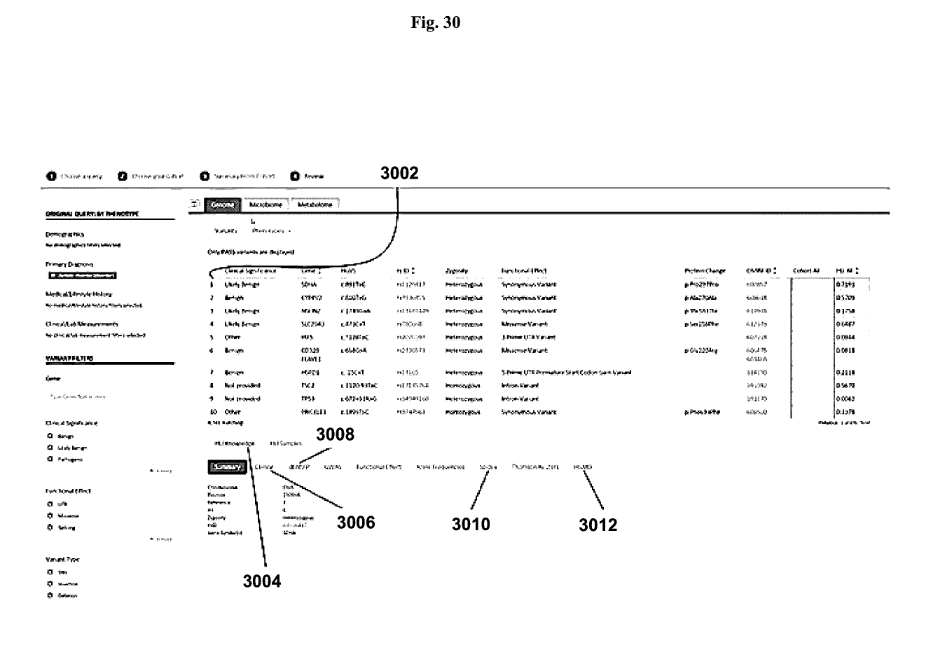

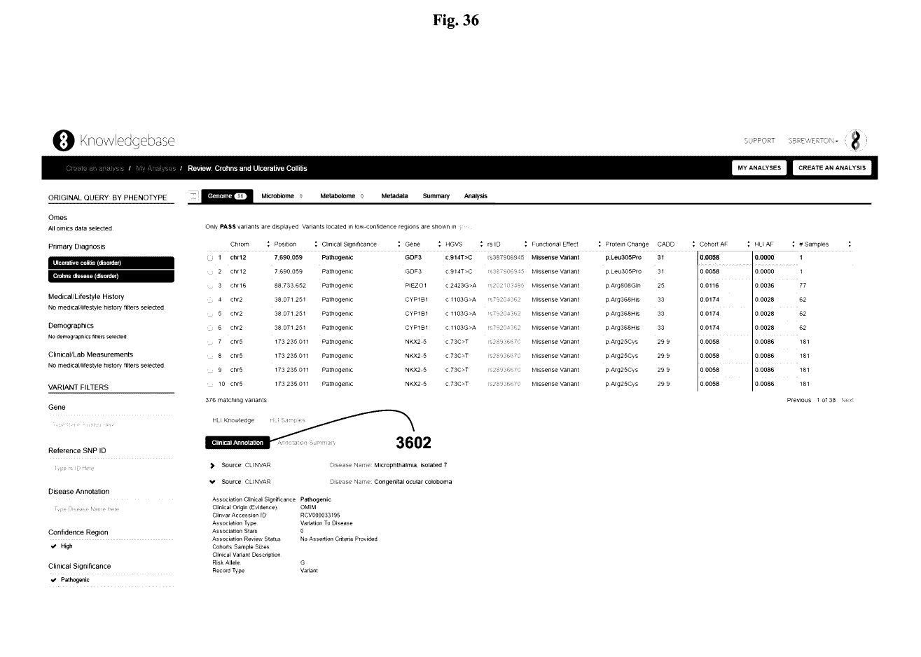

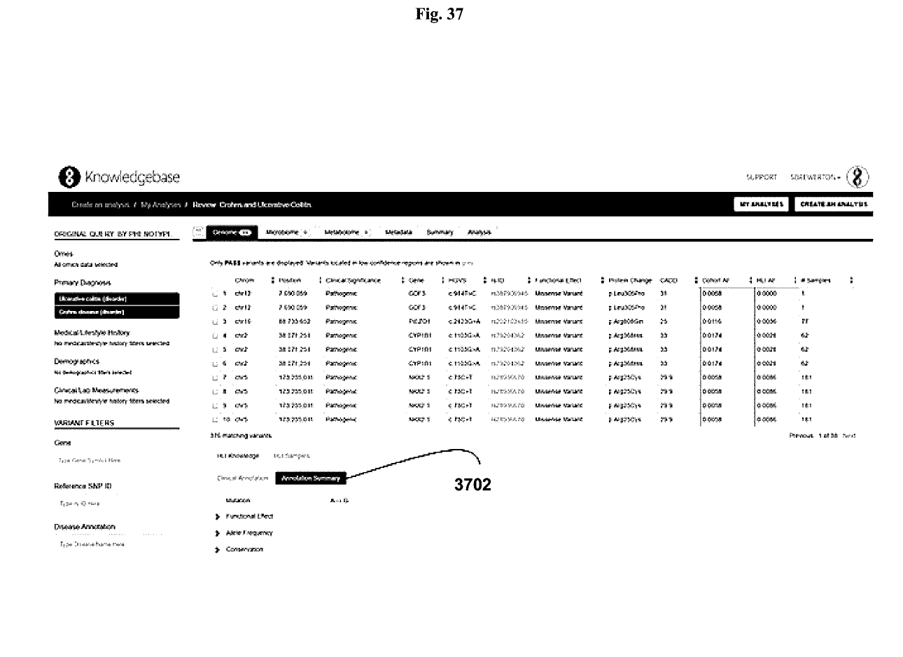

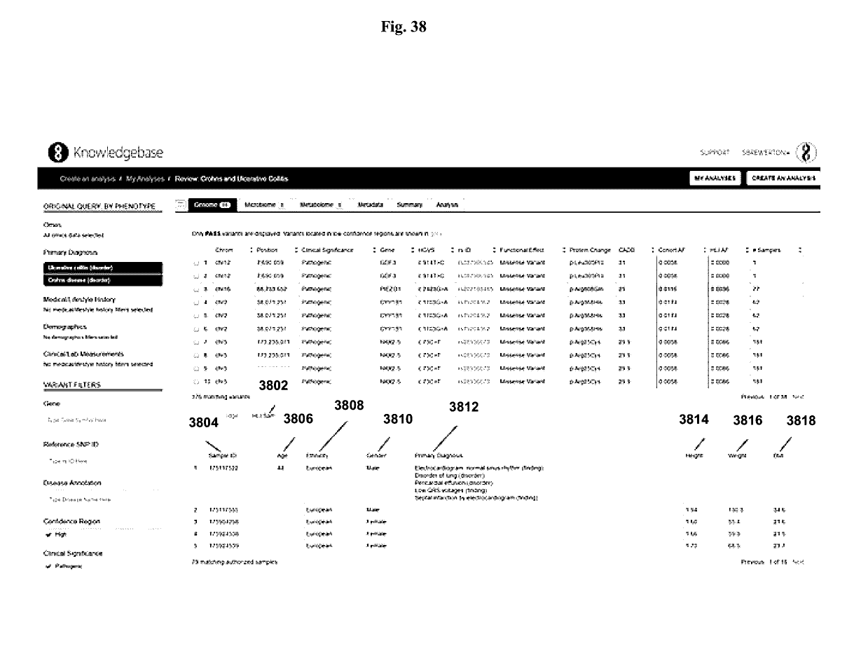

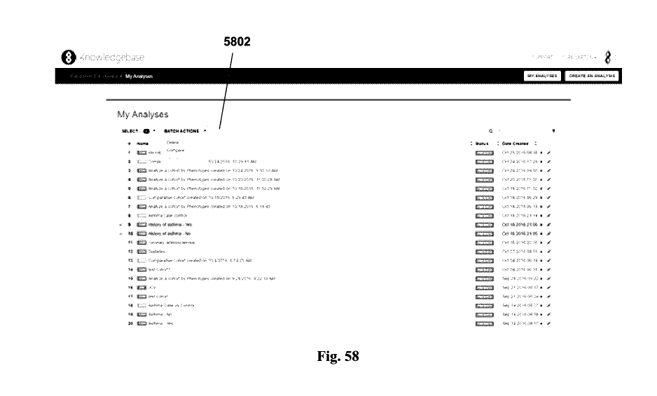

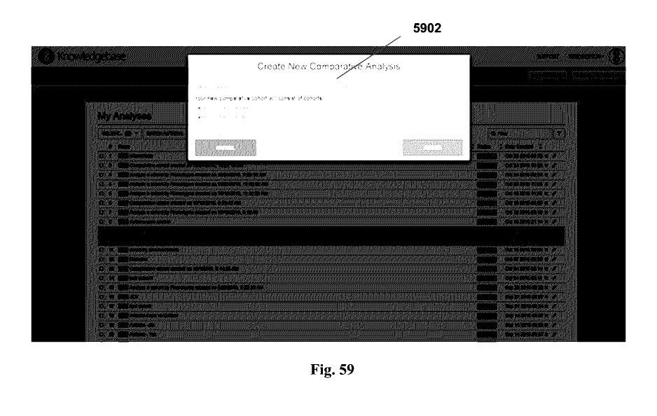

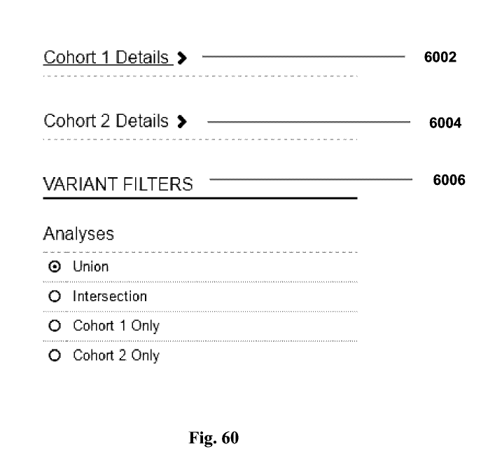

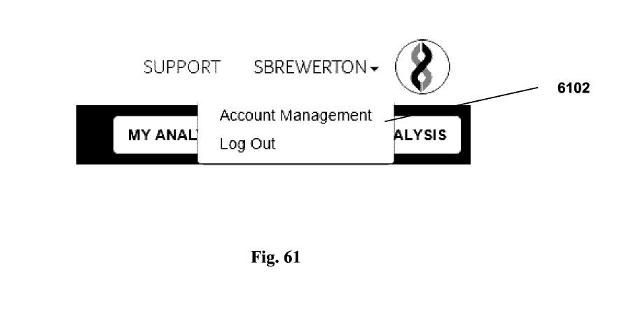

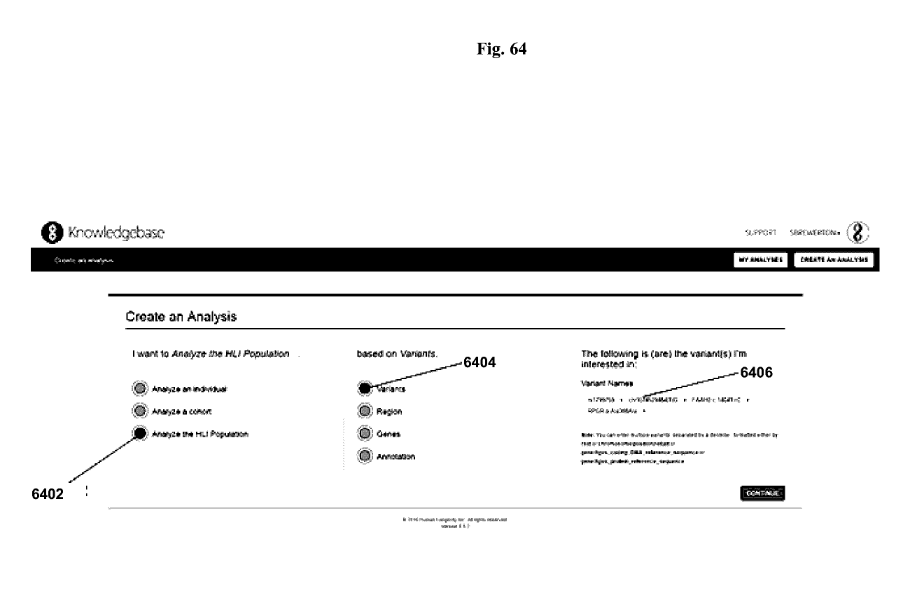

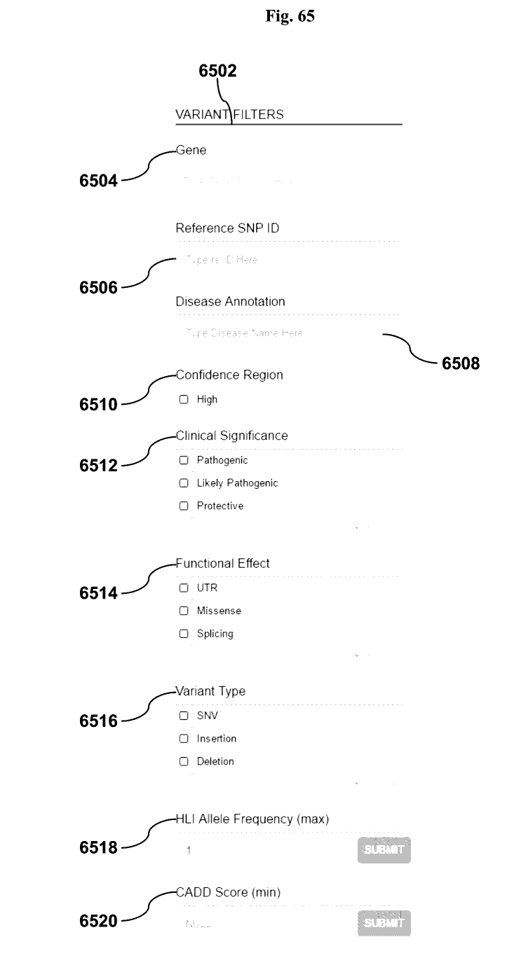

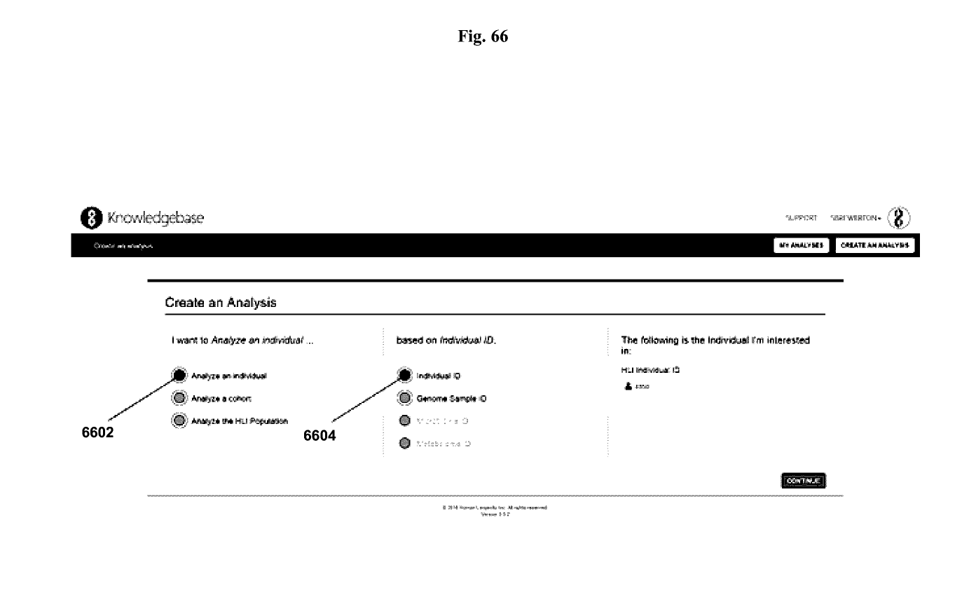

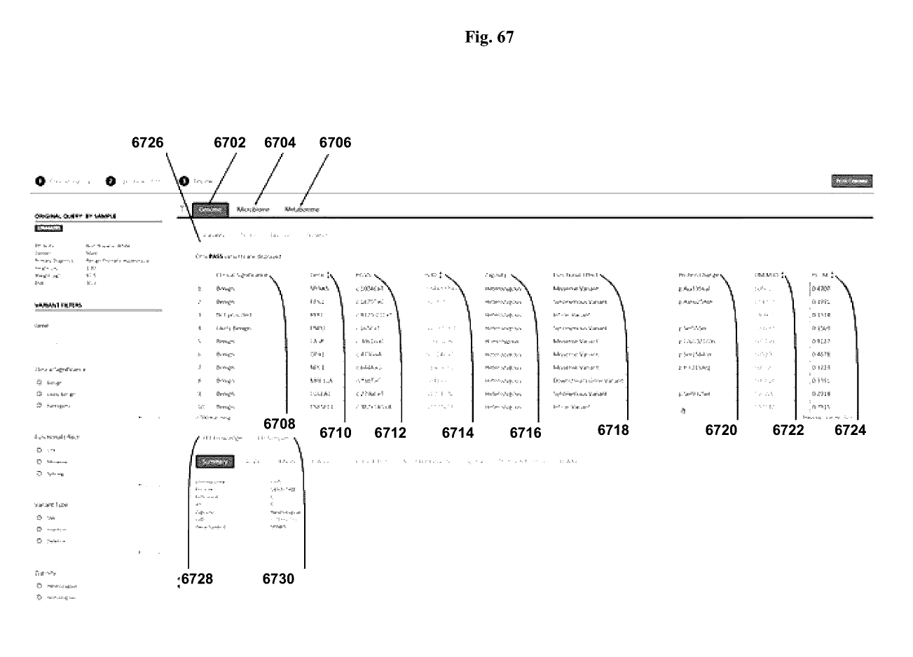

As described herein, a user optionally initiates a query by selecting a scope of biologic information to query and a type of query to conduct on the selected data. FIG. 27 depicts an example wherein a user indicates that they wish to analyze a cohort 2702 based on one or more phenotypes 2704. FIGS. 28 and 29 illustrate the feature to provide an overview enable a user to create a summary chart. FIGS. 30-58, described further herein, illustrate the resulting visual data synthesis displays summarizing the results of queries by phenotype. FIGS. 59 and 60 illustrate the feature to allow a user to compare two cohorts. FIGS. 61-63 depict administrative features. FIG. 64 depicts an example wherein a user indicates that they wish to analyze the entire population of data 6402 based on one or more genomic variants 6404, which are indicated by variant name 6406. FIGS. 20-22, described above and further herein, illustrate the resulting visual data synthesis displays summarizing the results of queries by gene. Referring to FIG. 65, in various embodiments, the application described herein includes an interface presenting user configurable gene variant filters allowing the user to refine an analysis conducted on the basis of one or more genes or gene names. FIG. 66 depicts an example wherein a user indicates that they wish to analyze an individual 6602, who is indicated by an individual ID 6604. FIGS. 67-71, described further herein, illustrate the resulting visual data synthesis displays summarizing the results of queries by individual or sample.

### Cohort Builder and Cohort Analysis

The platforms, systems, media, and methods described herein include cohorts, or use of the same. As used herein, a “cohort” refers to a group of subjects with a common characteristic. Further, the platforms, systems, media, and methods described herein include tools for building and/or customizing one or more cohorts. Users optionally build, edit, and save cohorts via an interactive cohort builder tool. In various embodiments, a user selects diseases, traits, demographics, and/or observational data to construct one or more cohorts of individuals. By way of specific example, a user optionally queries to select male individuals who were diagnosed with coronary arteriosclerosis but had no history of myocardial infarction, were not taking beta-blockers, were not overweight and had low levels of low density lipoprotein (LDL) cholesterol. The cohort builder described herein allows users to save configured cohorts in order to revisit the results.

The platforms, systems, media, and methods described herein include tools for reviewing and analyzing the genomic variants, and other biologic parameters, in the cohort. By way of example, annotated variants are interactively filtered according to the associated, integrated annotation data, such as variant type, variant effects, and calculations of allele frequency. By way of specific example, a user filters to show only pathogenic, missense variants with an allele frequency of less than 0.01. Microbiome abundances, metabolome levels, and phenotypic information for the individuals in the cohort are also optionally analyzed.

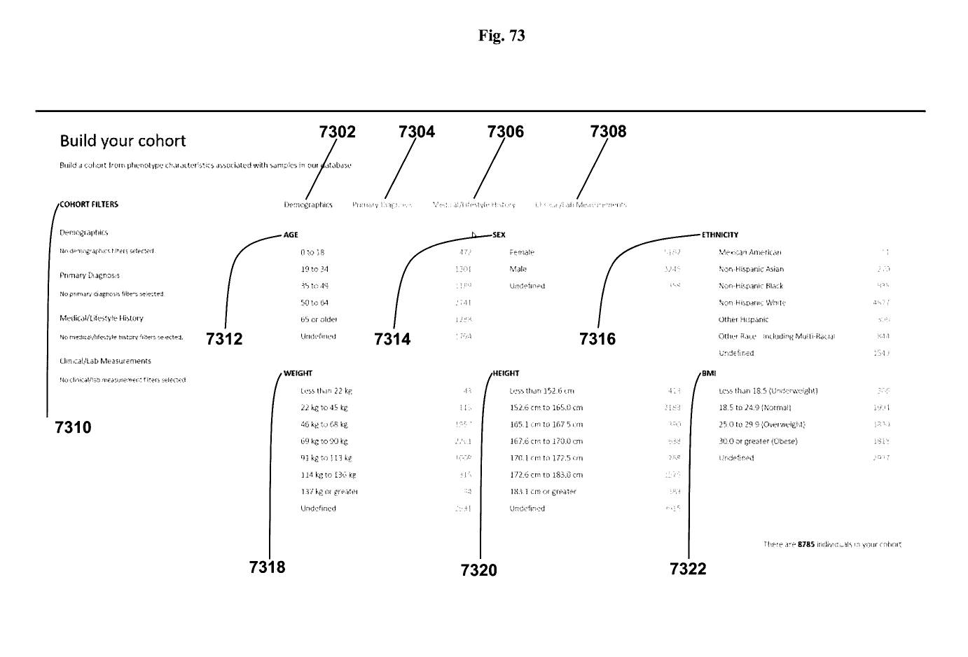

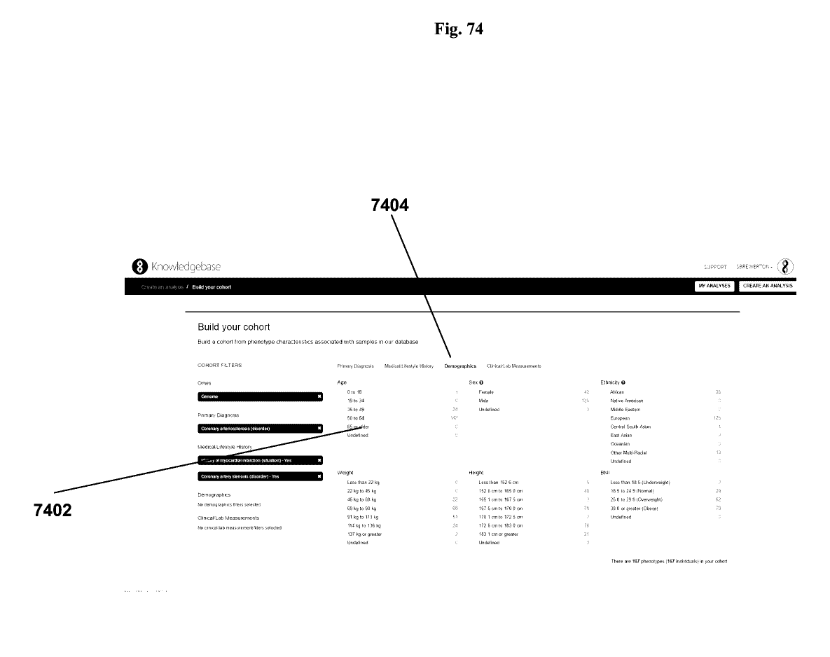

Referring to FIG. 73, in a particular embodiment, the application described herein includes a cohort builder interface, which includes features allowing a user to select the demographic characteristics of the individuals included in the current cohort. In this embodiment, the interface offers interactive tabs across its top allowing the user to specific demographic characteristics 7302, primary diagnosis 7304, medical history/lifestyle history 7306, and clinical measurements/lab measurements 7308 for individuals included in the current cohort. Further, the exemplary interface offers a summary of cohort filters 7310 on its left side allowing the user to review the selected characteristics. The user interacts with the demographics features to optionally view and select age 7312, sex (gender) 7314, ethnicity 7316, weight 7318, height 7320, and Body Mass Index (BMI) 7322 characteristics for current cohort. Each demographic characteristic displayed includes an indication of how many individuals in the database are associated with the characteristic. Referring to FIG. 74, in a particular embodiment, a user has selected an age of 50 to 64 7402 and a sex of male 7404 for the current cohort.

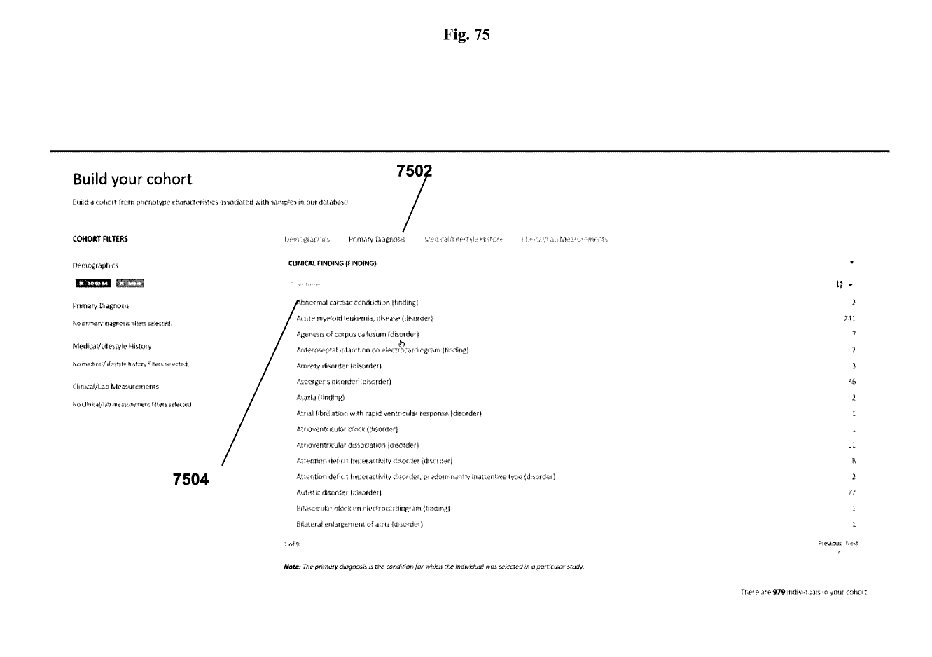

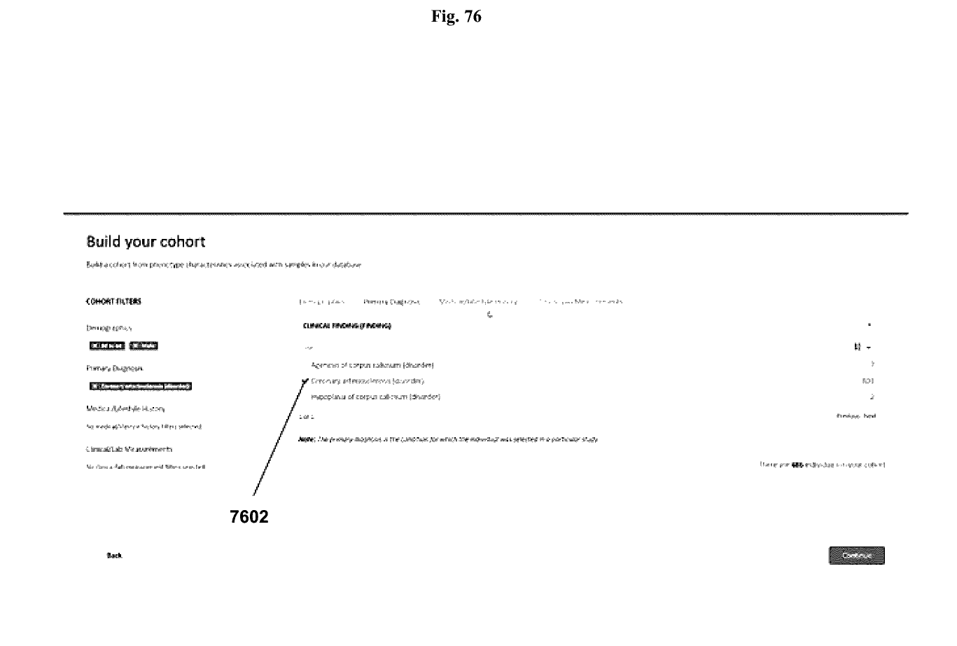

Referring to FIG. 75, in a particular embodiment, the application described herein includes a cohort builder interface, which includes features allowing a user to select the primary diagnosis of the individuals included in the current cohort. In this embodiment, the interface offers a searchable, alphabetically arranged index of primary diagnoses 7502. Each diagnosis 7504 in the list includes an indication of how many individuals in the database are associated with the diagnosis. Referring to FIG. 76, in a particular embodiment, a user has searched for and selected a primary diagnosis of coronary arteriosclerosis 7602 for the current cohort.

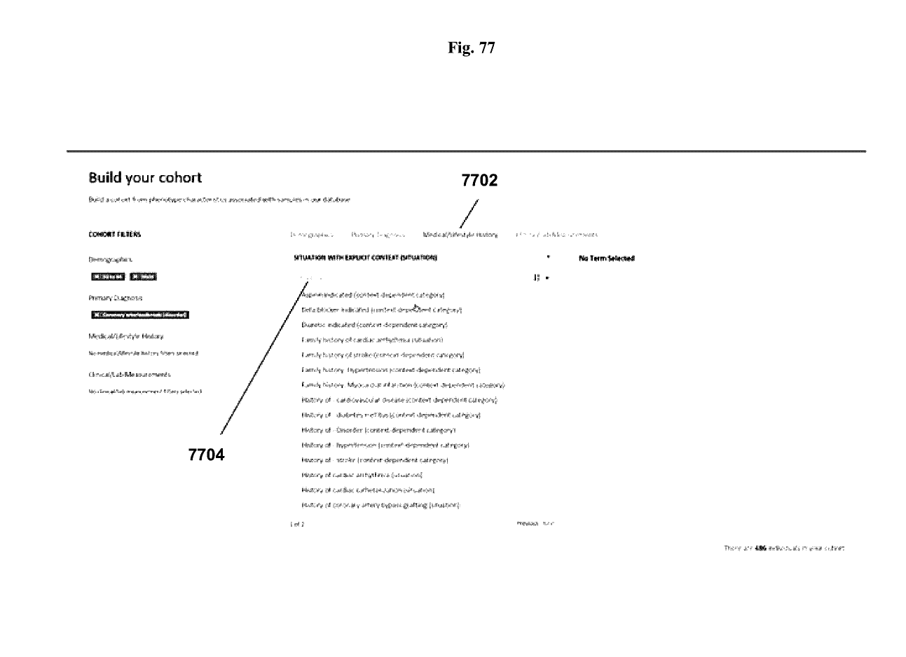

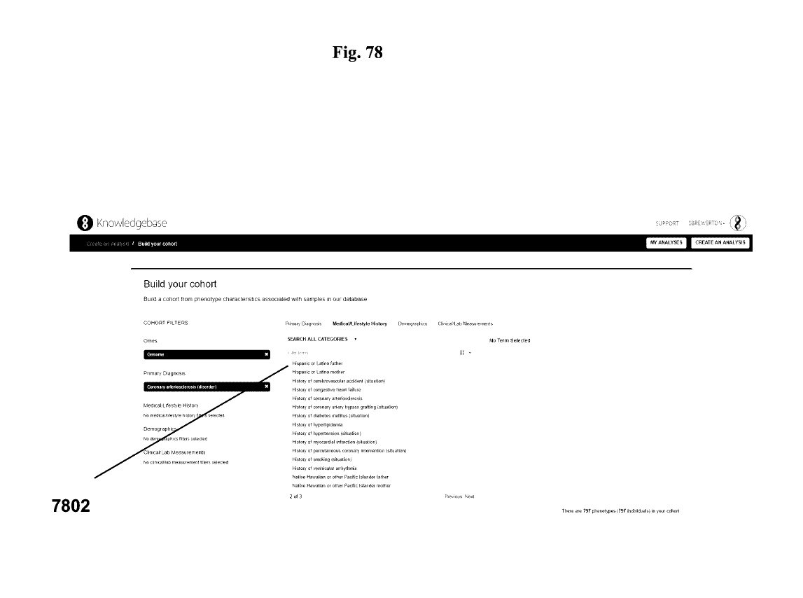

Referring to FIG. 77, in a particular embodiment, the application described herein includes a cohort builder interface, which includes features allowing a user to select the medical history and/or lifestyle history 7702 of the individuals included in the current cohort. In this embodiment, the interface offers a searchable, alphabetically arranged index of situations 7704. Referring to FIG. 78, in a particular embodiment, a user has searched for and selected a situation indicating no history of statin therapy 7802 for the current cohort.

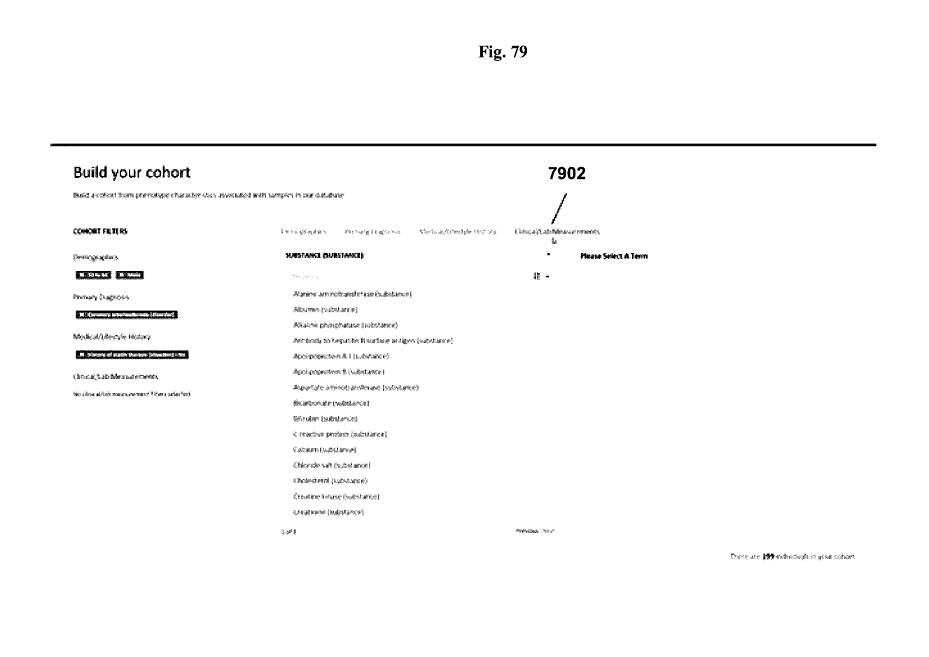

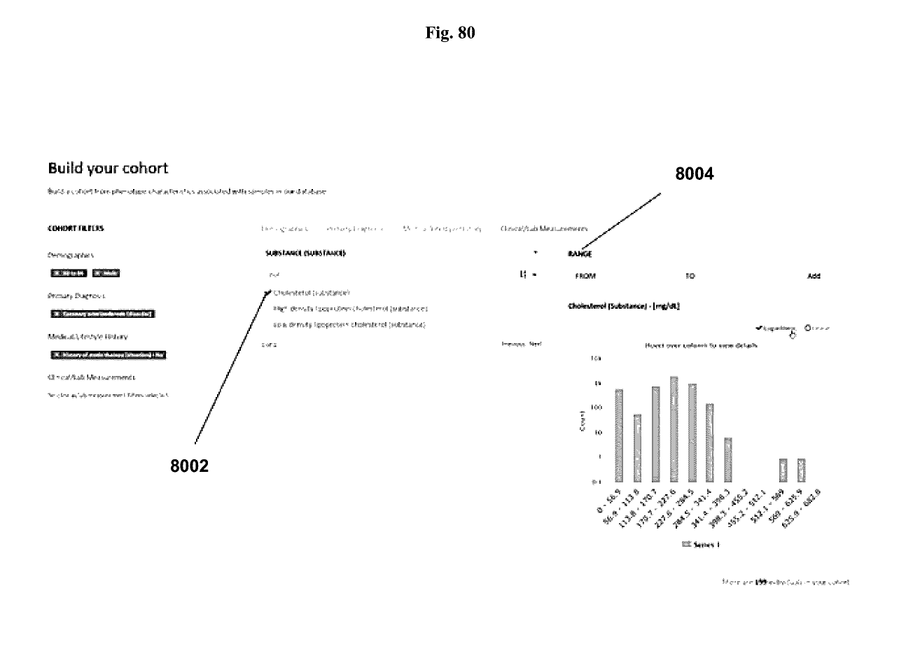

Referring to FIG. 79, in a particular embodiment, the application described herein includes a cohort builder interface, which includes features allowing a user to select the clinical measurements and/or laboratory measurements 7902 of the individuals included in the current cohort. In this embodiment, the interface offers a searchable, alphabetically arranged index of substances 7902 and tools to accept user input indicating a relevant quantitative range for each substance. Referring to FIG. 80, in a particular embodiment, a user has searched for and selected cholesterol 8002 as a substance for the current cohort and is in the process of identifying a relevant quantitative range 8004.

In summary, FIGS. 73-80 depict a cohort builder tool used, as an example, to progressively specify a cohort of males, aged 52 to 64, who have a primary diagnosis of coronary arteriosclerosis, and who have no history of statin therapy.

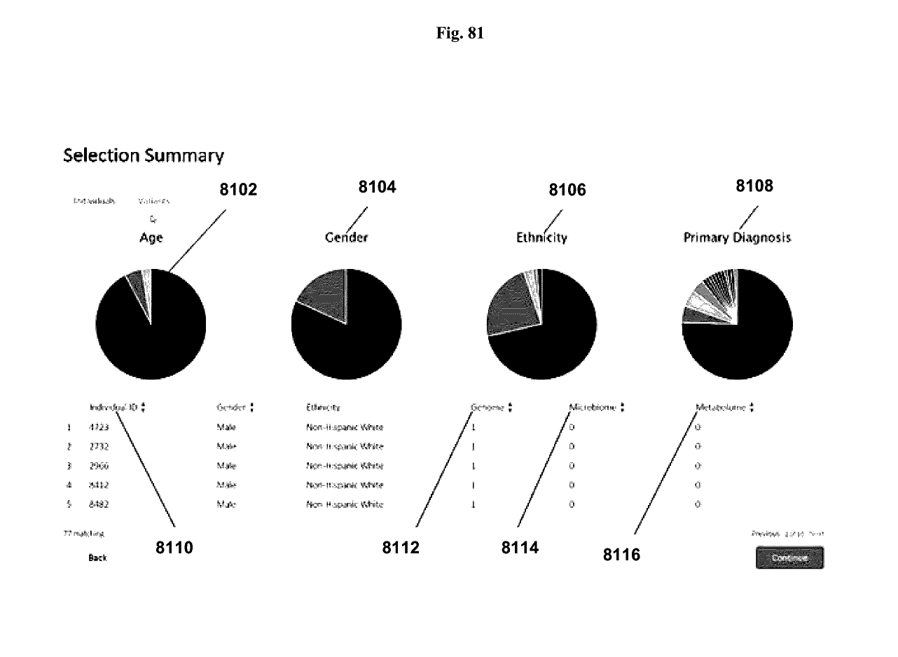

Referring to FIG. 81, in a particular embodiment, the application described herein includes a cohort summary interface, which includes graphical depictions of, as well as data tables for, the demographic characteristics of a cohort. In this embodiment, the age 8102, gender 8104, ethnicity 8106, and primary diagnosis 8108 of individuals in the cohort are presented in the form of pie charts. Moreover, for each individual in the cohort, 77 in all, an individual ID number 8110 is presented along with the type of biologic information available for the individual (e.g., genome information 8112, microbiome information 8114, and/or metabolome information 8116).

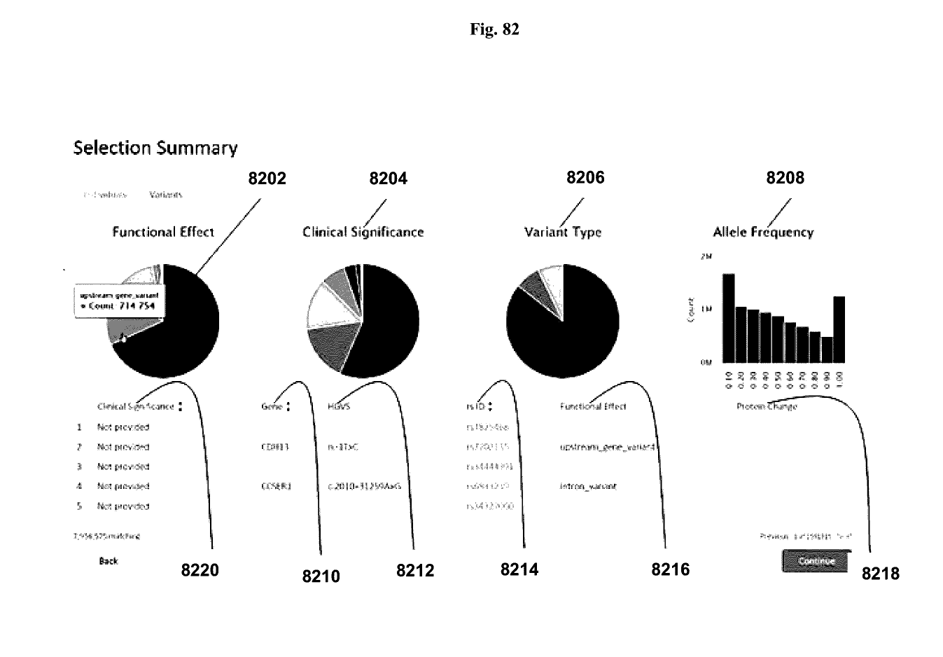

Referring to FIG. 82, in a particular embodiment, the application described herein includes a cohort summary interface, which includes graphical depictions of, as well as data tables for, the genomic characteristics of a cohort. In this embodiment, the functional effect 8202, clinical significance 8204, variant type 8206, and allele frequency 8208 of variants present in the individuals in the cohort are presented in the form of pie charts. Moreover, for each variant in the cohort, 7,956,575 in all, a gene name 8210, an HGVS nomenclature 8212, an rs ID 8214, functional effect 8216, a protein change 8218, and a clinical significance 8220 are displayed.

### Visual Synthesis Application

The platforms, systems, media, and methods described herein include a visual synthesis application, or use of the same. In further embodiments, the visual synthesis comprises analysis in the form of data tables of queried information, summaries of queried information, reviews of queried information, and the like.

The summaries comprise, for example, individual summaries (summarizing age, gender, ethnicity, primary diagnosis, etc.) The summaries also comprise, for example, gene variant summaries (summarizing clinical significance, gene name, HGVS nomenclature, rs ID, zygosity, functional effect, protein change, OMIM ID, variant type, allele frequency, etc.). The summaries also comprise, for example, microbiome summaries (summarizing microbial abundance for specific phyla, genera, or species of microbes). The summaries also comprise, for example, metabolome summaries (summarizing specific metabolites or categories of metabolites and associated ranges or levels).

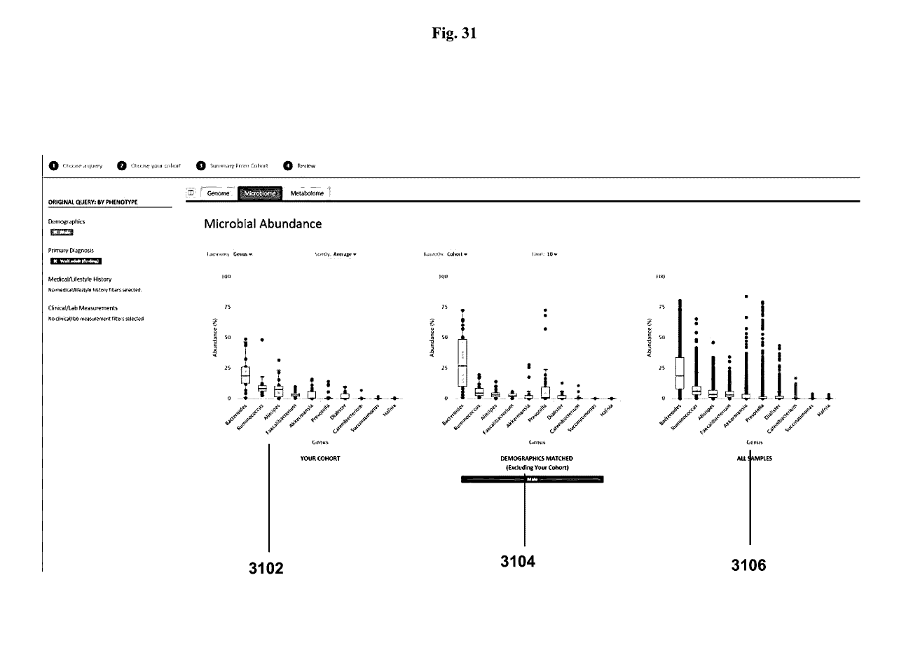

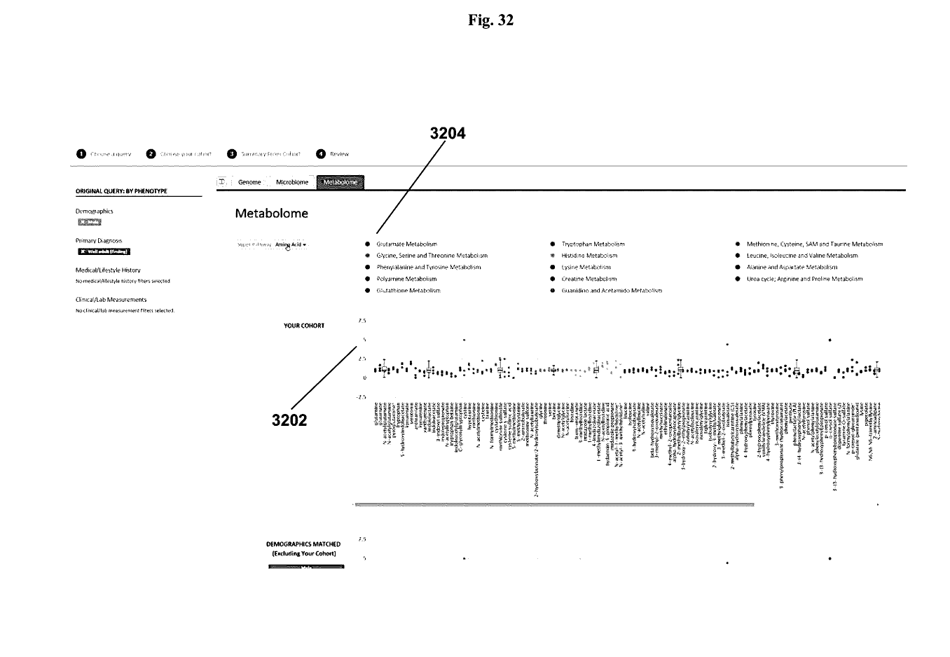

FIG. 28 illustrates a summary dashboard page. This is the same as the population summary dashboard page but now specific to the cohort selected. It shows a total number of genomes 2802, a total number of microbiomes 2804, a total number of metabolomes 2806, and a total number of individuals 2808. FIG. 29 illustrates a user interface that allows a user to select the user's own control pollution. The user can click on “Add custom summary table” to select a new control population using the demographics filters, including age 2902, sex 2094, ethnicity 2906, weight 2908, height 2910, and BMI 2912. FIGS. 30-32 depict a visual synthesis application including interactive tabs providing access to summaries of genome, microbiome, and metabolome information resulting from a query by phenotype. Referring to FIG. 30, in a particular embodiment, a query by phenotype (a particular primary diagnosis) yields a summary of individuals with 4,743 associated gene variants. The gene variants are listed in a data table 3002 along with knowledge base data 3004, in the form of annotations, including annotations obtained from, for example, ClinVar information 3006, dbNSFP information 3008, Spidex (splicing index) information 3010, and Human Gene Mutation Database (HGMD) information 3012, and the like. Referring to FIG. 31, in a particular embodiment, a query by demographics and phenotype (a particular primary diagnosis) yields a summary of microbial abundance of individuals meeting the query criteria 3102, of individuals not meeting the query criteria 3104, and of all individuals 3106. Referring to FIG. 32, in a particular embodiment, a query by demographics and phenotype (a particular primary diagnosis) yields a summary of metabolome information 3202 for individuals in the x-axis meeting the query criteria, including particular metabolites 3204 and associated ranges in the y-axis. In some embodiments, the reviews comprise comparison of data for a selected cohort, a demographics matched group, and all samples/individuals in a population.

The visual synthesis comprises an interface for browsing genomic data, microbiomic data, metabolomic data, and metadata returned by a query. In further embodiments, each of the genomic data, microbiomic data, metabolomic data, and metadata are accessible via a tab in the visualization interface. In still further embodiments, the visual synthesis also comprises a summary and an analysis tool, which are also accessible via a tabs in the visualization interface. In some embodiments, the visual synthesis comprises an interface for browsing genomic data, which further includes a set of user-configurable filters allowing “on-the-fly” refinement of the queried data set. For example, in some embodiments, the filters include a set of variant filters. Referring to FIG. 65, in a particular embodiment, a set of variant filters 6502 includes a gene filter (accepting gene symbol input) 6504, a reference SNP ID filter (accepting rs ID input) 6506, a disease annotation filter (accepting disease name input) 6508, a confidence region filter 6510, a clinical significance filter 6512, a function effect filter 6514, a variant type filter 6516, a max. allele frequency filter 6518, and a min. CADD score filter 6520.

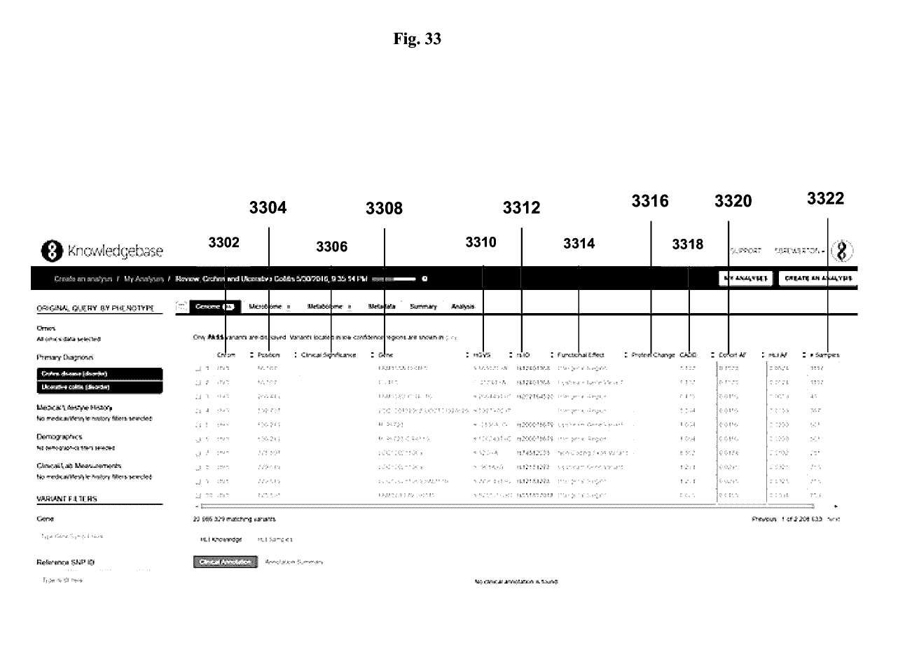

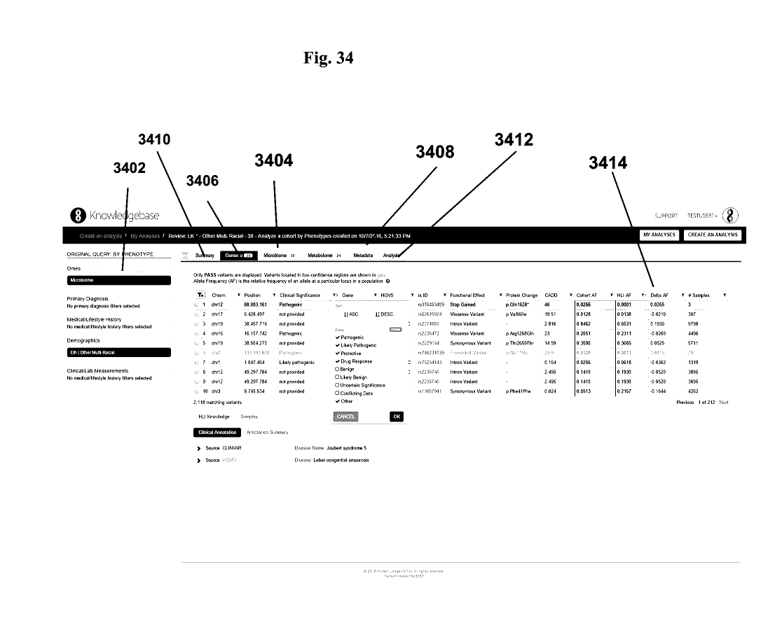

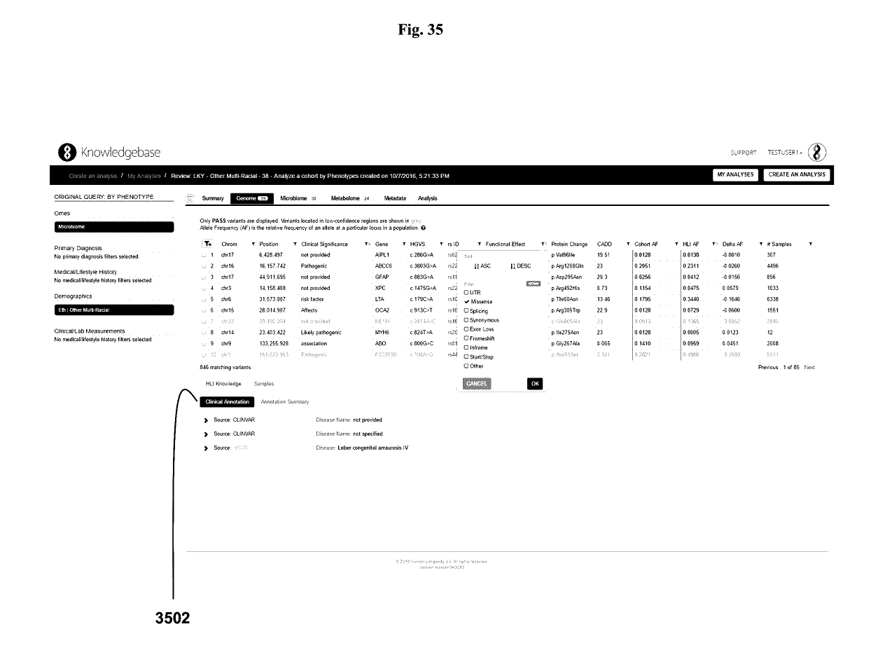

FIGS. 33-38 depict a visual synthesis application including interactive tabs providing access to summaries of genome, microbiome, metabolome, and metadata information resulting from a query by phenotype (primary diagnosis of ulcerative colitis or Crohn's disease) as well as a summary and an analysis tool. Referring to FIGS. 33 and 34, in particular embodiments, a query by phenotype (a particular primary diagnosis) yields a summary of individuals with 22,086,329 and 55,450 associated gene variants, respectively. The genomic data comprises a list of variants and, for each variant includes, chromosome 3302 and 3402, position 3304 and 3404, clinical significance 3306 and 3406, gene 3308 and 3408, HGVS nomenclature 3310 and 3410, rs ID 3312 and 3412, functional effect 3314 and 3414, protein change 3316 and 3416, CADD 3318 and 3418, allele frequency 3320 and 3420, a number of samples 3322 and 3422, clinical annotations, and an annotation summary. FIGS. 35-38 depict a genome summary of a similar query by phenotype yielding 376 gene variants, wherein ClinVar clinical annotation information 3502, 3602, and 3702 is displayed for a selected gene variant as well as an annotation summary and sample data 3802 (e.g., sample ID 3804 and age 3806, ethnicity 3808, gender 3810, primary diagnosis 3812, height 3814, weight 3816, and BMI 3818 of individual) for 79 relevant samples.

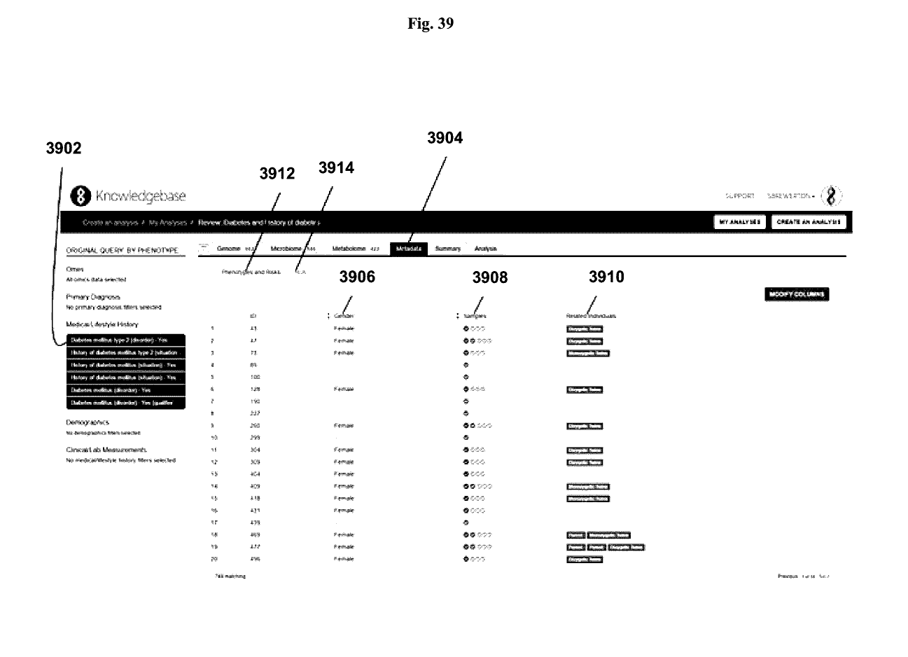

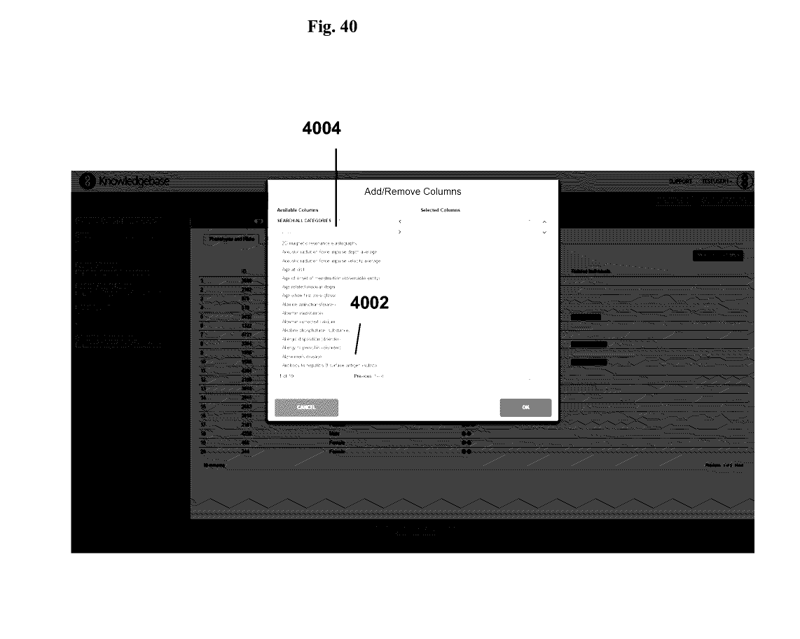

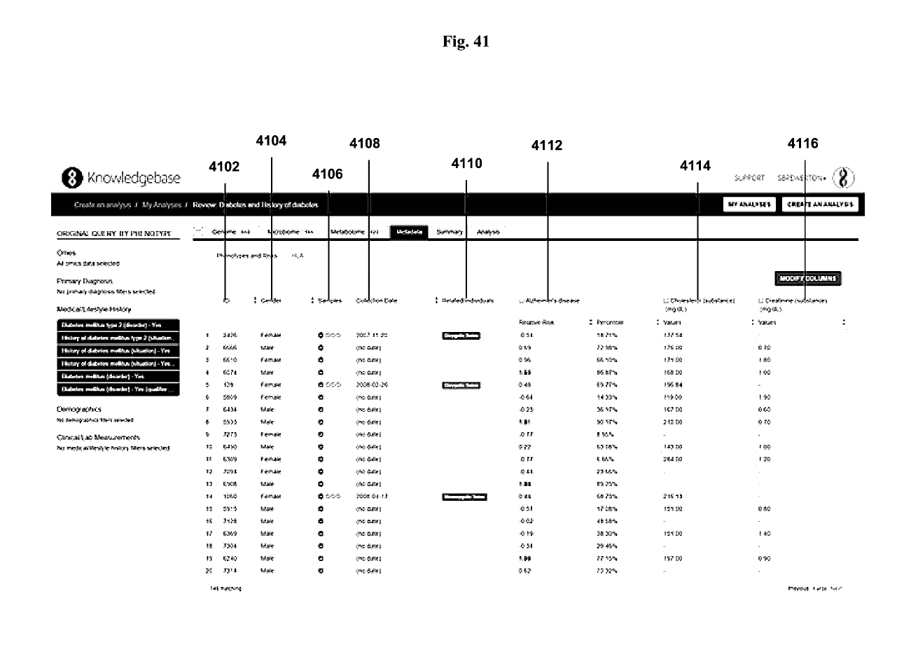

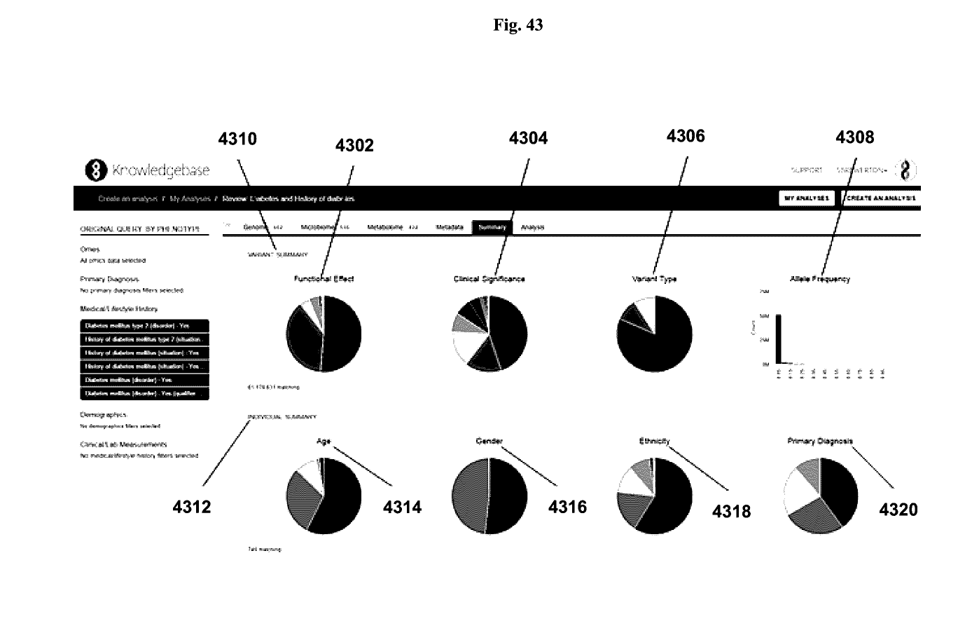

FIGS. 39-43 depict a visual synthesis application including interactive tabs providing access to summaries of genome, microbiome, metabolome, and metadata information resulting from a query by phenotype as well as a summary and an analysis tool. Referring to FIG. 39, in a particular embodiment, a query by phenotype (history of type 2 diabetes) 3902 yields a summary of metadata 3904 for 749 matching individuals. The metadata comprises metadata associated with each individual and includes phenotypes and risks 3912, such as gender 3906, samples available 3908, and types of related individuals 3910, as well as HLA information 3914. FIG. 40 in particular depicts an interface of adding 4002 and removing 4004 columns from the metadata summary. FIG. 41 in particular depicts a summary of the metadata, wherein the data columns have been modified to include individual ID 4102, gender 4104, samples 4106, collection date 4108, related individuals 4110, and Alzheimer's disease risk data 4112 as well as cholesterol 4114 and creatinine metabolite data 4116. FIG. 43 illustrates a user interface that allows a user to select the user's own control population. The user can click on “Add custom summary table” to select a new control population using the demographics filters, including age 4302, sex 4304, ethnicity 4306, weight 4308, height 4310, and BMI 4312.

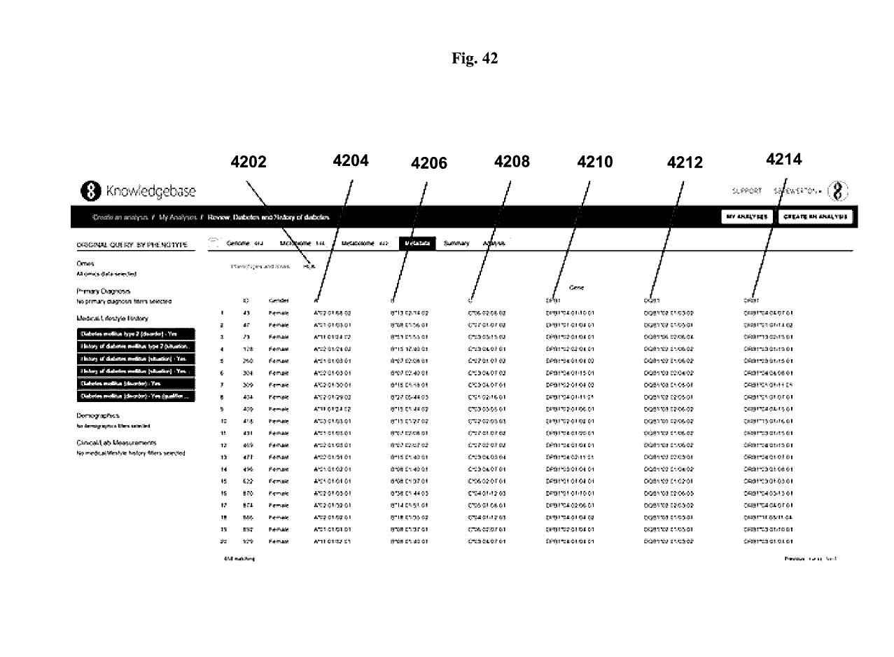

FIG. 42 in particular depicts a summary of the HLA information 4202 for the individuals, such as information regarding genes A 4204, B 4206, C 4208, DPB1 4210, DQB1 4212, and DRB1 4214. FIG. 43 in particular depicts a summary of the characteristics of the gene variants 4310 (e.g., functional effect 4302, clinical significance 4304, variant type 4306, allele frequency 4308, etc.) and the individuals 4312 (e.g., age 4314, gender 4316, ethnicity 4318, primary diagnosis 4320, etc.) returned by the query.

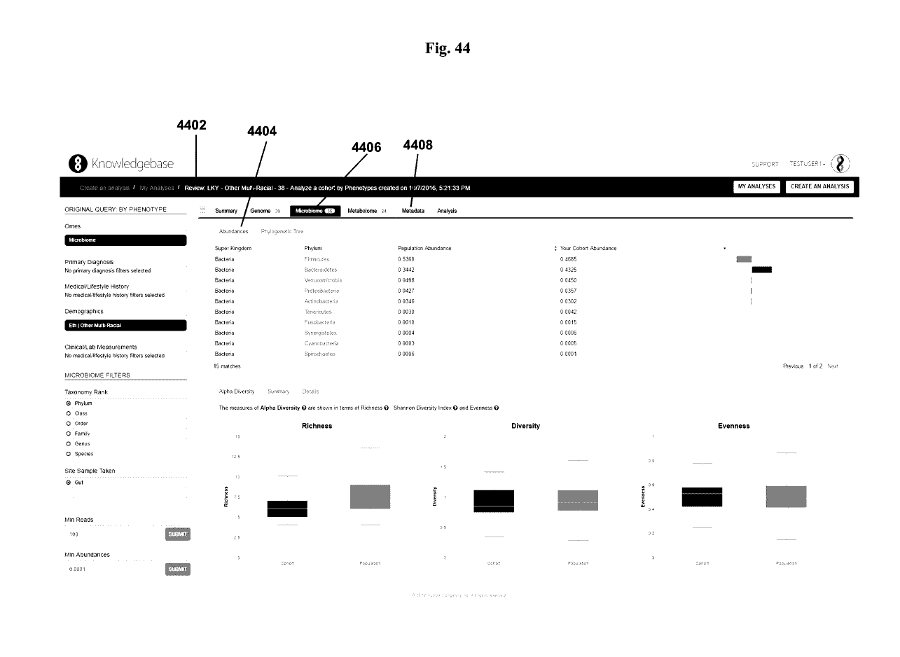

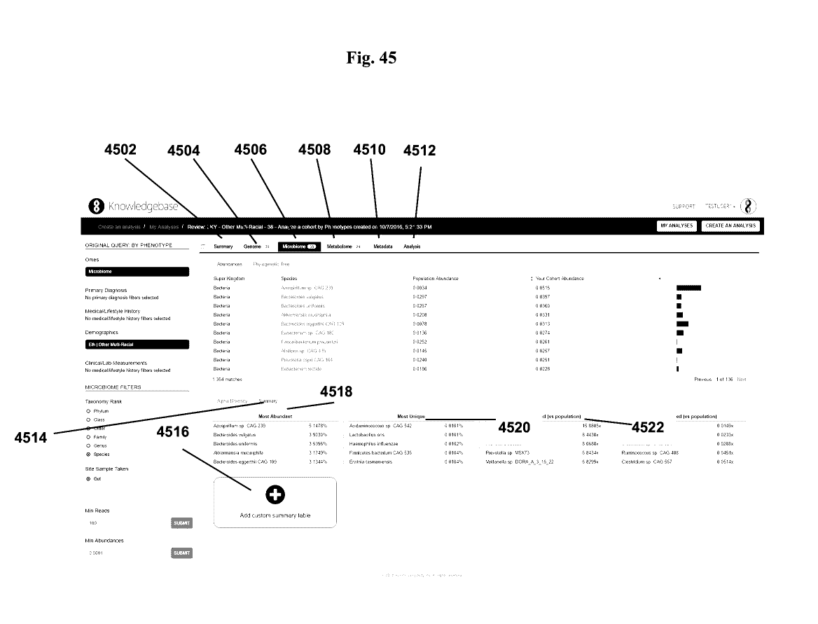

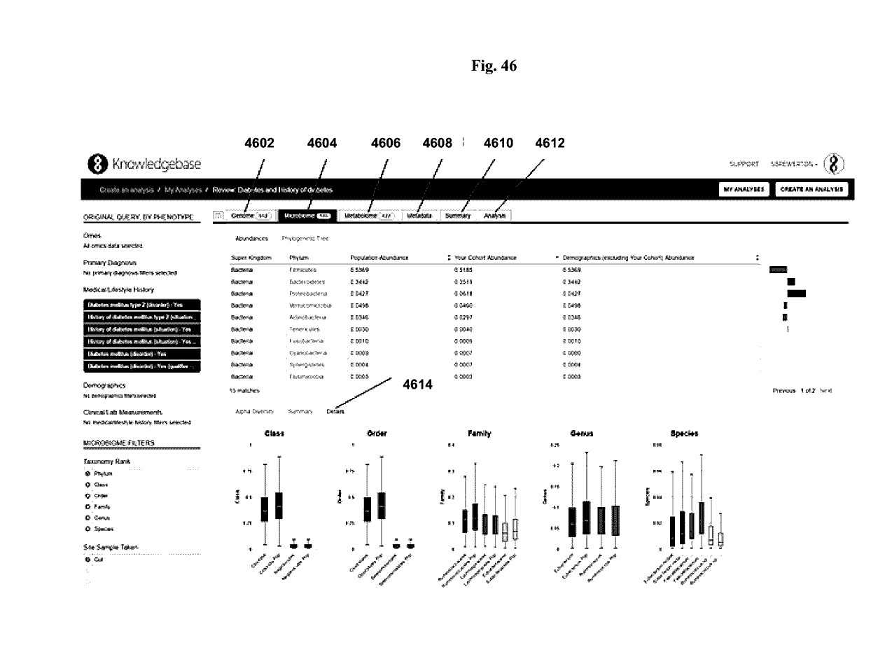

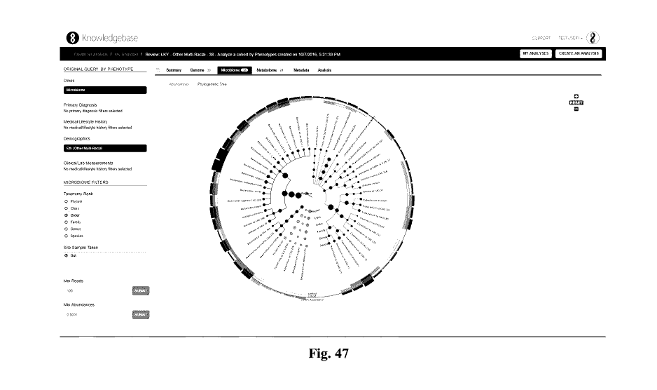

FIGS. 44-46 depict a visual synthesis application including interactive tabs providing access to summaries of genome 4402, 4502, and 4602, microbiome 4404, 4504, and 4604, metabolome 4406, 4506, and 4606, and metadata information 4408, 4508, and 4608 resulting from a query by phenotype as well as a summary 4410, 4510, and 4610 and an analysis tool 4412, 4512, and 4612. Referring to FIG. 44, in a particular embodiment, a query by phenotype (history of type 2 diabetes) yields a summary of microbiome information 4404 for 15 matching individuals. The microbiomic data comprises abundances 4414 for each phylum of microorganism as well as alpha diversity (e.g., richness 4418, diversity 4420, and evenness 4422). FIG. 45 in particular depicts a summary 4514 of the microbiomic data (e.g., most abundant 4518, most unique 4520, most enriched 4520, and most depleted 4522). FIG. 46 in particular depicts phylogenetic details 4614 of the relevant microbes. FIG. 47 illustrates a phylogenetic tree. The phylogenetic tree visualization shows the top 50 most abundant species in the cohort. The tree diagram in the center of the circular plot shows the evolutionary relationship between the species. The shaded rings and the bar chart in the outer rings of the plot show the abundances of each species in the population and the cohort.

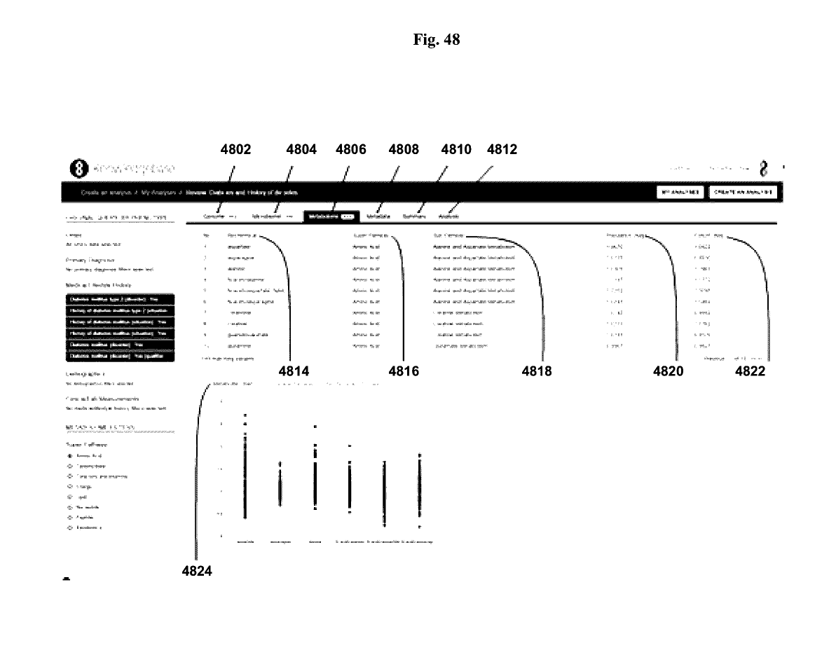

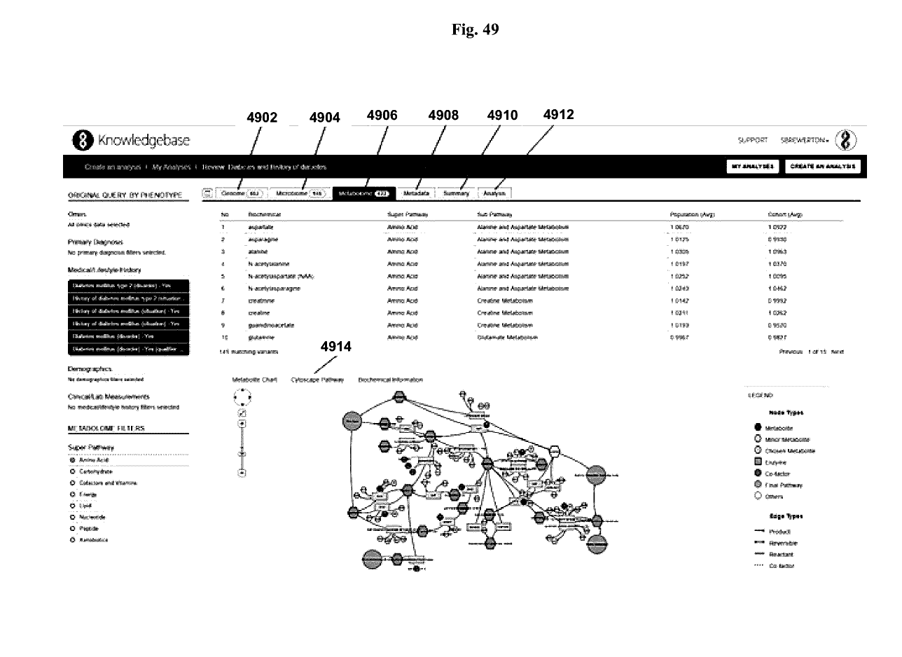

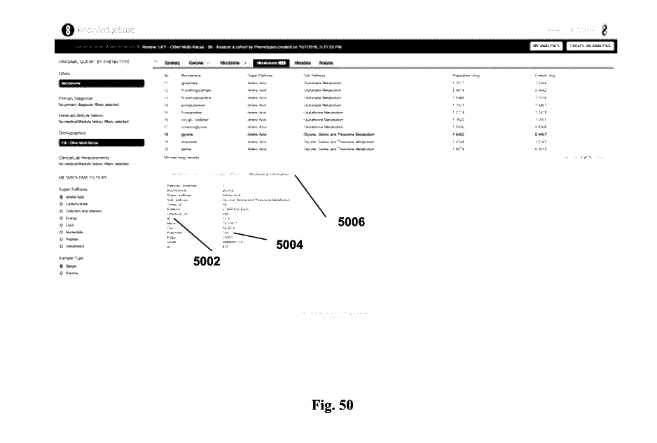

FIGS. 48 and 49 depict a visual synthesis application including interactive tabs providing access to summaries of genome 4802 and 4902, microbiome 4804 and 4904, metabolome 4806 and 4906, and metadata information 4808 and 4908 resulting from a query by phenotype as well as a summary 4810 and 4910 and an analysis tool 4812 and 4912. Referring to FIG. 48, in a particular embodiment, a query by phenotype (history of type 2 diabetes) yields a summary of metabolome information 4806 for 149 matching individuals. The metabolome data comprises a list of relevant biochemicals 4814, a superpathway 4816, a subpathway 4818, and relevant average levels 4820 and 4822 as well as an overall a metabolite chart 4824. FIG. 49 in particular depicts a cytoscape pathway 4914 for a selected metabolite (aspartate). FIG. 50 illustrates a page of metabolome information. Specifically, it shows the biochemical information 5006 in addition to the metabolite chart 5002 and the cytoscape pathway 5004.

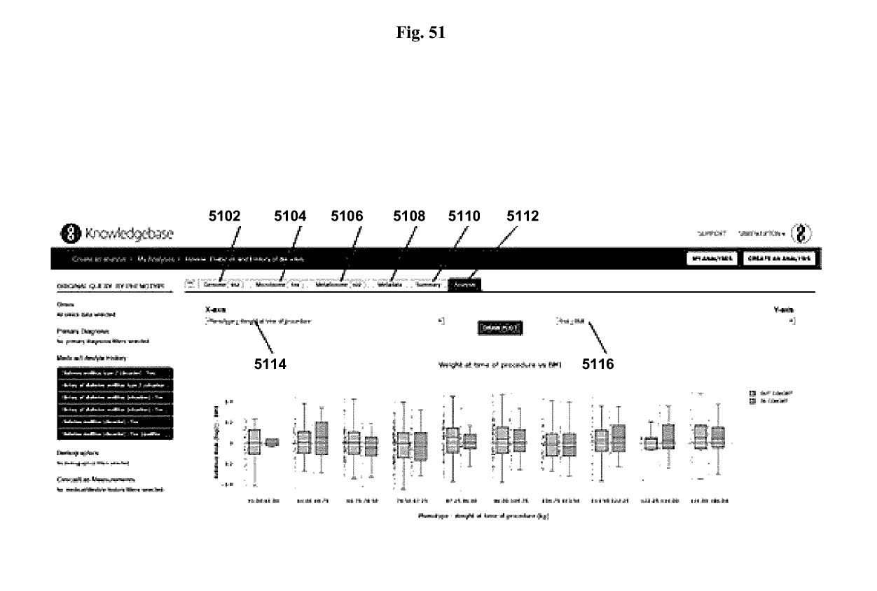

Referring to FIG. 51, in a particular embodiment, a query by phenotype (history of type 2 diabetes) yields a summary of relevant genome 5102, microbiome 5104, metabolome 5106, and metadata information 5108 as well as a summary 5110 and an analysis tool 5112. The analysis tool allows a user to generate customized data graphs by selecting a parameter for an x-axis 5114 and another for a y-axis 5116. In this case, a user has selected “Phenotype—Weight at time of procedure” to plot against “Risk-BMI” for the individuals relevant to the query.

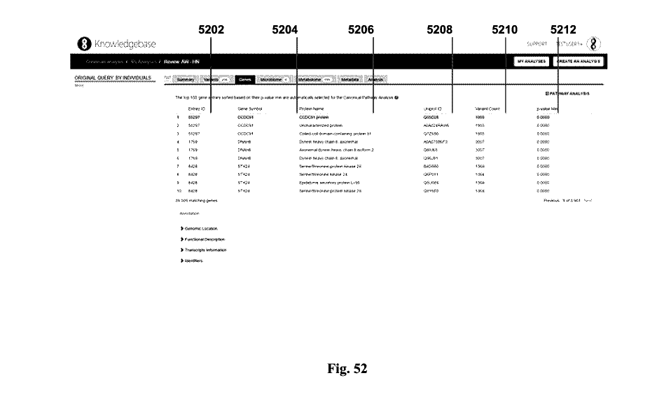

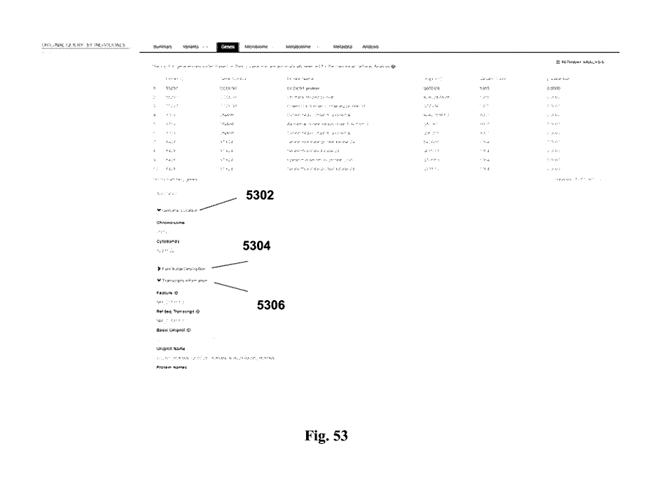

FIG. 52 illustrates a table of the genes that contain variants in the selected cohorts. This page may also provide synchronicity between the variants tab and the genes tab such that when a user filters the variants on the variants tab the genes will be filtered, too. Some basic information is given in the table, such as entrez ID 5202, gene symbol 5204, protein name 5206, Uniprot ID 5208, variant count 5210, and minimum p-value 5212. The p-value for a variant represents whether there is a significant difference between the cohort allele frequency and the HLI population allele frequency. For each gene the minimum variant p-value is taken. FIG. 53 illustrates a panel of extra annotation information about the gene selected in the table. It shows annotations including genome location 5302, functional description 5304, and transcripts information 5306.

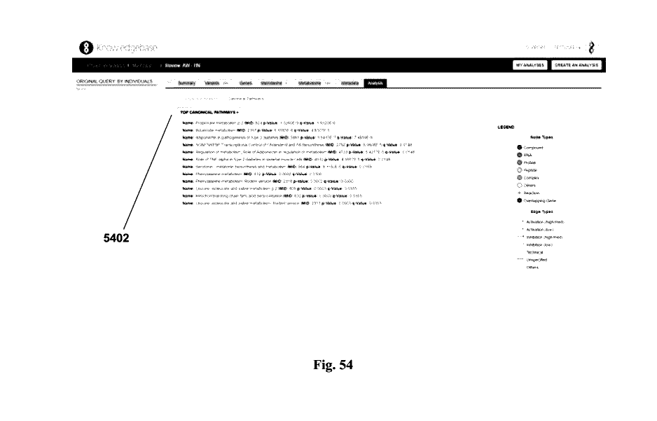

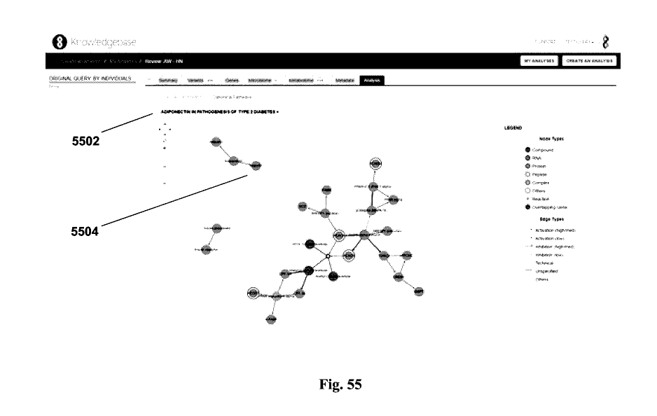

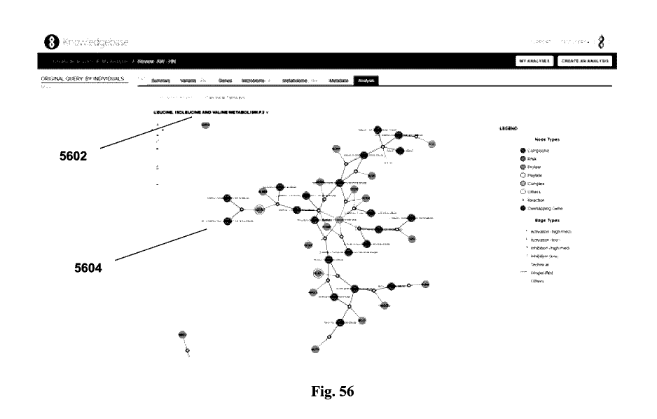

FIGS. 54-56 illustrate the pathway analysis capability. Clicking on the Pathway Analysis button from the genes tab allows the user to take a set of genes and look for pathways enriched in those genes. The top canonical pathways 5402 (by significant enrichment) are shown and if the user selects a pathway a Cytoscape visualization of the pathway is shown with the contributing genes highlighted. FIG. 55 shows a canonical pathway 5502 related to Adiponectin in pathogenesis of type 2 diabetes, where each node 5504 represents a contributing gene. Similarly, FIG. 56 shows a canonical pathway 5602 related to Leucine, isoleucine, and valine metabolism, where each node 5604 represents a contributing gene.

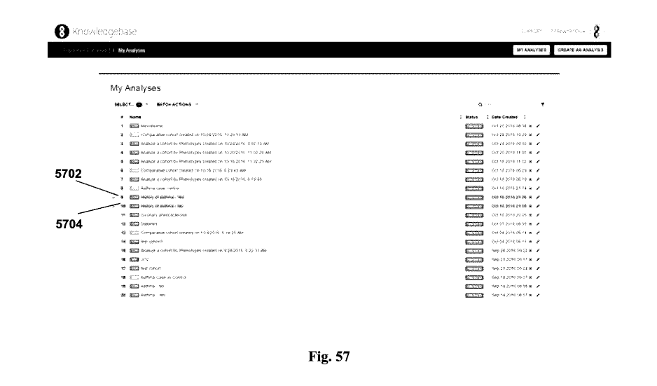

FIGS. 57-60 illustrate the cohort comparison capability. The system allows a user to select two cohorts 5702 and 5704 for comparison. The user can choose batch actions 5802, which allows the user to create a new cohort 5902 that consists of the two selected cohorts joined in the same dataset. This cohort can then be browsed in the same way as any other cohort. Specifically, the user could view details regarding the first cohort 6002 and details regarding the second cohort 6004. Additional filtering features 6006 allow the user to select the intersection or union of the variants in the two cohorts, or the variants present in only one of the cohorts. Also shown in the variant table are the cohort allele frequencies for the two cohorts and the difference between the two for comparison.

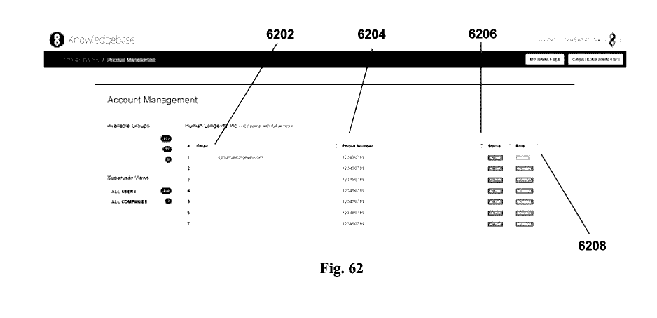

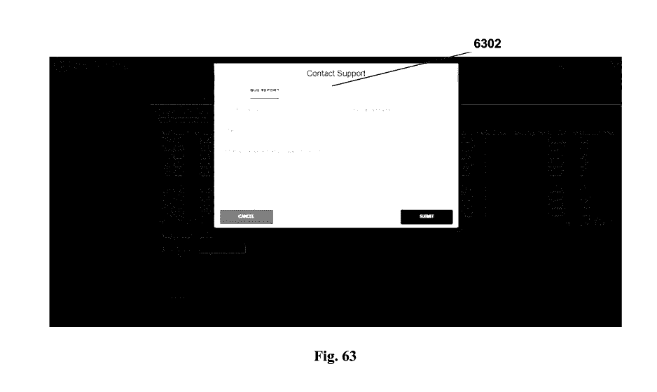

FIGS. 61 and 62 illustrate the account management capability. The account management option 6102 allows an admin user to add, delete and change the permissions of the users. The account management page shows information regarding the user, such as the email address 6202, phone number 6204, and status and role 6206. FIG. 63 illustrates the support functionality. The “contact support” page 6302 allows a user to fill in a form to submit support requests to the development team.

FIG. 67 depicts a visual synthesis application including interactive tabs providing access to summaries of genome 6702, microbiome 6704, and metabolome information 6706 resulting from a query by sample ID. The genomic data comprises a list of variants 6726 and, for each variant includes clinical significance 6708, gene 6710, HGVS nomenclature 6712, rs ID 6714, zygosity 6716, functional effect 6718, protein change 6720, CMIM ID 6722, and allele frequency 6724 bas well as annotation information 6728 and originating sample information 6730.

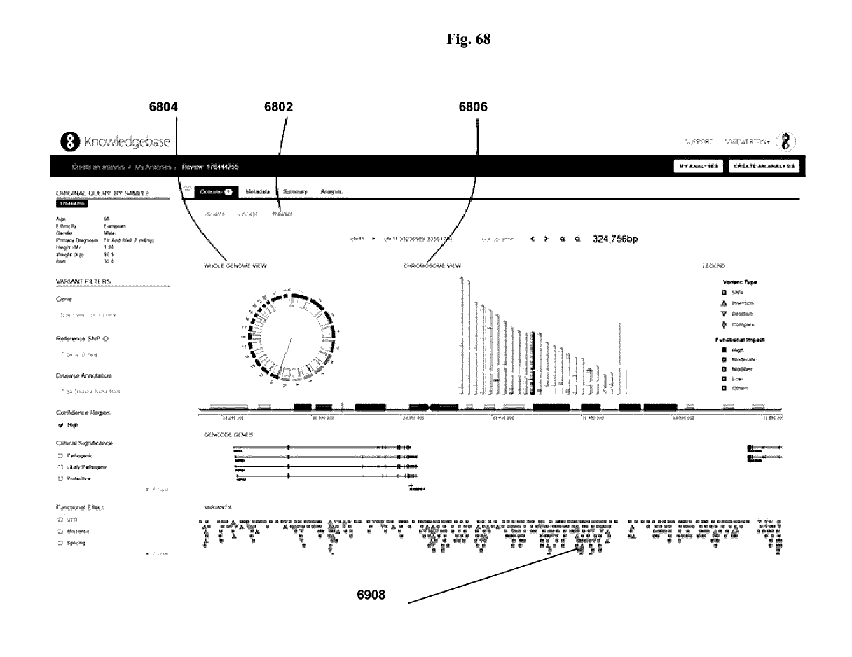

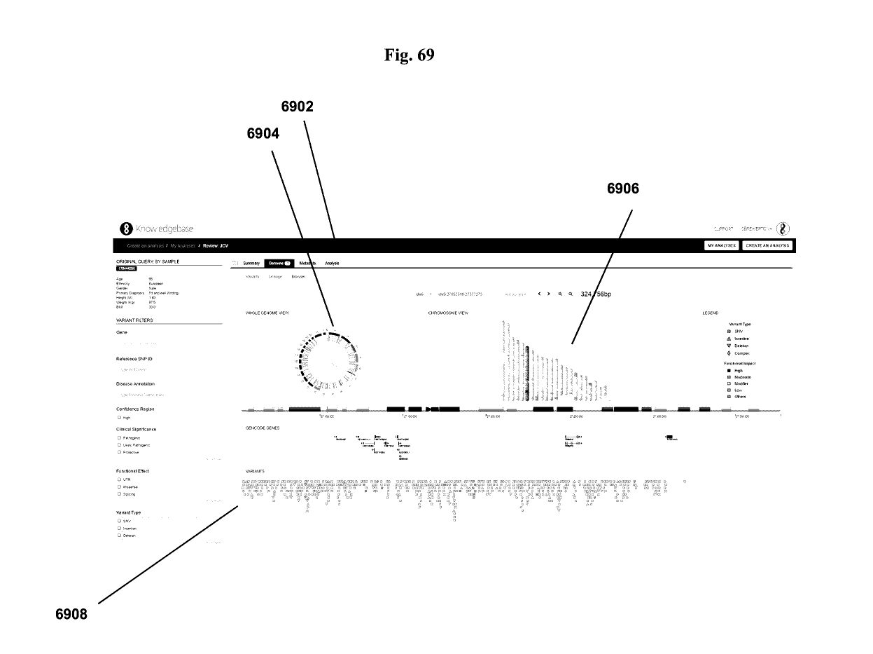

In some embodiments, the visual synthesis comprises a genome browser tool. See, e.g., FIGS. 68 and 69. In further embodiments, a genome browser tool 6802 and 6902 includes a whole genome view 6804 and 6904, which visually indicates the concentration of genomic variants and their functional impact for each chromosome of an individual. In still further embodiments, a genome browser tool includes an interactive chromosome view 6806 and 6906, which allows a user to select a chromosome, for which the genes and the individual's gene variants (including type and functional impact) 6808 and 6908 are presented.

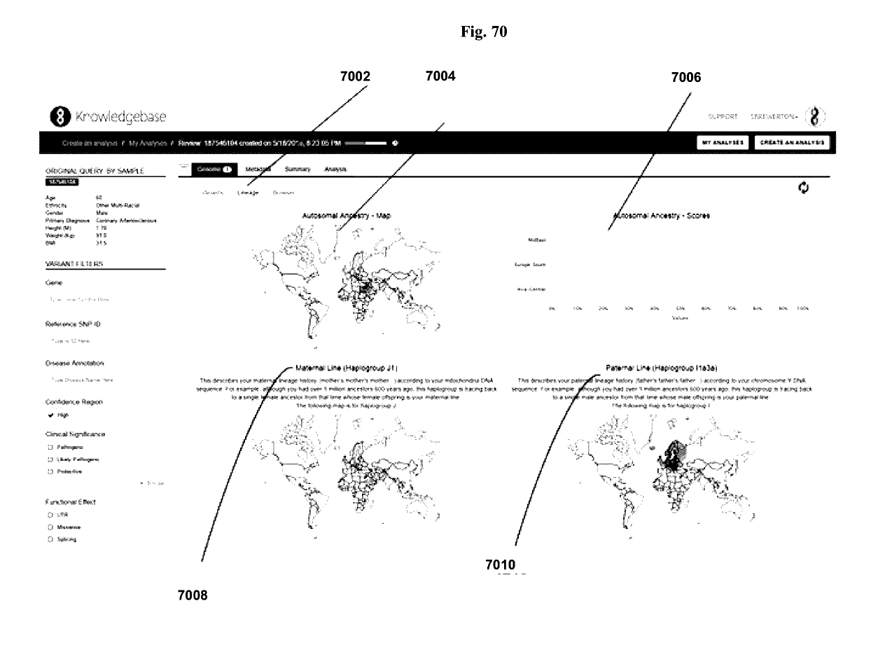

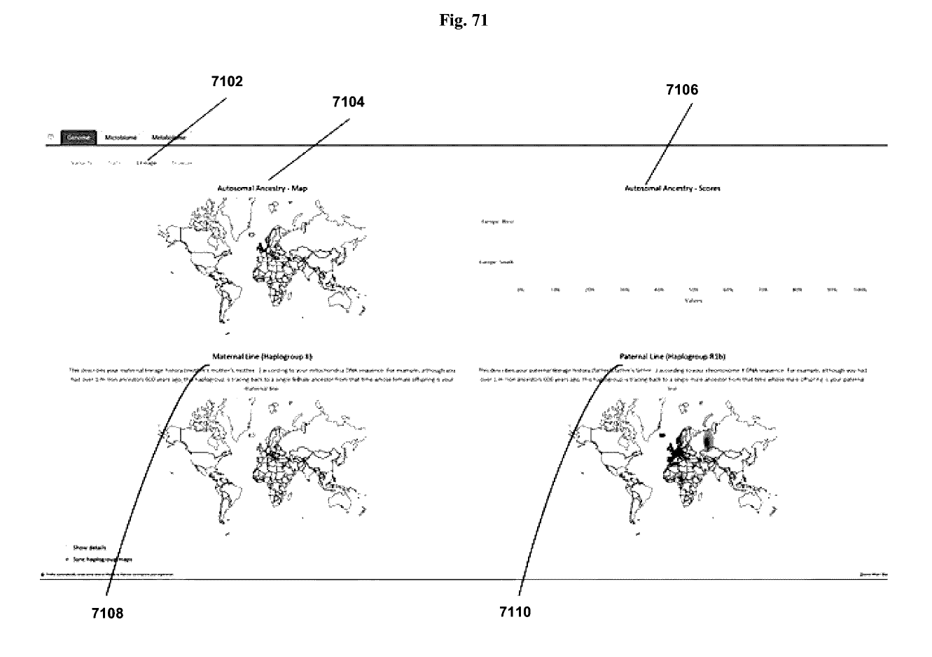

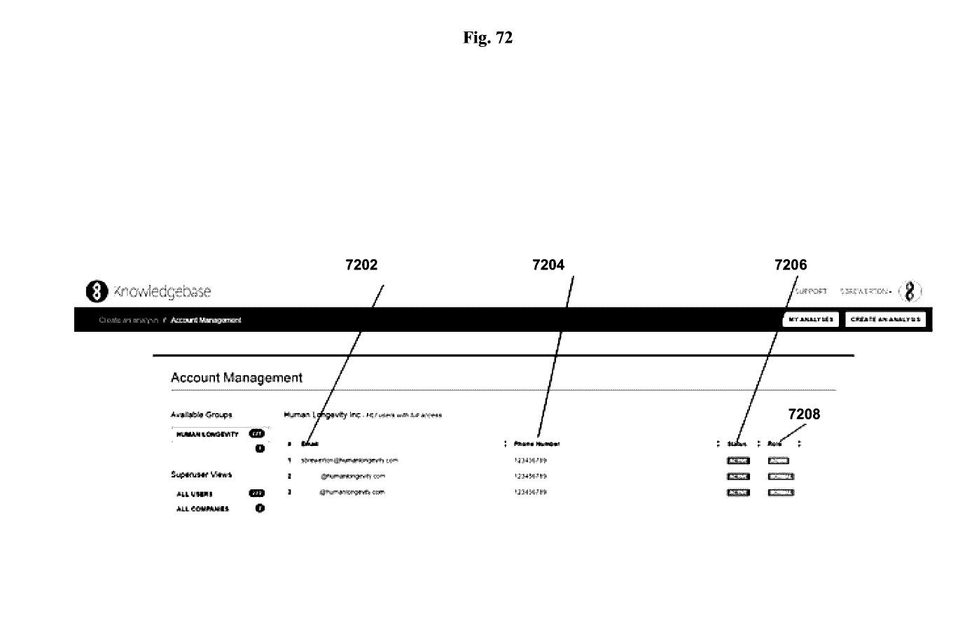

In some embodiments, the visual synthesis comprises a lineage viewer tool. See, e.g., FIGS. 70 and 71. In further embodiments, a lineage viewer tool 7002 and 7102 includes an autosomal ancestry map 7004 and 7104 and quantitative autosomal ancestry region scores 7006 and 7106. In still further embodiments, a lineage viewer tool includes a maternal lineage history map 7008 and 7108 and a paternal lineage history map 7010 and 7110. FIG. 72 shows a non-limiting example of a user interface for a biologic information visual synthesis application; in this case, an interface for managing user accounts including individual and group accounts. In some embodiments, for each account, the user interface shows an email address 7202, a phone number 7204, a status 7206, and a role 7208.

### Data Ingress

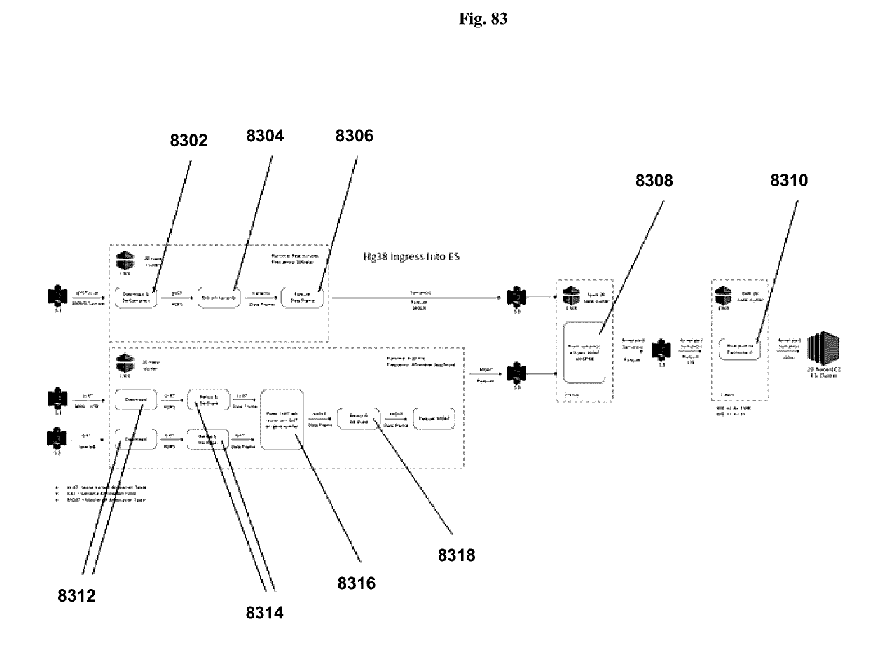

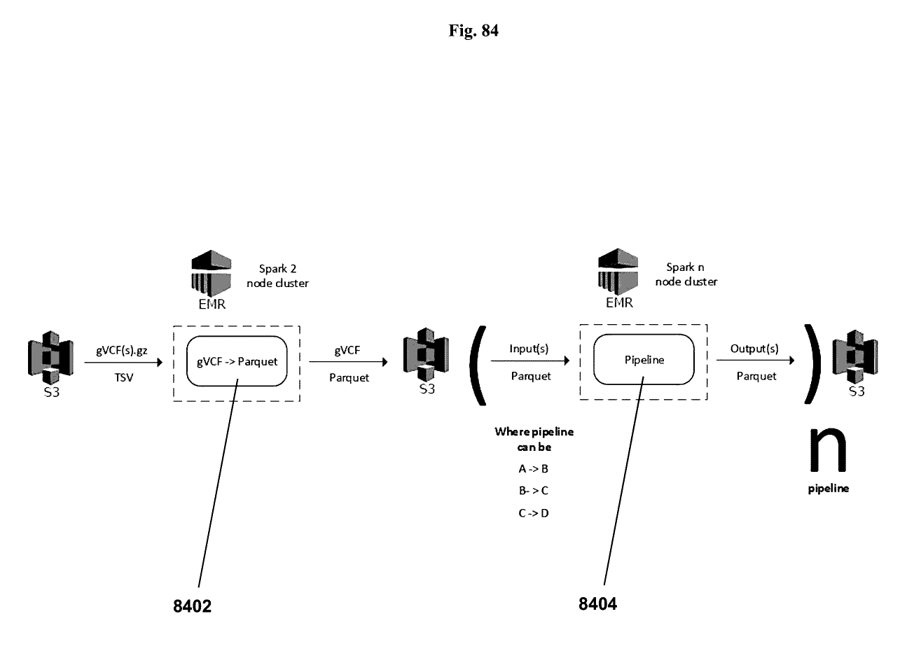

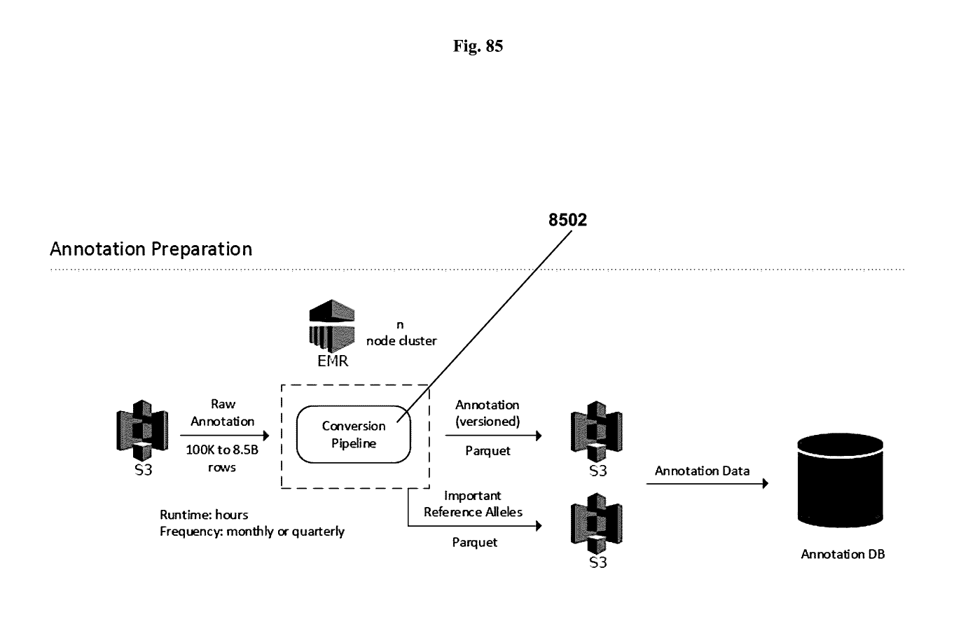

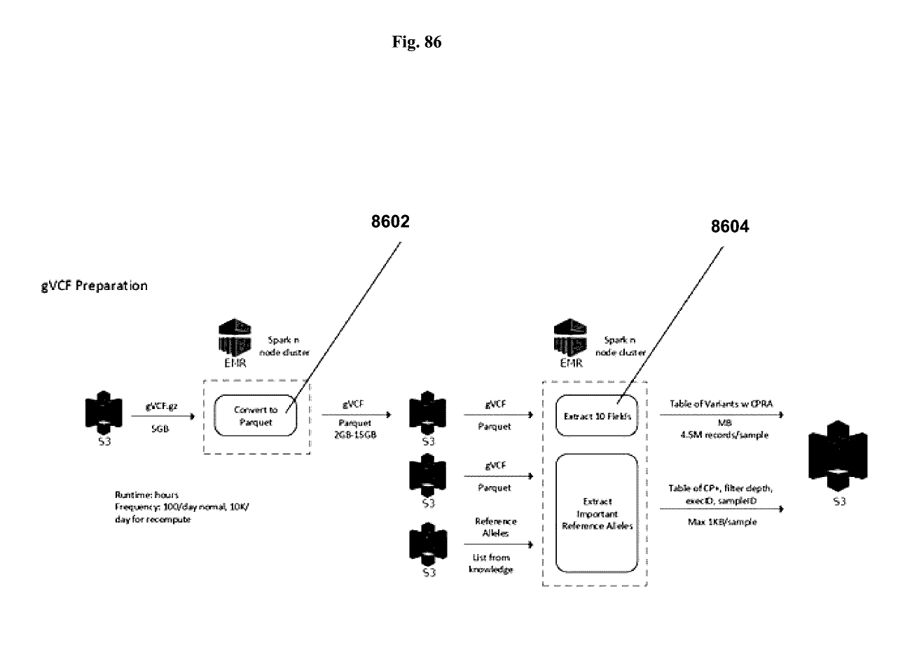

In some embodiments, the platforms, systems, media, and methods described herein include infrastructure and processes for ingress of data of various types from various sources, or use of the same. See, e.g., FIGS. 83-86. By way of examples, the platforms, systems, media, and methods described herein include infrastructure and processes for ingress of: hg38 data, see, e.g., FIG. 83; gVCF data, see, e.g., FIGS. 84 and 86; and annotation data, see, e.g., FIG. 85.

In FIG. 83, a platform comprising a user interface and a backend engine analyzes gVCF data on a cloud or a cluster of servers. Specifically, the platform in step 8302 downloads the gVCF data and decompresses it to also obtain HDFS data. The platform in step 8304 extracts variants from the decompressed data. The platform in step 8306 converts the variants into the Parquet format. Subsequently, the platform in step 8308 joins the converted data with MOAT on CPRA to generate annotated samples. The platform in step 8310 performs a sequence match for the annotated samples. Furthermore, the platform in step 8312 downloads a local variant annotation table (LVAT) or a genome annotation table (GAT). The platform in step 8314 rolls up such data and performs deduplication. The platform in step 8316 then joins the resulting LVAT and GAT on gene symbols to obtain data frames. The platform in step 8318 then rolls up the data frames and performs deduplication and subsequently converts the data into the Parquet format for storage.

In FIG. 84, a platform comprising a user interface and a backend engine analyzes gVCF and TSV data on a cloud or a cluster of servers. The platform in step 8402 converts the gVCF data into the Parquet format. The platform in step 8404 runs the converted data through specific pipelines.

In FIG. 85, a platform comprising a user interface and a backend engine analyzes raw annotations on a cloud or a cluster of servers. The platform in step 8502 subject the raw annotations to certain conversion pipelines to generate important reference alleles, which the platform stores together with versioned annotations in an annotation database.

In FIG. 86, a platform comprising a user interface and a backend engine analyzes gVCF data on a cloud or a cluster of servers. The platform in step 8602 converts the gVCF data into the Parquet format. The platform in step 8604 extracts important reference alleles from the gVCF data with respect to information regarding reference alleles to generate a table of variants with CPRA and a table of CP+, filter depth, execID, and sample ID information.

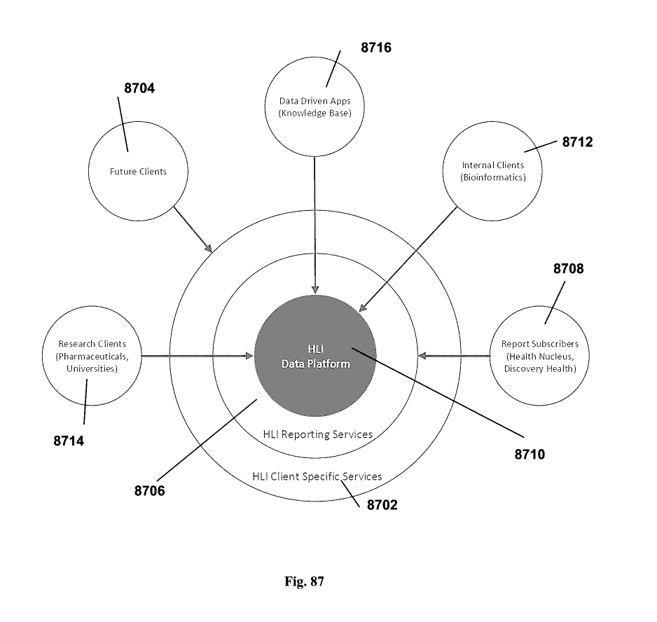

FIG. 87 shows a non-limiting example of architecture diagram for a biologic information visual synthesis application; in this case, a diagram depicting an overall structure for the biologic information platform. The platform includes an outer layer for client-specific services 8702, which interacts with future clients 8704. The platform includes a middle layer for reporting services 8706, which interacts with report subscribers 8708. In addition, the platform includes an inner layer for data management 8710, which interacts with internal clients 8712, research clients 8714, and data-driven applications 8716.

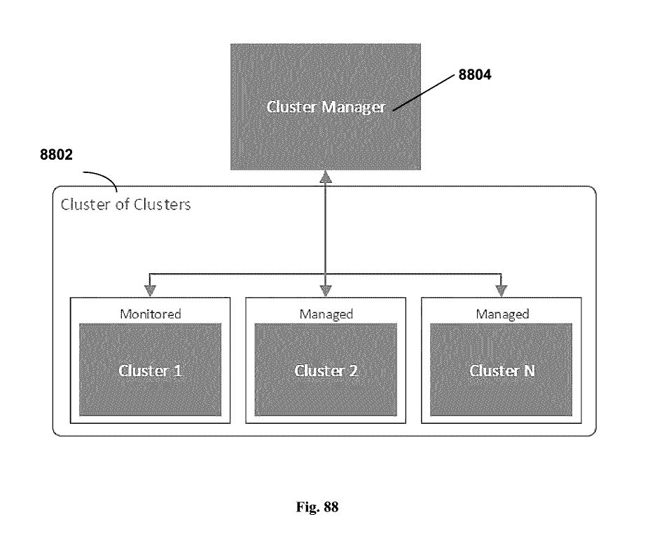

FIG. 88 shows a non-limiting example of architecture diagram for a biologic information visual synthesis application; in this case, a diagram depicting a cluster 8802 of clusters managed by a cluster manager 8804.

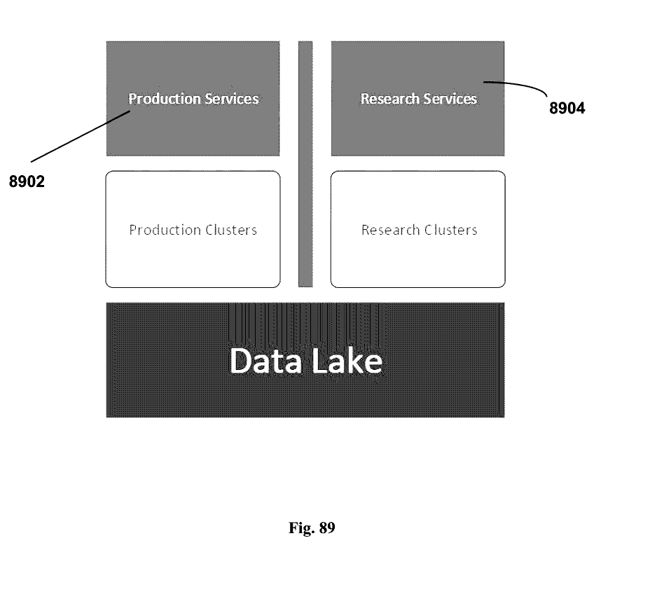

FIG. 89 shows a non-limiting example of architecture diagram for a biologic information visual synthesis application; in this case, a diagram depicting parallel production and research services 8902 and 8904 drawing from a common data lake.

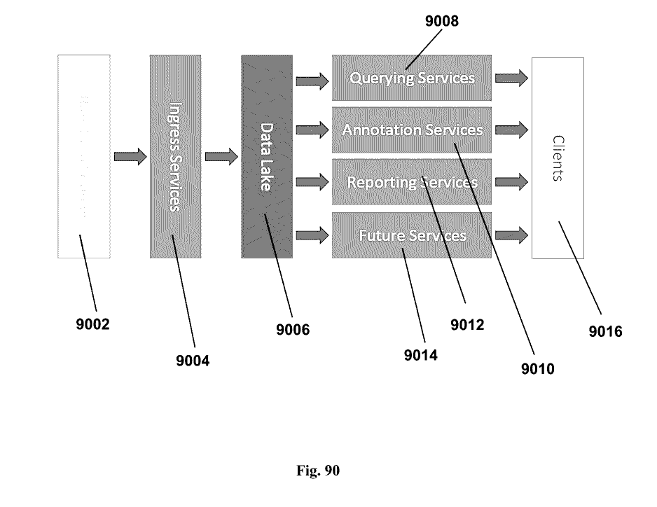

FIG. 90 shows a non-limiting example of architecture diagram for a biologic information visual synthesis application; in this case, a diagram depicting ingress 9004 of raw data 9002 into a data lake 9006 to provide a plurality of services, including querying 9008, annotation 9010, reporting services 9012, and future services 9014 to clients 9016.

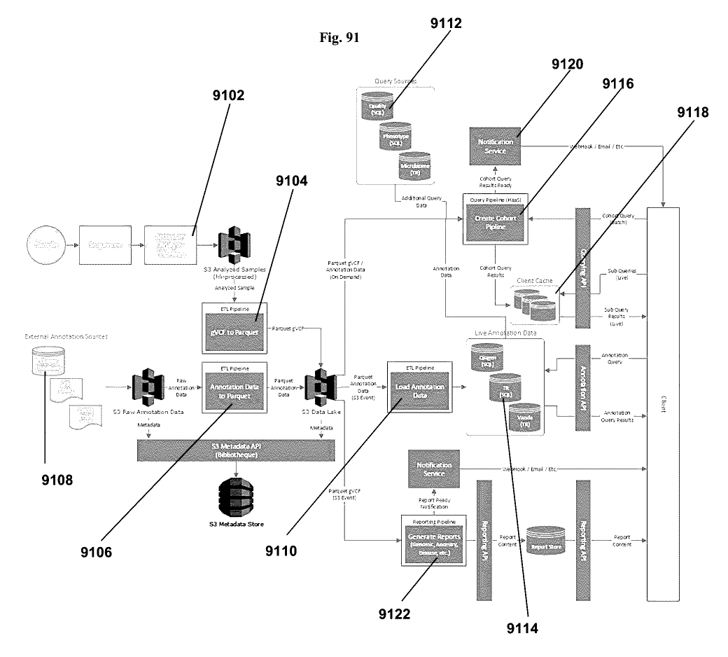

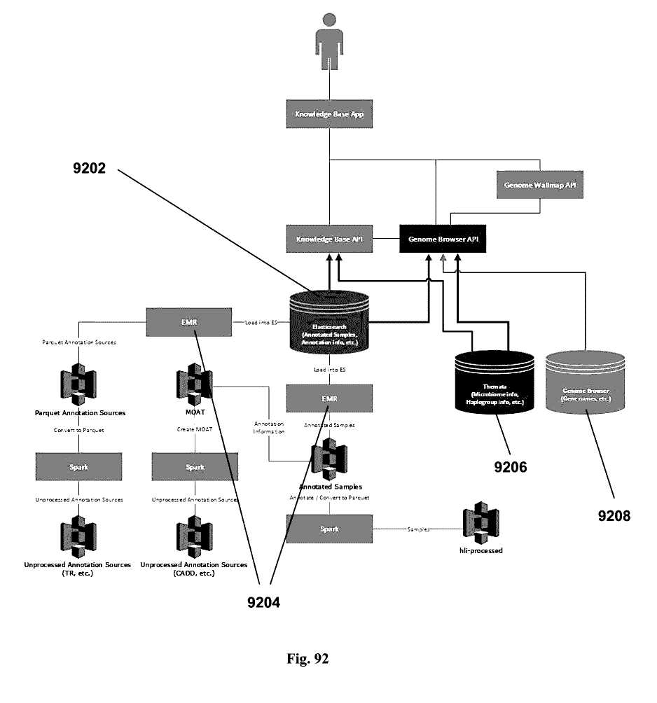

FIGS. 91 and 92 show non-limiting examples of architecture diagrams for a biologic information visual synthesis application; in this case, diagrams depicting an exemplary architectures for the biologic information platform.

In FIG. 91, a platform comprising a user interface and a backend engine analyzes raw annotations on a cloud or a cluster of servers. The platform in step 9102 runs sample sequences through a secondary analysis pipeline. The platform in step 9104 runs the analyzed sequences through an ETL pipeline to generate gVCF in the Parquet format, which it then sends to a data lake and potentially further store in a metadata store. The platform also retrieves data from external annotation sources 9108 and subjects the retrieved data to an ETL pipeline 9106 to generate annotation data in the Parquet format, which it then sends to a data lake. The platform can store the raw annotation data or the converted annotation data into the metadata store. The platform receives query annotations from query sources 9112 or from a client. The platform in step 9110 runs the converted annotation data through an ETL pipeline to produce live annotation data 9114 as query results. The platform in step 9116 runs converted gVCF or annotation data in the Parquet format through a cohort query pipeline to generate cohort query results that can be stored in a client cache 9118. A client could also send a cohort query to the cohort query pipeline to receive query results through a notification service 9120. In addition, the platform in step 9122 runs the converted gVCF data through a reporting pipeline to generate reports regarding genomic, ancestry, disease, or other information, which it can then store in a report store.

In FIG. 92, a platform comprising a user interface and a backend engine analyzes raw annotations on a cloud or a cluster of servers. The platform in step 9202 performs a search for annotated samples and related information outputted by EMR devices 9204 and can then store the search results into a knowledge base. The platform can also store microbiome information, haptogroup information, and other data 9206 into the knowledge base. In addition, the platform can show the search results, gene data 9208, and other available information through a genome browser.

### Software Architecture

The software architecture is designed to accommodate the massive quantity of genomic, microbiomic, and metabolomic data contemplated for the platforms, systems, media, and methods described herein. In addition to accommodating the sheer quantity of data, the software architecture is designed to accommodate the interrelations of the data, including relation of genomic, microbiomic, and metabolomic data to phenotype information and annotations. Significant challenges with regard to computing efficiency and conservation of computing resources are overcome by the architecture described herein, which allows for multiple concurrent users each performing complex queries and visualizations.

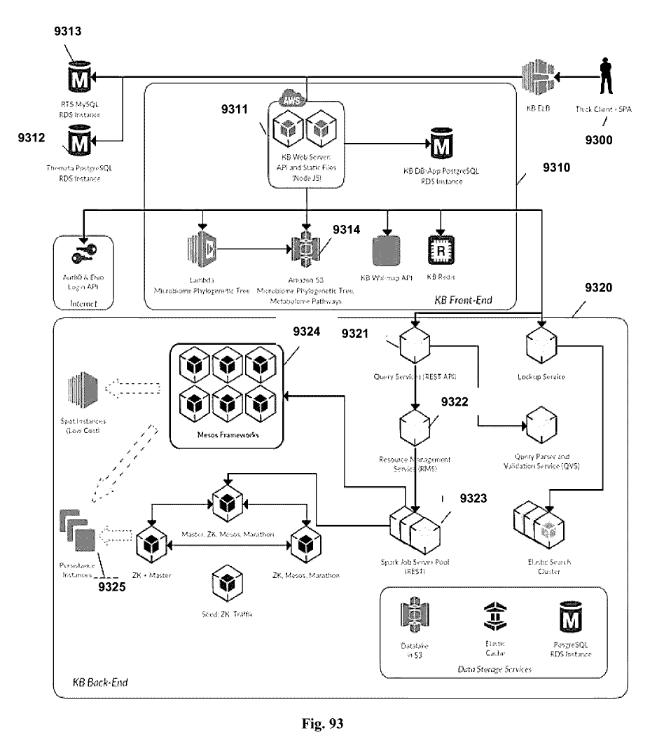

Referring to FIG. 93, in some embodiments, a platform comprises a front-end system 9310 and a back-end system 9320. A user 9300 accesses the platform through an interface provided by a web server 9311. The front-end system 9310 stores phenotype data in a database instance 9312 such as PostgreSQL. In some embodiments, phenotype data comprises more than 9300 phenotype data fields with more than 2 million data points. To handle an extremely large volume of data, the database 9312 is able to handle complicated data queries, including, but not limited to, joining, foreign keys, partition, and drilling. The front-end system 9310 stores annotation data of samples in a database instance 9313 such as MySQL. The front-end system 9310 stores genotypic data in a simple data store 9314. In some embodiments, the genotypic data comprises one or more of the following: microbiomes, metabolomes, and genomes.

In some embodiments, a query request made by the user 9300 needs further computations from the back-end system 9320. A request is handled by a query service engine 9321. The request is further sent to a resource management engine 9322, followed a job scheduling server 9323. In some embodiments, the job scheduling server 9323 is implemented by Spark. In some embodiments, the job scheduling server 9323 controls non-persistent computing instances 6924; for example, the job scheduling server 9323 tentatively adds new computing instances for new jobs and kills the instances once the new jobs are done. The computed results are further passed to persistent computing instances 9325 for further processing, such as visualization. In some embodiments, controlling non-persistent computing instances is implemented by Mesos frameworks 9324.

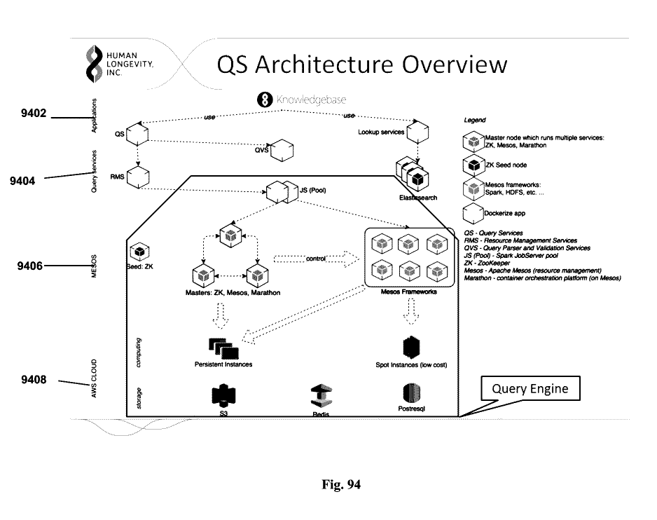

In some embodiments, in order to be able to receive a large number of queries and properly handle a large amount of data processing in response to the queries, the system takes several approaches. FIG. 94 illustrates an example architecture for a query engine. First, the system preformats certain data, including pre-joining annotation data with gVCF data, to facilitate downstream processing. Second, the system separates computing resources from storage resources, to allow for a broader bandwidth for data processing. Third, the system provisions one or more new cluster for each user, to provide a suitable bandwidth on a per-user basis. As illustrated in FIG. 94, the system has an application layer 9402, a query service layer 9404, a MESOS layer 9406, and a cloud layer 9408. The system provides a platform to host both data and services through the application layer 9402. The system enables users to query genome data through the query service layer 9404. The system prejoins annotation data with gVCF data in a data preparation pipeline, so that cohorts could be created based on the pre-join table. In addition, the system offers genome query tools in a distributed computing environment to boost the creation speed. Cohort storage is separated from computing platform in the cloud layer 9408, with cohorts loaded into the computing cluster only upon receiving user requests.

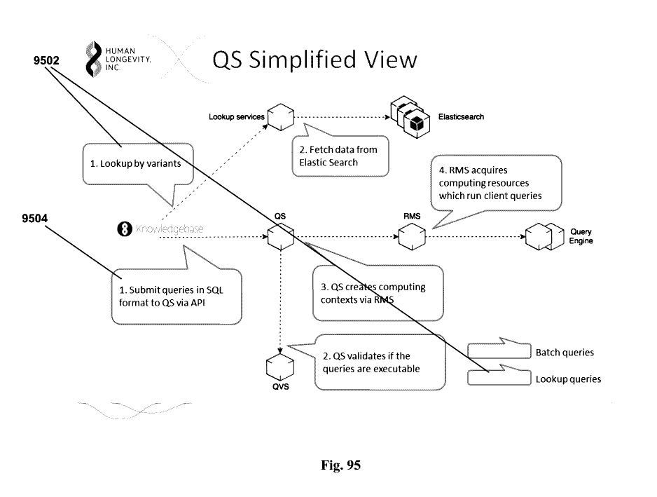

In some embodiments, the system divides user queries into two categories: batch queries (filtering, transformation, and aggregate) and lookup queries. In-memory cluster computing is used to process batch queries (filter, sort, transform, and aggregate). In this manner, the computing cluster scales out as more user requests are received, reclaims computing nodes when users' job are completed, and scales down when no new user requests come in. FIG. 95 illustrates an example process of query processing. A user can submit a query 9502 to find samples by variants, gender, gene, etc. Such a query can be processed by a search engine that provides easy horizontal scale-out, including the one illustrated in FIG. 94. A user can also submit a batch query 9504 for cohort creation, filtering, sorting, pagination of cohort queries, and aggregation of cohort data (e.g. histograms of numerical fields). As discussed above, each user has his/her own computing clusters, and the size of computing cluster is decided by the size of data to be processed.

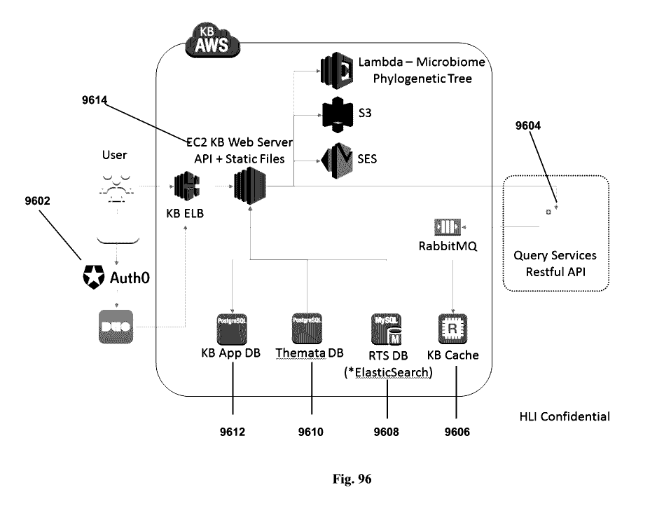

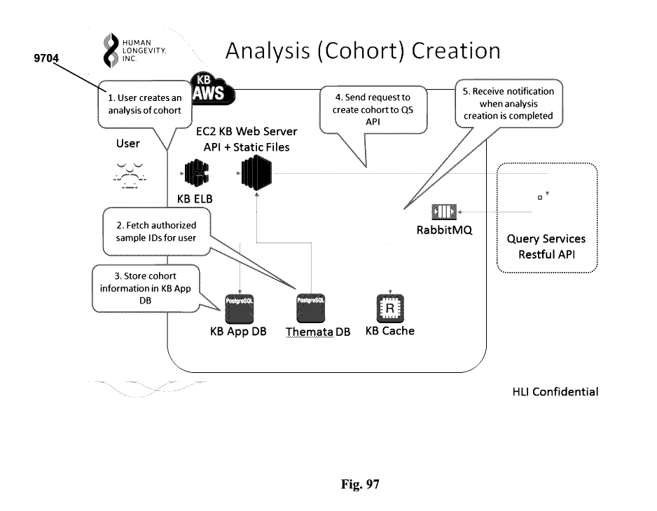

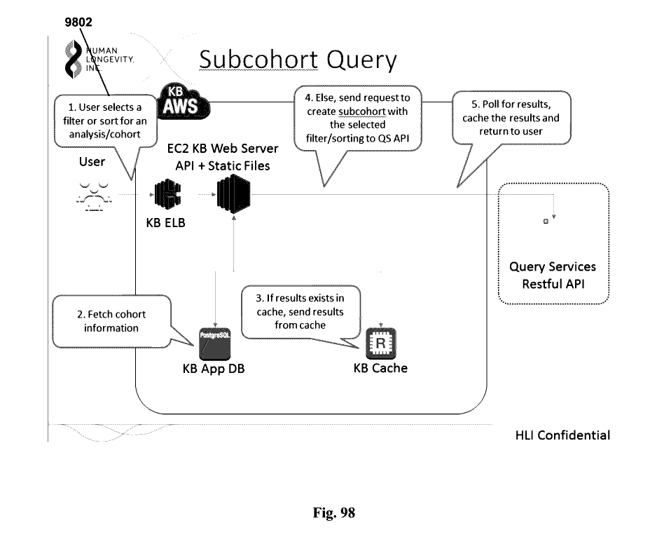

FIG. 96 illustrates an example architecture for the system. The system includes an authentication server 9602 for authenticating a user and a web server 9604 for managing user's online experience. The system also includes various database 9606 to store data regarding users, cohorts, authorizations, phenotypes, microbiomes, metabolomes, individual-to-sample mappings, real-time annotation services, and annotations against CPRA. FIG. 96 illustrates an example cohort creation process. In response to a user's request to create an analysis of cohort 9702, the system fetches sample IDs that can be accessed by the user from the databases and stores relevant cohort information into the databases. Next, the system sends a request for creating the cohorts to a query engine through a query service API, and subsequently receives a notification when the cohorts are created and analyzed. FIG. 98 illustrates an example subcohort creation process. In response to a user's request 9802 to select a filter or sorting criterion for a cohort analysis, the system retrieves cohort information from the databases. Upon determining that relevant data exist in a cache, the system presents those data to the user. Otherwise, the system sends a request for creating subcohorts with the selected filter or sorting criterion to a query engine through the query service API. The system can then pool for results returned from the query engine, stores received results in the cache, and also present them to the user.

### Use Cases

The system can be applied in a variety of fields. The system provides useful data and analysis to pharmaceutical companies, including informaticians, bench scientists, medical director, the senior executive team, or commercial organizations. Such data and analysis can include analysis of clinical trial data for patient stratification and biomarker discovery, identification and in silico validation of novel genetic targets, discovery of novel disease and dose response biomarkers/signatures, compound repurposing and expand indications of marketed drugs, rescue of failed phase 3 assets, real time genetic analysis of adverse events, or targeted accelerated recruitment for clinical trials. For academic research groups, including physicians/principal investigators, informaticians, research scientists and geneticists, the system can offer analysis of specific cohorts, analysis of individual patients, or large scale analysis of variation in populations. Clinics, hospitals and cancer centers, including physicians and genetic counsellors, may also find the system useful in the analysis of individuals, analysis of cohorts, wellness focus, or oncology focus. The data and analysis can also prove valuable to insurance companies, actuarial teams, or health economists.

Specifically, for pharma and researchers, the system can serve as or enable a reference set of knowledge/evidence, an hypothesis generation engine, a platform for analysis of pharma's own data, a platform for combination of pharma data and data and analysis provided by the system, a platform for combining data from multiple collaborators, a platform for sharing data within a company, etc. For physicians or genetic counsellors, the system can similarly be used as part of a care tool to identify the most relevant results for treatment and prevention, a reference set of knowledge/evidence, or a tool to identify other physicians with similar patients/share knowledge. In addition, for insurance companies, the system can be useful as part of a tool for detect individual care pathway and incentivize healthy living or a tool to help quantify risk that they have in the insured population.

### Digital Processing Device

In some embodiments, the platforms, systems, media, and methods described herein include a digital processing device, or use of the same. In further embodiments, the digital processing device includes one or more hardware central processing units (CPUs) or general purpose graphics processing units (GPGPUs) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, and notebook computers.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In some embodiments, the display is a wearable display. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's on or more CPUs, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Apache Hadoop, Microsoft®.NET, or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™ and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® ActionScript, Javascript, or Silverlight®. In some embodiments, a web application is written to some extent in a server-side coding language such as Active Server Pages (ASP), ColdFusion, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of user, patent, phenotypic, genomic, microbiome, and metabolome information. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In other embodiments, a database is based on one or more local computer storage devices.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A computer-implemented system comprising: at least one memory storing computer-executable instructions; and at least one processor configured to access the at least one memory and execute the computer-executable instructions to perform:
a) receiving a query, wherein the query defines a cohort of one or more individuals;
b) querying a database; wherein the database comprises a plurality of genomic data and a plurality of phenotype data;
c) generating, using at least the genomic data, one or more of: a genome summary, a microbiome summary, and a metabolome summary for the cohort, the genome summary comprising genes and gene variants of the cohort, the microbiome summary comprising one or more of: a relative abundance of types of microflora found in the cohort and genes and gene variants of the microflora, and the metabolome summary comprising measurements of metabolites found in the cohort;
d) determining a graphical representation of the genome summary, the microbiome summary, and the metabolome summary for the cohort; and
e) sending the graphical representation to a display device.

2. The system of claim 1, wherein the database further comprises a plurality of microbiomic data and a plurality of metabolomic data.

3. The system of claim 1, wherein the instructions perform generating, using at least the genomic data, two or more of: a genome summary, a microbiome summary, and a metabolome summary for the cohort.

4. The system of claim 3, wherein the instructions perform generating, using at least the genomic data, a genome summary, a microbiome summary, and a metabolome summary for the cohort.

5. The system of claim 1, wherein the plurality of genomic data is obtained by analysis of one or more biologic samples from one or more individuals.

6. The system of claim 1, wherein the query comprises one or more of: demographic information, clinical information, disease history, family history, disease treatments, physical traits, test results, diagnostic images, dietary information, lifestyle information, and cognitive assessments.

7. The system of claim 1, wherein the query includes a phenotype.

8. The system of claim 1, wherein the query includes a sample ID.

9. The system of claim 1, wherein the query includes an individual ID.

10. The system of claim 1, wherein the query includes a gene name or gene variant name.

11. The system of claim 1, wherein the at least one processor is further configured to access the at least one memory and execute the computer-executable instructions to perform presenting a graphical user interface (GUI) for receiving the query.

12. The system of claim 11, wherein the GUI allows construction of the query by adding or removing one or more of: a demographic filter, a primary diagnosis filter, a medical history filter, a lifestyle filter, a clinical measurement filter, and a laboratory measurement filter.

13. The system of claim 12, wherein the GUI shows a number of individuals remaining in the cohort in response to each adding or removing a filter.

14. The system of claim 1, wherein the genome summary further comprises functional effect, clinical significance, variant type, and allele frequency for the gene variants.

15. The system of claim 11, wherein the GUI allows the user to configure display of the microbiome summary to show abundance by species or genus of microflora found in the individuals.

16. The system of claim 11, wherein the GUI allows the user to configure display of the metabolome summary to show measurements of metabolites found in the individuals by metabolic superpathway or sub-pathway.

17. The system of claim 1, wherein the genome summary, microbiome summary, and metabolome summary comprise data for individuals.

18. The system of claim 11, wherein the GUI displays one of the genome information, microbiome information, and metabolome information at a time and allows the user to switch among displays of the genome information, the microbiome information, and the metabolome information.

19. The system of claim 1, wherein the genomic data comprises data in variant call format (VCF).

20. The system of claim 1, wherein the genomic data is annotated with one or more non-genomic data upon or before import into the database.

21. The system of claim 20, wherein the one or more non-genomic data comprises one or more of: demographic information, clinical information, disease history, family history, disease treatments, physical traits, test results, microbiome information, metabolome information, dietary information, lifestyle information, cognitive assessments, sample ID, and patient ID.

22. The system of claim 1, wherein at least one processor is allocated to the query independently of other queries.

23. The system of claim 1, wherein at least one dedicated processor is allocated to the query and the database is shared for all queries.

24. A computer-implemented method comprising:
a) receiving a query, wherein the query defines a cohort of one or more individuals;
b) querying a database; wherein the database comprises a plurality of genomic data and a plurality of phenotype data;
c) generating, using at least the genomic data, one or more of: a genome summary, a microbiome summary, and a metabolome summary for the cohort, the genome summary comprising genes and gene variants of the cohort, the microbiome summary comprising one or more of: a relative abundance of types of microflora found in the cohort and genes and gene variants of the microflora, and the metabolome summary comprising measurements of metabolites found in the cohort;
d) determining a graphical representation of the genome summary, the microbiome summary, and the metabolome summary for the cohort; and
e) sending the graphical representation to a display device.

25. The method of claim 24, wherein the database further comprises a plurality of microbiomic data and a plurality of metabolomic data.

26. The method of claim 24, comprising generating, using at least the genomic data, two or more of: a genome summary, a microbiome summary, and a metabolome summary for the cohort.

27. The method of claim 26, comprising generating, using at least the genomic data, a genome summary, a microbiome summary, and a metabolome summary for the cohort.

28. Non-transitory computer-readable storage media encoded with a computer program including instructions executable by at least one processor to perform:
a) receiving a query, wherein the query defines a cohort of one or more individuals;
b) querying a database; wherein the database comprises a plurality of genomic data and a plurality of phenotype data;
c) generating, using at least the genomic data, one or more of: a genome summary, a microbiome summary, and a metabolome summary for the cohort, the genome summary comprising genes and gene variants of the cohort, the microbiome summary comprising one or more of: a relative abundance of types of microflora found in the cohort and genes and gene variants of the microflora, and the metabolome summary comprising measurements of metabolites found in the cohort;
d) determining a graphical representation of the genome summary, the microbiome summary, and the metabolome summary for the cohort; and
e) sending the graphical representation to a display device.

29. The media of claim 28, wherein the database further comprises a plurality of microbiomic data and a plurality of metabolomic data.

30. The media of claim 28, wherein the instructions are executable to perform generating, using at least the genomic data, two or more of: a genome summary, a microbiome summary, and a metabolome summary for the cohort.

31. The media of claim 30, wherein the instructions are executable to perform generating, using at least the genomic data, a genome summary, a microbiome summary, and a metabolome summary for the cohort.
